SEQUENCE LISTING (35 sequences)

SEQ ID NO: 1 - DNA, 651 bp, Burkholderia gladioli
tttccttagtaacgtagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatggtcggaatcctggagagatctgggagtgctcgaaagagaaccgatacacaggtgctgcatggctgtcgtcagctcgtgtcgtgagatgttgggttaagtcccgcaacgagcgcaacccttgtccttagttgctacgcaagagcactctagggagactgccggtgacaaaccggaggaaggtggggatgacgtcaagtcctcatggcccttatgggtagggcttcacacgtcatacaatggtcggaacagagggtcgccaacccgcgagggggagctaatcccagaaaaccgatcgtagtccggattgcactctgcaactcgagtgcatgaagctggaatcgctagtaatcgcggatcagcatgccgcggtgaatacgttcccgggtcttgtacacaccgcccgtcacaccatgggagtgggttttaccagaagtggctagtctaaccgcaaggaggacggtcaccacggtaggattcatgactggggtgaagtcgta

SEQ ID NO: 2 - DNA, 662 bp, Burkholderia gladioli
tcctccttgcggttagactagccacttctggtaaaacccactcccatggtgtgacgggcggtgtgtacaagacccgggaacgtattcaccgcggcatgctgatccgcgattactagcgattccagcttcatgcactcgagttgcagagtgcaatccggactacgatcggttttctgggattagctccccctcgcgggttggcgaccctctgttccgaccattgtatgacgtgtgaagccctacccataagggccatgaggacttgacgtcatccccaccttcctccggtttgtcaccggcagtctccctagagtgctcttgcgtagcaactaaggacaagggttgcgctcgttgcgggacttaacccaacatctcacgacacgagctgacgacagccatgcagcacctgtgtatcggttctctttcgagcactcccagatctctccaggattccgaccatgtcaagggtaggtaaggtttttcgcgttgcatcgaattaatccacatcatccaccgcttgtgcgggtccccgtcaattcctttgagttttaatcttgcgaccgtactccccaggcggtcaacttcacgcgttagctacgttactaaggaaatgaatccccaacaactagttgacatcgtttagggcgtggactaccagggta

SEQ ID NO: 3 - DNA, 660 bp, Burkholderia gladioli
tcctccttgcggttagactagccacttctggtaaaacccactcccatggtgtgacgggcggtgtgtacaagacccgggaacgtattcaccgcggcatgctgatccgcgattactagcgattccagcttcatgcactcgagttgcagagtgcaatccggactacgatcggttttctgggattagctccccctcgcgggttggcgaccctctgttccgaccattgtatgacgtgtgaagccctacccataagggccatgaggacttgacgtcatccccaccttcctccggtttgtcaccggcagtctccctagagtgctcttgcgtagcaactaaggacaagggttgcgctcgttgcgggacttaacccaacatctcacgacacgagctgacgacagccatgcagcacctgtgtatcggttctctttcgagcactcccagatctctccaggattccgaccatgtcaagggtaggtaaggtttttcgcgttgcatcgaattaatccacatcatccaccgcttgtgcgggtccccgtcaattcctttgagttttaatcttgcgaccgtactccccaggcggtcaacttcacgcgttagctacgttactaaggaaatgaatccccaacaactagttgacatcgtttagggcgtggactaccaggg

SEQ ID NO: 4 - DNA, 828 bp, Burkholderia gladioli
  misc_feature (769)..(769): n is a, c, g, or t
  misc_feature (771)..(771): n is a, c, g, or t
gcagcgtcagctggtttgccaccacggagtgctgcagaatcgcatcctgcggctccggctggtatgcagggcgcgcgttatcattgtagtgtggccgcatatcgttaaagttggtgcgcagcgtgaagccaaacatcacggtgttgccgcgctcgtagctgaggttaacgtcggcccagtcggtgacgcgataaatggcgccgacgttaaacttgctcttctgctcaatcttcccggcgaagtcctgcgagtagtcattcccttcatattccagcttcaggcgtaatggctgccagggcgtttgatactccacgccgccaaacagcgatgccggaccgtggaacatctggtcaccgttgatggaacccgctttcttatagctgttatcgcggtagcagtatttatcgctgtaggagcaaaacggatttttcacgttaccgccagtgcccaggtagccccatcccaggccgagcgagaagtcgaacggcccccaggctttactggccacgatgtattcagcatcaaacagaccggtaccaccgatatctttggcgcccacggacacctgcggcatccagtagctctcttcccacaggcgcagcttgacgtcgaaggctttatctttgtaggtctggtcgccggagaacgcatcaacgctgctgtactgtttcgtacgcacgtcggtgtagcgcagcgtggtttcaagccacgggaacagctgcaccgacgccgagtagtaacgatactgatcgttatcacggtagttaangnctgtctcttatacacatctcaaccatcatcgatgaattgcttcgttaatacagatgt

SEQ ID NO: 5 - DNA, 991 bp, Burkholderia gladioli
  misc_feature (740)..(740): n is a, c, g, or t
  misc_feature (843)..(845): n is a, c, g, or t
  misc_feature (946)..(947): n is a, c, g, or t
  misc_feature (951)..(951): n is a, c, g, or t
  misc_feature (969)..(969): n is a, c, g, or t
  misc_feature (979)..(979): n is a, c, g, or t
  misc_feature (981)..(981): n is a, c, g, or t
  misc_feature (986)..(986): n is a, c, g, or t
gtgtataagagacaggccttaactaccgtgataacgatcagtatcgttactactcggcgtcggtgcagctgttcccgtggcttgaaaccacgctgcgctacaccgacgtgcgtacgaaacagtacagcagcgttgatgcgttctccggcgaccagacctacaaagataaagccttcgacgtcaagctgcgcctgtgggaagagagctactggatgccgcaggtgtccgtgggcgccaaagatatcggtggtaccggtctgtttgatgctgaatacatcgtggccagtaaagcctgggggccgttcgacttctcgctcggcctgggatggggctacctgggcactggcggtaacgtgaaaaatccgttttgctcctacagcgataaatactgctaccgcgataacagctataagaaagcgggttccatcaacggtgaccagatgttccacggtccggcatcgctgtttggcggcgtggagtatcaaacgccctggcagccattacgcctgaagctggaatatgaagggaatgactactcgcaggacttcgccgggaagattgagcagaagagcaagtttaacgtcggcgccatttatcgcgtcaccgactgggccgacgttaacctcagctacgagcgcggcaacaccgtgatgtttggcttcacgctgcgcaccaactttaacgatatgcggccacactacaatgataacgcgcgccctgcataccagccggagccgcangatgcgattctgcagcactccgtggtggcaaaccagctgacgctgctgaaatacaatgccggcctggcggatccccgccacggttgatgagagctttgttgtnnnggaccagttggtgattttgaacttttgctttgccacggaacggtctgcgttgtcgggaagatgcgtgatctgatccttcaactcagcaaaagttcgatttnntcanaaagccgccgtcccgtcngtcagcgtangntctgncagtg

SEQ ID NO: 6 - DNA, 951 bp, Burkholderia gladioli
  misc_feature (870)..(870): n is a, c, g, or t
  misc_feature (874)..(874): n is a, c, g, or t
  misc_feature (908)..(909): n is a, c, g, or t
  misc_feature (917)..(917): n is a, c, g, or t
  misc_feature (920)..(920): n is a, c, g, or t
  misc_feature (933)..(935): n is a, c, g, or t
  misc_feature (937)..(938): n is a, c, g, or t
cagcgtcagctggtttgccaccacggagtgctgcagaatcgcatcctgcggctccggctggtatgcagggcgcgcgttatcattgtagtgtggccgcatatcgttaaagttggtgcgcagcgtgaagccaaacatcacggtgttgccgcgctcgtagctgaggttaacgtcggcccagtcggtgacgcgataaatggcgccgacgttaaacttgctcttctgctcaatcttcccggcgaagtcctgcgagtagtcattcccttcatattccagcttcaggcgtaatggctgccagggcgtttgatactccacgccgccaaacagcgatgccggaccgtggaacatctggtcaccgttgatggaacccgctttcttatagctgttatcgcggtagcagtatttatcgctgtaggagcaaaacggatttttcacgttaccgccagtgcccaggtagccccatcccaggccgagcgagaagtcgaacggcccccaggctttactggccacgatgtattcagcatcaaacagaccggtaccaccgatatctttggcgcccacggacacctgcggcatccagtagctctcttcccacaggcgcagcttgacgtcgaaggctttatctttgtaggtctggtcgccggagaacgcatcaacgctgctgtactgtttcgtacgcacgtcggtgtagcgcagcgtggtttcaagccacgggaacagctgcaccgacgccgagtagtaacgatactgatcgttatcacggtagttaaggcctgtctcttatacacatctcaaccatcatcgatgaattgcttcgttaatacagatgtaggtgttccacagggtagccagcagcatcctgcgatgcagatnccgnatgccatttcattacctctttctccgcacccganntagatccnaanatcagcagttcannngnnatagtacgtacta

SEQ ID NO: 7 - DNA, 906 bp, Burkholderia gladioli
  misc_feature (749)..(749): n is a, c, g, or t
  misc_feature (808)..(808): n is a, c, g, or t
  misc_feature (813)..(813): n is a, c, g, or t
  misc_feature (853)..(854): n is a, c, g, or t
ggttgagatgtgtataagagacaggccttaactaccgtgataacgatcagtatcgttactactcggcgtcggtgcagctgttcccgtggcttgaaaccacgctgcgctacaccgacgtgcgtacgaaacagtacagcagcgttgatgcgttctccggcgaccagacctacaaagataaagccttcgacgtcaagctgcgcctgtgggaagagagctactggatgccgcaggtgtccgtgggcgccaaagatatcggtggtaccggtctgtttgatgctgaatacatcgtggccagtaaagcctgggggccgttcgacttctcgctcggcctgggatggggctacctgggcactggcggtaacgtgaaaaatccgttttgctcctacagcgataaatactgctaccgcgataacagctataagaaagcgggttccatcaacggtgaccagatgttccacggtccggcatcgctgtttggcggcgtggagtatcaaacgccctggcagccattacgcctgaagctggaatatgaagggaatgactactcgcaggacttcgccgggaagattgagcagaagagcaagtttaacgtcggcgccatttatcgcgtcaccgactgggccgacgttaacctcagctacgagcgcggcaacaccgtgatgtttggcttcacgctgcgcaccaactttaacgatatgcggccacactacaatgataacgcgcgccctgcataccagccggagccgcangatgcgattctgcagcactccgtggtggcaaaccagctgacgctgctgaaatacaatgnccggnctggcggatccccgccacggttgatgagagctttgttgtnntggaccagttggtgattttgaacttttgctttgccacggaacggtctgcgtt

SEQ ID NO: 8 - DNA, 944 bp, Burkholderia gladioli
  misc_feature (4)..(4): n is a, c, g, or t
  misc_feature (7)..(7): n is a, c, g, or t
  misc_feature (10)..(10): n is a, c, g, or t
  misc_feature (14)..(15): n is a, c, g, or t
  misc_feature (736)..(736): n is a, c, g, or t
  misc_feature (846)..(847): n is a, c, g, or t
  misc_feature (887)..(887): n is a, c, g, or t
  misc_feature (889)..(889): n is a, c, g, or t
  misc_feature (891)..(891): n is a, c, g, or t
  misc_feature (925)..(926): n is a, c, g, or t
  misc_feature (929)..(929): n is a, c, g, or t
  misc_feature (936)..(937): n is a, c, g, or t
gccntcnccnaggnngcggcaagcgcacggccatcgtcgtgttcgtcgtgtcgctggcgctgacgctggtgttcgcgctcaaactgttcggagcattctaagaaaatggcaggcaacaaccgaatcggctcgaagcgcctcgtggtcggcgctcactacggcctgcgcgactggctcgcgcaacgcatcaccggcgtcatcatggcggtctacaccgtgatcctgctcgcctggttcttcgcggcgcgcgatttctcctacgacggctgggcatcgatcttcgccacgcaatggatgaagctcgcgaccttcgtcacgctgctggcgctgttctatcacgcctgggtcggcattcgcgatatctggatggattacgtgaagccggtcggcgtgcggctgctgctgcaatcgctgacgatcgtctggctgctcgcgtgcgcgggctacgccgcgcagattctctggagagtgtaaaagaatggctgcaatcaatacttccctgccgcgtcgcaagttcgacgtggtcatcgtcggcgcgggcggctcggggatgcgcgcctcgctgcaactcgcgcgcgcgggcctgtcggtctgcgtgctgtcgaaggtgttcccgacgcgttcgcacacggtcgccgcgcaaggcgggatcggtgcctcgctgggcaacatgagcgaagacaactggcactaccacttctacgacacgatcaagggctccgactggctcggcgancaggacgcgatcgagttcatgtgccgcgaagcgccgaatgccgtctacgagctgtctcttatacacatctcaaccatcatcgatgaattgcttcgttaatacagatgtanntgttccacagggtagccagcagcatcctgcgatgcagatncngnatgccatttcattacctctttctccgcacccganntanatccganntcagcag

SEQ ID NO: 9 - DNA, 880 bp, Burkholderia gladioli
  misc_feature (798)..(799): n is a, c, g, or t
  misc_feature (877)..(877): n is a, c, g, or t
gaactcgatcgcgtcctggtcgccgagccagtcggagcccttgatcgtgtcgtagaagtggtagtgccagttgtcttcgctcatgttgcccagcgaggcaccgatcccgccttgcgcggcgaccgtgtgcgaacgcgtcgggaacaccttcgacagcacgcagaccgacaggcccgcgcgcgcgagttgcagcgaggcgcgcatccccgagccgcccgcgccgacgatgaccacgtcgaacttgcgacgcggcagggaagtattgattgcagccattcttttacactctccagagaatctgcgcggcgtagcccgcgcacgcgagcagccagacgatcgtcagcgattgcagcagcagccgcacgccgaccggcttcacgtaatccatccagatatcgcgaatgccgacccaggcgtgatagaacagcgccagcagcgtgacgaaggtcgcgagcttcatccattgcgtggcgaagatcgatgcccagccgtcgtaggagaaatcgcgcgccgcgaagaaccaggcgagcaggatcacggtgtagaccgccatgatgacgccggtgatgcgttgcgcgagccagtcgcgcaggccgtagtgagcgccgaccacgaggcgcttcgagccgattcggttgttgcctgccattttcttagaatgctccgaacagtttgagcgcgaacaccagcgtcagcgccagcgacacgacgaacacgacgatggccgtgcgcttgccgctttccttggtgacggcgtcatggttgatccccgccacggttgatgagagctttgttgtnntggaccagttggtgattttgaacttttgctttgccacggaacggtctgcgttgtcgggaagatgcgtgatctgatccntca

SEQ ID NO: 10 - DNA, 880 bp, Burkholderia gladioli
  misc_feature (768)..(768): n is a, c, g, or t
  misc_feature (835)..(835): n is a, c, g, or t
  misc_feature (858)..(858): n is a, c, g, or t
  misc_feature (860)..(860): n is a, c, g, or t
  misc_feature (872)..(873): n is a, c, g, or t
acggatgcgcagaatgctgcgccgactttttcgtagagatggccgaggacgcgttcgtctgcgttgtggcgggagaggatgctgcgccagcggaaattcaggtggcggtgtgggtggatcagggattcgagatcgtcgctggagggggcggggagggcggagaggtagtcggtgtagagcttggtgattcgggcgttgtcgtccaactggaaatcttccctcaattgcgggtccatttggtctggagttgcccccgtaactccggacacggcacccacttaggttgctgaatccgtcgcgcgtcgaaactcgcggggtgagcggtacttcaacgcgctatggggatgcttttcgttgtagtgctcaaatgcaatggccagattcctggccgcggtcgctgcgtccggcttcggcatgatagcgacgtaatcgcgcttcatggtcttcacgaagctttccgccatgccgttgctctgcgggctgcacaccggcgtggtcaacggcttcaggccgagcagcaccgcaaactgacgtgtttcgtcggccgtatagcccgagccgttgtcgctcagccactcgatttcggactcggtatgcagcacatccccaaaccggttttccaccgcagccagcatcacgtcgcgcacgatgtcgccgctatggccggccgtcgtggctgcccagctcatcgcttcgcggtcgcagcagtcgagcgcgaacgtcacgcgcaacggctcgccgttgtcgcagcgaaactcgaagccgtcngaacaccaccgttgattgctgcgctccaccgcaaccttgccatcgtgacggcgctgcggccgaaccnggtgccgctctgcgttgcatcancnggccatgcgtgnncattacg

SEQ ID NO: 11 - DNA, 880 bp, Burkholderia gladioli
  misc_feature (781)..(782): n is a, c, g, or t
  misc_feature (873)..(873): n is a, c, g, or t
gttctaaaaggccgacggctcgttggtcccgaagagtgtttttttccagcttcgcagcccaccagtcagttctcgtagaaggcaacttagctttgccgcaccccgcatgttgatgccagaaacaaccgtgcacgaagatggcaagacgaaatcgtggcaggacgatatcgggacaccccggaaggtcctttctgtgcagtcggaagcgaaagcccattttgtgaagagctcgtctaactgccatttccggttgcgtatcgcgctggcgaacccgcgccatcaaccgagaacgattttcgaccgtgaggcggtctaccatatcttcgctctcctcaccccttgggcgagtcgcttggcgcacccgacacactcggcgtgacaacctcaagcgggagtacttcttggtttggaaaatgctcgctgtcgaggtagtctcgaatcagtcgggcaatcagcgtacttttcttgaagccgcgttcgtcgcagtacgagtcgagccgcgcgaactcatgctgcggcagcaacacagtgactttcgtcattcggaccttttgcatgggagctccatgcgcaacagtgcgcacttgtacggagtaaaccggagtttacgtcggccaactgcgagccgcaaggcacaagtgggtaagccgcaccaatgctgtatgaatatacaggttttcgggctcagcggctgcaaagtgcacgccccaacgaacgaccgccacggcaagggagcgtgcactgaaaccgtcacaatcagaccctttgaaaccgtacgaannccggccgtatagtgatttacgtgcggtcggcaaccggcaagtacatcaatagaatcagtgtgttacggcgaagttggggcatcagtgaacngcccctt

SEQ ID NO: 12 - DNA, 880 bp, Burkholderia gladioli
  misc_feature (849)..(852): n is a, c, g, or t
  misc_feature (873)..(873): n is a, c, g, or t
cgccgggtgctcgggcgtgcgcgcggcgatgcggcgcggcagctcggcgatacgcgcgggcagggcggcgagcagcgcctcggtgtcgagcggcgcggtgggcggcgaggacggggacgactgggaagctgacggagaagcggactgggaagcgggcatcgtggctccggaaacaggccgggtcgcagggccttgctgaagatgttcaataaggtgtcgatcgtgccacgcgcaccgcggcggggcaatctgccgaacggacaatagtgcttcgcggcgcgcgcaattaaaatgcgcccatgagcaaatcccgacatgtctccgaaacccccgccacgcaatggctgcgccgccagggcgtggccttcggcgagcacacctacgactacgtcgagcacggcggcacgggcgaatcggcgcgccagctaggcgtggacgagcacgcggtggtcaagaccctggtgatggaggacgagcaggccaggccgctggtgatcctgatgcatggcgatcgtaccgtctccaccaagaacctggcgcggcagatcggcgccaagcgcgtcgagccctgcaagcccgaggtcgcgaaccgtcattcgggctacctggtaggcggcacctcgccgttcggcaccaagaaagcgatgcccgtctacgtcgagtcgagcgtgctcgagctgccctcgatcctcatcaacggcggcaagcgcggctacctgctgagcctcgcgccggcggtgctgaccgacgtgctcggcgcgaaaccggtgcagtgcgccagcgtcgattgagggtttcacccggaaccggggccggcccgcttcggtagaatgggcgccgcgcggcgcnnnntggcccggcggcggcgccccnttcactt

SEQ ID NO: 13 - DNA, 965 bp, Burkholderia gladioli
  misc_feature (17)..(17): n is a, c, g, or t
  misc_feature (722)..(722): n is a, c, g, or t
  misc_feature (755)..(755): n is a, c, g, or t
  misc_feature (766)..(766): n is a, c, g, or t
  misc_feature (891)..(892): n is a, c, g, or t
  misc_feature (905)..(905): n is a, c, g, or t
  misc_feature (939)..(939): n is a, c, g, or t
  misc_feature (941)..(941): n is a, c, g, or t
  misc_feature (954)..(954): n is a, c, g, or t
ggcgcgccggatcgccnccaccgcgtcgaacacgtcgcgcggcgtcgcctcggccggcgcgatgccgcgcgcggcgaattcgcgcgagacatcggcgtagttgcaacgcggcgtccatcgcttgggcagcctgaacgtgaccgagacgatcgcgaagcggtcccgcgcggcctgcttgaaaacgctgtcgcgatagccgaacgcgcaggccgcggcatcgaattcgacgatctcgccggtggccagctcgaccgccttcagcgatgcgaagcgttcgcgcatctcgatgccgtaggcgccgatgttctggatcggcgcggcgcccaccgtgcccgggatcagcgcgagattctcgagccccggcatgccggcatccagggtccaggccacgaactcgtgccagttctcgccgccgccggcttccacgtaccaggcctcgtcgtcctcgcgcagcagcgcgcggccgcgcacgccgttgatcagcaccagcgcgtcgacgtcgcccgtgaacaccacgttgctgccgccgccgagcaccagcactggcaggccggctgcgcgcgggtcgcgcgccgcggcggcgaagccggcctgcgtgtcgacgcgcgccgcccagcgcgcgcgcaccgcgaaaccgaagctgttgtgctcgcgcagcgggtaatcgggcagcagcaccggcacgccggcagcctccgaggcgggagcggacgaaggcggangagcagcggcggaaggggaaggggaaggggaangggaagcgaantcggaatctgacatcggcggcagggggcgcggcgttcgcgggtcacgccgacgtgagcggcggccttgggcaaaacgcgggggcatcggtaaaatggcggtcggtccgcaattatagcgagtggnngcgcacgcatcgngcggcccgcatgttttacagggagaacagcatgncntcgttcgacgtcntttccgaagcg

SEQ ID NO: 14 - DNA, 937 bp, Burkholderia gladioli
  misc_feature (7)..(7): n is a, c, g, or t
  misc_feature (12)..(12): n is a, c, g, or t
  misc_feature (701)..(701): n is a, c, g, or t
  misc_feature (926)..(927): n is a, c, g, or t
ggcgganagccnccggcaatgtacgcaacggcgcacaacggctgcccaggcgaacggcaaaaacgacgccctgcgcttcacggtggggtgctccaccttgaacccgagggttctatcgccagtcacgcaggggctgatgagcgccgtagtttattggatggccgatgaataggcaaccggccggccggccctgtggagcaataagggcgcgatcgaaatcaccgcgaacgccacgccgggcctgcctccgtcgccgcatccgggcctggaaagcaggccgccgccgtgcccgaccaccacccgtgtcgccttgccgcaacgcggcattgtcagtaggctaacgatcccccctatcgtttcaccccaccgaccaggagcagcagcaatgatcgtgttcgtcaccggcgcatccgcgggattcggcgccgccatcgcccggaccttcgtcaagggcggccatcgcgtgatcgccagcgcgcgccgcaaggaccggctcgacgccctcgccgccgaactcggcgaggccctgctgcccgtcgagctcgacgtgcgcgagcgcggcgccatcgaggccgcgctcgcgggcctgccggcggacttcgccgggatcgacgtgctggtcaacaacgccggcctcgcgctgggtaccgagccggcccagcgggccagcctcgacgagtggcagaccatgatcgacaccnattgctcgggcctggtcaccgtcacgcacacgctgctgcccggcatgatcgcgcgcggccgcggccacatcttcaacctgggctcggtcgccggcacctacccgtacgcgggcggcaacgtctacggcgcgaccaaggcatttgtccgacaattcagcctgaacctgcgcaccgacctgctgggcacgccgctgcgcgtgaccgacatcgagccgggcctctgcnncggcaccgaa

SEQ ID NO: 15 - DNA, 880 bp, Burkholderia gladioli
  misc_feature (614)..(614): n is a, c, g, or t
  misc_feature (753)..(753): n is a, c, g, or t
caccagcccttcggtggcgccgttccagacgatgaacggcttgacccggcgcttgaccttgtcggcataaccgggcgaggtggcattgccgcccgagcccgaacccgtgccgctcttggccaggccgtcgctgccgccctggccgcctgccgcgccctgcaactgcgcgaggcgcgcctggcgctccttgtcgagcttggcattggccgcggcggtggccttggccttcgcggccgcgtcggccttcgccttggccgcggcttccgccttggcggccgccgccttctcggcctcggccttcttctgcgcttcagcctgtgcctgctcctgcttgcgttgctgctcgagcttctgctgttgctcgagtttcttctgttcggcgagttgttgctggcgcaacttgtcggcctgcttctgcttttccgctgcctgctgctgggcaagctgctgcgccgccagctgggcggcgcgcctggcttcggcttcctgctgctgggccttcagcgcctgctcgcggcgctgctcggcgagctgcgcctcgcgcgcggccgcttcctgctgctggcggcgcttctgctgcagggcgatctcggcatcgtcgtcccgcgccggangcggcgcgggggcgacgcgcaccggcggggcgggcggcggcaccgggcgcggcgccggcgaatccggcacttcggtccacagctcggcttccgcgccggccggcgtgctgttctgccaattgatgccgtggtagagcanggccaccagcagcacgtgcatcagcgccgcgagcaggaacgcgcgtcccgtgccgcgttctcgaggcggctgcagcggtgaggcggtgcgggtcttgcgctggttcattgcgatttgacgaggaggc

SEQ ID NO: 16 - DNA, 935 bp, Burkholderia gladioli
  misc_feature (6)..(6): n is a, c, g, or t
  misc_feature (910)..(910): n is a, c, g, or t
gcgganagccaccggcaatgtacgcaacggcgcacaacggctgcccaggcgaacggcaaaaacgacgccctgcgcttcacggtggggtgctccaccttgaacccgagggttctatcgccagtcacgcaggggctgatgagcgccgtagtttattggatggccgatgaataggcaaccggccggccggccctgtggagcaataagggcgcgatcgaaatcaccgcgaacgccacgccgggcctgcctccgtcgccgcatccgggcctggaaagcaggccgccgccgtgcccgaccaccacccgtgtcgccttgccgcaacgcggcattgtcagtaggctaacgatcccccctatcgtttcaccccaccgaccaggagcagcagcaatgatcgtgttcgtcaccggcgcatccgcgggattcggcgccgccatcgcccggaccttcgtcaagggcggccatcgcgtgatcgccagcgcgcgccgcaaggaccggctcgacgccctcgccgccgaactcggcgaggccctgctgcccgtcgagctcgacgtgcgcgagcgcggcgccatcgaggccgcgctcgcgggcctgccggcggacttcgccgggatcgacgtgctggtcaacaacgccggcctcgcgctgggtaccgagccggcccagcgggccagcctcgacgagtggcagaccatgatcgacaccaattgctcgggcctggtcaccgtcacgcacacgctgctgcccggcatgatcgcgcgcggccgcggccacatcttcaacctgggctcggtcgccggcacctacccgtacgcgggcggcaacgtctacggcgcgaccaaggcatttgtccgacaattcagcctgaacctgcgcaccgacctgctgggcacgccgctgcgcgtgaccgacatcnagccgggcctctgcggcggcaccga

SEQ ID NO: 17 - DNA, 937 bp, Burkholderia gladioli
  misc_feature (9)..(9): n is a, c, g, or t
  misc_feature (884)..(884): n is a, c, g, or t
  misc_feature (932)..(932): n is a, c, g, or t
  misc_feature (934)..(934): n is a, c, g, or t
ggttgagangtgtataagagacaggatgagcacattgacctgcgcgttggcggtgctgcccgccgcgatcaggcacgaggccaccagtgccctgaaacccagcttcgtcatcaaactcatgcgtcctgtttcccgtatgtaactgtgcaaccgcaaagacctaacaatagccgattcgttccttgtggcgacggcgcgagtgtatgccgattccgtgtcactccgccgcccggaaggtaattgcaatattcgccggggtactcccgttagtatcgggcggcaggggcgaggccgcccgcaccgcgccgaccacggtttcgtcccaggccggattgccgctcggcttcaccaccgagacgccgagcacgtcgcccgacggcgagcagcgcacctgcacacgcgtcaccagcccttcggtggcgccgttccagacgatgaacggcttgacccggcgcttgaccttgtcggcataaccgggcgaggtggcattgccgcccgagcccgaacccgtgccgctcttggccaggccgtcgctgccgccctggccgcctgccgcgccctgcaactgcgcgaggcgcgcctggcgctccttgtcgagcttggcattggccgcggcggtggccttggccttcgcggccgcgtcggccttcgccttggccgcggcttccgccttggcggccgccgccttctcggcctcggccttcttctgcgcttcagcctgtgcctgctcctgcttgcgttgctgctcgagcttctgctgttgctcgagtttcttctgttcggcgagttgttgctggcgcaacttgtcggcctgcttctgcttttccgctgcctgctgctgggcaagctgctgcgccgccagctgggcggcgcgcctggcttcngcttcctgctgctgggccttcagcgcctgctcgcggcgctgctcggcnanctg

SEQ ID NO: 18 - DNA, 930 bp, Burkholderia gladioli
  misc_feature (5)..(5): n is a, c, g, or t
  misc_feature (820)..(820): n is a, c, g, or t
  misc_feature (827)..(827): n is a, c, g, or t
  misc_feature (912)..(912): n is a, c, g, or t
  misc_feature (921)..(921): n is a, c, g, or t
agccnccggcaatgtacgcaacggcgcacaacggctgcccaggcgaacggcaaaaacgacgccctgcgcttcacggtggggtgctccaccttgaacccgagggttctatcgccagtcacgcaggggctgatgagcgccgtagtttattggatggccgatgaataggcaaccggccggccggccctgtggagcaataagggcgcgatcgaaatcaccgcgaacgccacgccgggcctgcctccgtcgccgcatccgggcctggaaagcaggccgccgccgtgcccgaccaccacccgtgtcgccttgccgcaacgcggcattgtcagtaggctaacgatcccccctatcgtttcaccccaccgaccaggagcagcagcaatgatcgtgttcgtcaccggcgcatccgcgggattcggcgccgccatcgcccggaccttcgtcaagggcggccatcgcgtgatcgccagcgcgcgccgcaaggaccggctcgacgccctcgccgccgaactcggcgaggccctgctgcccgtcgagctcgacgtgcgcgagcgcggcgccatcgaggccgcgctcgcgggcctgccggcggacttcgccgggatcgacgtgctggtcaacaacgccggcctcgcgctgggtaccgagccggcccagcgggccagcctcgacgagtggcagaccatgatcgacaccaattgctcgggcctggtcaccgtcacgcacacgctgctgcccggcatgatcgcgcgcggccgcggccacatcttcaacctgggctcggtcgccggcacctacccgtacgcgggcggcaacgtctacngcgcgancaaggcatttgtccgacaattcagcctgaacctgcgcaccgacctgctgggcacgccgctgcgcgtgaccgacatcgagccgggnctctgcggnggcaccgaa

SEQ ID NO: 19 - DNA, 935 bp, Burkholderia gladioli
  misc_feature (9)..(9): n is a, c, g, or t
  misc_feature (666)..(666): n is a, c, g, or t
  misc_feature (784)..(784): n is a, c, g, or t
  misc_feature (802)..(802): n is a, c, g, or t
  misc_feature (887)..(887): n is a, c, g, or t
  misc_feature (903)..(903): n is a, c, g, or t
  misc_feature (917)..(917): n is a, c, g, or t
  misc_feature (930)..(930): n is a, c, g, or t
ggttgagangtgtataagagacagacggcgagcagcgcacctgcacacgcgtcaccagcccttcggtggcgccgttccagacgatgaacggcttgacccggcgcttgaccttgtcggcataaccgggcgaggtggcattgccgcccgagcccgaacccgtgccgctcttggccaggccgtcgctgccgccctggccgcctgccgcgccctgcaactgcgcgaggcgcgcctggcgctccttgtcgagcttggcattggccgcggcggtggccttggccttcgcggccgcgtcggccttcgccttggccgcggcttccgccttggcggccgccgccttctcggcctcggccttcttctgcgcttcagcctgtgcctgctcctgcttgcgttgctgctcgagcttctgctgttgctcgagtttcttctgttcggcgagttgttgctggcgcaacttgtcggcctgcttctgcttttccgctgcctgctgctgggcaagctgctgcgccgccagctgggcggcgcgcctggcttcggcttcctgctgctgggccttcagcgcctgctcgcggcgctgctcggcgagctgcgcctcgcgcgcggccgcttcctgctgctggcggcgcttctgctgcagggcgatctcggcatcgtcgtcccgcgccggangcggcgcgggggcgacgcgcaccggcggggcgggcggcggcaccgggcgcggcgccggcgaatccggcacttcggtccacagctcggcttccgcgccggccggcgtgctgttctgccnattgatgccgtggtagancagggccaccagcagcacgtgcatcagcgccgcgagcaggaacgcgcgtcccgtgccgcgttctcgaggcggctgcagcggtgangcggtgcgggtcttgngctggttcattgcnatttgacgaggangccca

SEQ ID NO: 20 - DNA, 936 bp, Burkholderia gladioli
  misc_feature (19)..(19): n is a, c, g, or t
  misc_feature (23)..(23): n is a, c, g, or t
  misc_feature (708)..(708): n is a, c, g, or t
  misc_feature (803)..(803): n is a, c, g, or t
  misc_feature (888)..(888): n is a, c, g, or t
  misc_feature (910)..(910): n is a, c, g, or t
  misc_feature (918)..(918): n is a, c, g, or t
  misc_feature (923)..(923): n is a, c, g, or t
  misc_feature (931)..(931): n is a, c, g, or t
cagacgcgcggcatctggnaggngctgctcgaaggcgccgagctctatcgcgccgaagccaagaacgaggaaacgctgcgcaagttcagccacggcacgccgaacgactggatcgagcgcaacctgtctcttatacacatctcaaccatcatcgatgaattgcttcgttaatacagatgtaggtgttccacagggtagccagcagcatcctgcgatgcagatccggatgccatttcattacctctttctccgcacccgacatagatccgaagatcagcagttcaacctgttgatagtacgtactaagctctcatgtttcacgtactaagctctcatgtttaacgtactaagctctcatgtttaacgaactaaaccctcatggctaacgtactaagctctcatggctaacgtactaagctctcatgtttcacgtactaagctctcatgtttgaacaataaaattaatataaatcagcaacttaaatagcctctaaggttttaagttttataagaaaaaaaagaatatataaggcttttaaagcttttaaggtttaacggttgtggacaacaagccagggatctgccatttcattacctctttctccgcacccgacatagatccggaacataatggtgcagggcgctgacttccgcgtttccagactttacgaaacacggaaaccgaagaccattcatgttgttgctcangtcgcagacgttttgcagcagcagtcgcttcacgttcgctcgcgtatcggtgattcattctgctaaccagtaaggcaaccccgccagcctagccnggtcctcaacgacaggagcacgatcatgcgcacccgtggccaggacccaacgctgcccgagatgcgccgcgtgcggctgctgganatggcggacgcgatggatatgntctgccangggtnggtttgcncattc

SEQ ID NO: 21 - DNA, 938 bp, Burkholderia gladioli
  misc_feature (9)..(9): n is a, c, g, or t
  misc_feature (736)..(736): n is a, c, g, or t
  misc_feature (776)..(776): n is a, c, g, or t
  misc_feature (802)..(804): n is a, c, g, or t
  misc_feature (842)..(843): n is a, c, g, or t
  misc_feature (875)..(875): n is a, c, g, or t
  misc_feature (877)..(877): n is a, c, g, or t
  misc_feature (911)..(911): n is a, c, g, or t
  misc_feature (913)..(913): n is a, c, g, or t
  misc_feature (920)..(920): n is a, c, g, or t
ggttgagangtgtataagagacaggttgcgctcgatccagtcgttcggcgtgccgtggctgaacttgcgcagcgtttcctcgttcttggcttcggcgcgatagagctcggcgccttcgagcagcaccttccagatgccgcgcgtctgcgggctgtgcggatccccgccacggttgatgagagctttgttgtaggtggaccagttggtgattttgaacttttgctttgccacggaacggtctgcgttgtcgggaagatgcgtgatctgatccttcaactcagcaaaagttcgatttattcaacaaagccgccgtcccgtcaagtcagcgtaatgctctgccagtgttacaaccaattaaccaattctgattagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgancgagacgaaatacgcgatcgctgttaaaaggacaattacnaacaggaatcgaatgcaaccggcgcnnnacactgccagcgcatcaacaatattttcacctgaatcnnatattcttctaatacctggaatgctgtttttncnggggatcgcagtggtgagtaaccatgcatcatcngnagtacgnataaaatgcttgatggtc

SEQ ID NO: 22 - DNA, 938 bp, Burkholderia gladioli
  misc_feature (842)..(842): n is a, c, g, or t
  misc_feature (854)..(854): n is a, c, g, or t
  misc_feature (872)..(872): n is a, c, g, or t
  misc_feature (891)..(891): n is a, c, g, or t
  misc_feature (928)..(928): n is a, c, g, or t
gaccgctggcacggcttcggcccgctcgcggaaggcttcaacatgctggacccgatcaaggccaccatcatcaccccctgtctcttatacacatctcaaccatcatcgatgaattgcttcgttaatacagatgtaggtgttccacagggtagccagcagcatcctgcgatgcagatccggatgccatttcattacctctttctccgcacccgacatagatccgaagatcagcagttcaacctgttgatagtacgtactaagctctcatgtttcacgtactaagctctcatgtttaacgtactaagctctcatgtttaacgaactaaaccctcatggctaacgtactaagctctcatggctaacgtactaagctctcatgtttcacgtactaagctctcatgtttgaacaataaaattaatataaatcagcaacttaaatagcctctaaggttttaagttttataagaaaaaaaagaatatataaggcttttaaagcttttaaggtttaacggttgtggacaacaagccagggatctgccatttcattacctctttctccgcacccgacatagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggccaggacccaacgctgcccgagatgcgccgcgtgcggctgctgganatggcggacgcnatggatatgttctgccangggttggtttgcgcattcncagggtgtcccaaaatctctgatgttacattgcacanataaaatata

SEQ ID NO: 23 - DNA, 935 bp, Burkholderia gladioli
  misc_feature (9)..(9): n is a, c, g, or t
  misc_feature (758)..(758): n is a, c, g, or t
  misc_feature (798)..(799): n is a, c, g, or t
  misc_feature (874)..(874): n is a, c, g, or t
  misc_feature (900)..(900): n is a, c, g, or t
ggttgagangtgtataagagacagggggtgatgatggtggccttgatcgggtccagcatgttgaagccttccgcgagcgggccgaagccgtgccagcggtcgttcgggcgcaggatccccgccacggttgatgagagctttgttgtaggtggaccagttggtgattttgaacttttgctttgccacggaacggtctgcgttgtcgggaagatgcgtgatctgatccttcaactcagcaaaagttcgatttattcaacaaagccgccgtcccgtcaagtcagcgtaatgctctgccagtgttacaaccaattaaccaattctgattagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcangaacactgccagcgcatcaacaatattttcacctgaatcnnatattcttctaatacctggaatgctgtttttccggggatcgcagtggtgagtaaccatgcatcatcaggagtacngataaaatgcttgatggtcggaagangcataaattccgtcagccagtttagtctgaccatc

SEQ ID NO: 24 - DNA, 852 bp, Burkholderia gladioli
  misc_feature (787)..(787): n is a, c, g, or t
  misc_feature (848)..(848): n is a, c, g, or t
cgtgcccgccaattgcccgctctggcacaatagctacggcttcgtgcgtggcatcgtcgaccacggtcagattcttgatcacgcggccttcagccgtgcggtcgaacacaaaatccattgaccacacctgattggctgccgacggtcggcccaatggctggcgttgcgcagccggaaccttcttgcgcttgcggcggcgcacctgcagattctcttgcgcgtacagccgctccacgcgcttgtggttcacgaccatgcccgattgccgcaatttcagtaaatcatgcccgagccatagcgacggtgccgctgcgctaacgcgacgatctgcgcacgcaaggcgagattgcggtccggcgcgggctgatagcgataagcgctggcgctcatgccgatcactcgcaacgcatgtcgctcgctcaagccgccgtggatcatatggcgcaccaagtcgcggcgtgacggtgcgctcaccacttttttcgcagcgcctccggagtgacttcgttctccagcatcgattccgcgagcaacttcttcagccggttgttttcggcctccaattctttcaggcgcttcgcgtcggacacgctcatgccgccgaacttgctgcgccacaagtagtagcttgcctcggaaaagccatgctgtcggcagagctccttgatcggcaagccggcctccgcctcgcgcaggaaaccaatgatctgctcttcggtgaatcgtttcttcatgcccaatctcctgactgcgtgattggactctaaagcgtcatgctactcaagancggggggacgtcgccctgtctgaactgctcgttgtacttcgtcatgtaaaacaccccaaangttg

SEQ ID NO: 25 - DNA, 937 bp, Burkholderia gladioli
  misc_feature (9)..(9): n is a, c, g, or t
  misc_feature (927)..(927): n is a, c, g, or t
ggttgagangtgtataagagacaggcccaccagtcagttctcgtagaaggcaacttagctttgccgcaccccgcatgttgatgccagaaacaaccgtgcacgaagatggcaagacgaaatcgtggcaggacgatatcgggacaccccggaaggtcctttctgtgcagtcggaagcgaaagcccattttgtgaagagctcgtctaactgccatttccggttgcgtatcgcgctggcgaacccgcgccatcaaccgagaacgattttcgaccgtgaggcggtctaccatatcttcgctctcctcaccccttgggcgagtcgcttggcgcacccgacacactcggcgtgacaacctcaagcgggagtacttcttggtttggaaaatgctcgctgtcgaggtagtctcgaatcagtcgggcaatcagcgtacttttcttgaagccgcgttcgtcgcagtacgagtcgagccgcgcgaactcatgctgcggcagcaacacagtgactttcgtcattcggaccttttgcatgggagctccatgcgcaacagtgcgcacttgtacggagtaaaccggagtttacgtcggccaactgcgagccgcaaggcacaagtgggtaagccgcaccaatgctgtatgaatatacaggttttcgggctcagcggctgcaaagtgcacgccccaacgaacgaccgccacggcaagggagcgtgcactgaaaccgtcacaatcagaccctttgaaaccgtacgaatccggccgtatagtgatttacgtgcggtcggcaaccggcaagtacatcaatagaatcagtgtgttacggcgaagttggggcatcagtgaaccgcccctttttcgagtccctgattcgctaccaaatgcagaaagggctcagcgcatgaactgcaccccaaaagttggaccccccgtccnacctttgggg

SEQ ID NO: 26 - DNA, 660 bp, Burkholderia gladioli
cctggtagtccacgccctaaacgatgtcaactagttgttggggattcatttccttagtaacgtagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatggtcggaatcctggagagatctgggagtgctcgaaagagaaccgatacacaggtgctgcatggctgtcgtcagctcgtgtcgtgagatgttgggttaagtcccgcaacgagcgcaacccttgtccttagttgctacgcaagagcactctagggagactgccggtgacaaaccggaggaaggtggggatgacgtcaagtcctcatggcccttatgggtagggcttcacacgtcatacaatggtcggaacagagggtcgccaacccgcgagggggagctaatcccagaaaaccgatcgtagtccggattgcactctgcaactcgagtgcatgaagctggaatcgctagtaatcgcggatcagcatgccgcggtgaatacgttcccgggtcttgtacacaccgcccgtcacaccatgggagtgggttttaccagaagtggctagtctaaccgcaaggaggac

SEQ ID NO: 27 - DNA, 617 bp, Paenibacillus polymyxa
  misc_feature (182)..(182): n is a, c, g, or t
  misc_feature (431)..(432): n is a, c, g, or t
tcgatacccttggtgccgaagttaacacattaagcattccgcctggggagtacggtcgcaagactgaaactcaaaggaattgacggggacccgcacaagcagtggagtatgtggtttaattcgaagcaacgcgaagaaccttaccaggtcttgacatccctctgaccggtctagagataggnctttccttcgggacagaggagacaggtggtgcatggttgtcgtcagctcgtgtcgtgagatgttgggttaagtcccgcaacgagcgcaacccttatgcttagttgccagcaggtcaagctgggcactctaagcagactgccggtgacaaaccggaggaaggtggggatgacgtcaaatcatcatgccccttatgacctgggctacacacgtactacaatggccggtacaacgggaagcgaaggagcganntggagccaatcctagaaaagccggtctcagttcggattgtaggctgcaactcgcctacatgaagtcggaattgctagtaatcgcggatcagcatgccgcggtgaatacgttcccgggtcttgtacacaccgcccgtcacaccacgagagtttacaacacccgaagtcggtgaggtaaccgcaagg

SEQ ID NO: 28 - DNA, 649 bp, Bacillus subtilis
cccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaaggtgggacagatgattggggtgaagt

SEQ ID NO: 29 - protein, 161 aa, Burkholderia gladioli
MPSFDVVSEANMIEVKNAVEQSNKEISTRFDFKGSDARVEHKEQELTLFADDDFKLGQVKDVLIGKMAKRNVDVRFLDYGKVDKIGGDKLKQVVTIKKGVTGDLAKRVVRTVKDSKIKVQASIQGDAVRVSGTKRDDLQSVIALLRKEVADTPLDFNNFRD

SEQ ID NO: 30 - protein, 537 aa, Burkholderia gladioli
MPASQSASPSASQSSPSSPPTAPLDTEALLAALPARIAELPRRIAARTPEHPALIEDARRLSYAELVTAIDASAAQLRALGVRGGDRVMIVAENSIAQIVLLFAAATLDAWALLANARLSAAELDAIAAHARPRAITFVTATSPDAAAHAARHRAVPAAAGEPDIGTWAVALDPGTHAEAVETEGARQCAALIYTTGTTGTPKGVMLSHRNLLFVAAVSSTLRRVSASDVVYTVLPVSHVYGLASVCLGSLCAGASLRLAPRFVPEAVRRALADERVTIFQGVPAMHAKLLDHLQAHGHAWQAPQLRFVYSGGSPLDADLKARVERVYGLPLHNGYGMTESSPTVAQTLLEAPRGDCSVGVPIPGIEVRLVDPELKPVPPGEVGEIMVRGPNVMLGYYRNPEATRAAITAEGWLRTGDLARAAADGALSIAGRSKELIIRSGFNVYPAEVEHVLNAHPAVVQSAVIGRAVPGNEEVLAFVELTPGAALAADELDAWCAARLAPYKRPARIVAVEALPAASTGKVLKHRLREHAAYKD

SEQ ID NO: 31 - protein, 394 aa, Burkholderia gladioli
MLDFLAHGLLHFSWWQIVLATLVATHVTIVSVTIYLHRCQAHRALDLHPAVSHFFRLWLWMSTGMLTGQWAAIHRKHHAKCETEEDPHSPQTRGIWKVLLEGAELYRAEAKNEETLRKFSHGTPNDWIERNVYSKYTILGVSLMMVIDVALFGIVGLSVWAVQMIWIPFWAAGVVNGLAHFWGYRNFNSADASTNLIPWGIVIGGEEMHNNHHTFATSAKFSNKWYEFDIGWMYIRILSAFKLAKVKKIAPTPRLVARKAVVDQETLQAVLSNRYEVMANYGKALKRAYRQELAHLKELGSSEKYQLLRGARSWFHKDEEGLNEPQKRLLPEIFANSQKMHTYFQLRQDLASMWDRSNASREQLLAQLQDWCHRAEQSGIKALQEFATRLRRYA

SEQ ID NO: 32 - protein, 64 aa, Burkholderia gladioli
MLLPQHEFARLDSYCDERGFKKSTLIARLIRDYLDSEHFPNQEVLPLEVVTPSVSGAPSDSPKG

SEQ ID NO: 33 - protein, 149 aa, Burkholderia gladioli
MAGTPLRSSMRGGRSRRSMADINVVPYIDVMLVLLVIFMVTAPLVAPSIVNLPTVGNAAPQDQTPPVVVNIQADGRMSVRYKSDAGASQEDTMSKAELDDFIASRQADHPDQPVVIAADKTVQYDKVMTVMSDLKARGVKRVGLLVKSQ

SEQ ID NO: 34 - protein, 759 aa, Burkholderia gladioli
MKFRFPVVIIDEDFRSENISGSGIRALAEAIEKEGVEVLGLTSYGDLTSFAQQSSRASCFILSIDDDELMLGETGPDGELPELATAILELRAFVTEVRRRNADIPIFLYGETRTSRHIPNDVLRELHGFIHMFEDTPEFVARHIIRETKVYLDSLAPPFFKELVKYADEGSYSWHCPGHSGGVAFLKNPLGQMFHQFFGENMLRADVCNAVDELGQLLDHTGPVAASERNAARIFSADHLFFVTNGTSTSNKIVWHANVAPGDIVLVDRNCHKSILHAITMTHAIPVFLTPTRNHFGIIGPIPRDEFKPENIRKKIEANPFAREALQKNPNAKPRILTITQSTYDGVIYNVEHIKDLLGDLLDTLHFDEAWLPHAEFHEFYRDMHAIGAGRPRTGSLVFATHSTHKLLAGISQASQIVVQDSENRTFDKHRFNEAYLMHTSTSPQYAIIASCDVAAAMMEPPGGTALVEESIAEAIEFRRAMRKVDAEYGDDWFFSVWGPDTLPEEGIGSREDWILRPNDRWHGFGPLAEGFNMLDPIKATIITPGLDVDGEFGETGIPAAIVTKYLAEHGIIVEKTGLYSFFIMFTIGITKGRWNSMVTELQQFKDDYDNNQPLWRVLPEFVAQFPIYERVGLRDLCTQIHDVYRANDIARLTTEMYLSDMEPAMKASDAFAKLAHREIDRVPLDELEGRVTSILLTPYPPGIPLLIPGERFNATIVNYLRFARDFNERFPGFHTDVHGLVAEEVNGRVEYYVDCVRD

SEQ ID NO: 35 - protein, 591 aa, Burkholderia gladioli
MAAINTSLPRRKFDVVIVGAGGSGMRASLQLARAGLSVCVLSKVFPTRSHTVAAQGGIGASLGNMSEDNWHYHFYDTIKGSDWLGDQDAIEFMCREAPNAVYELEHFGMPFDRNADGTIYQRPFGGHTANYGEKPVQRACAAADRTGHALLHTLYQQNVAAKTQFFVEWMALDLIRDADGDVLGVTALEMETGDVYILEGKTTLFATGGAGRIFAASTNAFINTGDGLGMAARSGIALQDMEFWQFHPTGVAGAGVLITEGVRGEGGILRNSDGERFMERYAPTLKDLAPRDFVSRSMDQEIKEGRGVGPNKDHVLLDLSHIGAETIMKRLPSIREIALKFANVDCIKEPIPVVPTIHYQMGGIPTNIHGQVVGTSKGHEDPINGFYAVGECSCVSVHGANRLGTNSLLDLVVFGRAAGNHIVEHVKKQREHKPLPKDAADFALSRLAKLDSSSSGEYAQSVANEIRGSMQKHAGVFRTSALLAEGVEDIKKVAERAQHIHLKDKSKVFNTARVEALEVANLVEVARATMVSAEARKESRGAHAQDDFPHRDDENWMRHTLWFSEGDRLDYKPVHMQPLTVESVPPKARTF

(19) United States
(12) Patent Application Publication
(10) Pub. No.: US 2017/0273309 A1
(43) Pub. Date: Sep. 28, 2017

(54) BACTERIAL ENDOPHYTES FOR BIOCONTROL OF FUNGUS

(71) Applicant: University of Guelph, Guelph (CA)

(72) Inventors: Manish N. Raizada, Milton (CA); Hanan Shehata, Guelph (CA); David Johnston Monje, Cambridge, MA (US); Eric Lyons, Guelph (CA); Katerina Serlemitsos Jordan, Guelph (CA)

(21) Appl. No.: 15/514,302

(22) PCT Filed: Sep. 28, 2015
(86) PCT No.: PCT/CA2015/050970

§ 371 Date: Mar. 24, 2017

Related U.S. Application Data
(60) Provisional application No. 62/055,972, filed on Sep. 26, 2014.
(60) Provisional application No. 62/078,604, filed on Nov. 12, 2014.

(51) Int. Cl. A01N 63/00

(52) U.S. Cl. CPC A01N 63/00

(57) ABSTRACT

Bacterial endophytes isolated from maize are described. The endophytes are useful in preventing or inhibiting fungal growth on a plant, in particular preventing or inhibiting dollar spot disease and/or brown spot disease in grass. Genes required for the anti-fungal activity of the bacterial endophytes are also described.

### RELATED APPLICATIONS

This application claims the benefit of priority of US Provisional Patent Application Ser. No. 62/055,972 filed on Sep. 26, 2014, and 62/078,604 filed on Nov. 12, 2014, both of which are hereby incorporated by reference in their entirety.

### INCORPORATION OF SEQUENCE LISTING

A computer readable form of the Sequence Listing “6580-P47111PC00_SequenceListing.txt” (63.4 KB), submitted via ePCT and created on Sep. 28, 2015, is herein incorporated by reference.

### FIELD

The present disclosure relates to the use of bacterial endophytes for the biocontrol of fungal growth in plants.

### BACKGROUND

In agriculture, annual crop losses due to pre- and post-harvest fungal diseases exceed 200 billion euros and, in the United Stated alone, over $600 million are annually spent on fungicides [18]. It is estimated that fungi share 40-60% loss from total plant pathogenic losses [19].

The Golf Course Superintendents Association of America (GCSAA) estimates there are 2.2 million acres of golf courses in the US, equivalent to two Rhode Islands and Delaware combined. They estimate that there are 18,000 golf courses in the US with >35,000 globally. The most widely used turf on golf greens in the US and Canada is creeping bentgrass (Agrostis stolonifera).

In North America, 42% of turf superintendents report that dollar spot, caused by the fungus Sclerotinia homoeocarpa, is their most important disease problem, most severely infecting creeping bentgrass on golf courses [11]. Indeed, dollar spot is considered the most common and important turf disease worldwide [11]. The fungus infects turf leaves causing 6-inch diameter disease patches. The infection can spread to the crown region of the plant, causing death, “leaving a sunken depression in the turf stand that detracts from the playability and/or aesthetic value” [11]. The fungus infects diverse genera of turf including bentgrasses (Agrostis), bermudagrass (Cynodon sp.), bluegrass (Poa sp.), fescue (Festuca sp.), ryegrass (Lolium sp.) and zoysiagrass (Zoysia sp.). The disease was controllable until 10-15 years ago, but now contemporary management of golf courses, fungicide resistance and loss of effective fungicides, has made control difficult [16]. Sclerotinia homoeocarpa also causes white mold in legumes, sunflowers, canola, most vegetables, tobacco, many flowering bedding plants, and stone fruits.

Rhizoctonia solani is another very important and strongly damaging pathogenic fungus that affects some species of cool season grass including creeping bentgrass, bluegrass, fescue, and ryegrass as well as some warm-season grasses like zoysiagrass. Rhizoctonia solani is the causative agent of brown patch disease in cool season grasses. The disease appears as brown patches of diseased turf of different diameters ranging from 5 cm to 1 m. High temperature, high humidity and excessive nitrogen favor disease progress. Some of the cultural practices used to control R. solani are increased aeration, avoidance of excess nitrogen application and maintain low height thatch. Rhizoctonia solani also causes rhizoctonia root rot of wheat and barley. Root damage caused by Rhizoctonia solani is readily diagnosed by the characteristic spear-tipping of roots. Plants with root rot caused by Rhizoctonia solani typically die in patches.

Fusarium is a widespread pathogen of cereal crops. Fusarium graminearum is commonly found on cereal grains, most commonly on wheat and barley. F. graminearum is the causal agent of Gibberella ear rot in maize and Fusarium head blight in wheat. On wheat, the spores germinate on the kernel and grow down the stalk. The kernels will appear visually “scabby”. Any or all part of the head may appear bleached white, which is diagnostic for the disease in wheat. On corn, growth is seen as white-to-pink colored mold on scattered kernels. Fusarium graminearum has major economic impacts in the agriculture industry. Production losses worldwide have been estimated to be as much as 50%. Damage due to Fusarium head blight in the United States was estimated to be more than US$1 billion in 1993 and US$500 million in 1994.

An inexpensive and environmentally friendly solution to control fungal diseases in agricultural plants is needed.

### SUMMARY

The inventors isolated three bacterial endophytes from maize with the ability to confer resistance to certain fungal diseases. The 16S rRNA genes of the isolated bacterial endophytes had 100% identity with the bacterial species Burkholderia gladioli. Two additional bacterial endophytes with antifungal activity were also isolated that had identity with Bacillus subtilis and Paenibacillus polymyxa respectively.

Accordingly, one aspect of the disclosure provides a method of preventing or inhibiting fungal growth on a plant, comprising inoculating a plant with

a) a bacterial endophyte as described herein; or

b) a composition comprising the bacterial endophyte and optionally, a carrier.

Also provided is the use of

a) a bacterial endophyte as described herein; or

b) a composition comprising the bacterial endophyte and optionally a carrier for preventing or inhibiting fungal growth on a plant.

In one embodiment, the bacterial endophyte is Burkholderia gladioli. In one embodiment, the bacterial endophyte is A12 (also known as 3A12), C11 (also known as 3C11) or 5C9 as described herein. In one embodiment, the bacterial endophyte is Burkholderia gladioli and comprises a 16S rRNA gene comprising a nucleotide sequence that has at least 96% sequence identity to the sequence set forth in SEQ ID NO: 1, SEQ ID NO:2, SEQ ID NO:3 and/or SEQ ID NO: 26 or its progeny, or an isolated culture thereof, or mutants thereof. In one embodiment, the bacterial endophyte is Burkholderia gladioli and comprises a 16S rRNA gene comprising a nucleotide sequence that has at least 96% sequence identity to the sequence set forth in SEQ ID NO: 26. In one embodiment, the bacterial endophyte comprises at least one gene that has at least 80% sequence identity with a nucleic acid selected from any one of SEQ ID NOs: 4-25. In one embodiment, the bacterial endophyte expresses at least one polypeptide with an amino acid sequence selected from SEQ ID NOs: 29-35. In one embodiment, the the bacterial endophyte comprises at least one gene involved in chitinase activity that is induced as a result of contact with a fungal pathogen. In one embodiment, the at least one gene involved in chitinase activity hydrolyzes 4-nitrophenyl N,N′-diacetyl-β-D-chitobioside or 4-nitrophenyl N-acetyl-β-D-glucosaminide.

In another embodiment, the bacterial endophyte is Bacillus sp. In one embodiment, the bacterial endophyte is Bacillus subtilis. In one embodiment, the bacterial endophyte is 3H8 as described herein. In one embodiment, the bacterial endophyte is Bacillus subtilis and comprises a 16S rRNA gene comprising a nucleotide sequence that has at least 96% sequence identity to the sequence set forth in SEQ ID NO: 28.

In one embodiment, the bacterial endophyte is a Paenibacillus sp. In one embodiment, the bacterial endophyte is Paenibacillus polymyxa. In one embodiment, the bacterial endophyte is 4H12 as described herein. In one embodiment, the bacterial endophyte is Paenibacillus polymyxa and comprises a 16S rRNA gene comprising a nucleotide sequence that has at least 96% sequence identity to the sequence set forth in SEQ ID NO: 27.

In another embodiment, the plant inoculated is a grass.

In another embodiment, the grass is a cereal or a turfgrass.

In another embodiment, the grass is maize, rice, wheat, barley, sorghum, bentgrass, Bermuda grass, bluegrass, fescue, ryegrass or zoysiagrass.

In another embodiment, inoculating a plant comprises coating the seeds of the plant and/or exposing the plant to a spray.

In another embodiment, the endophyte inhibits the growth of at least one fungal pathogen.

In another embodiment, the fungal growth is growth of a fungus selected from the group consisting of Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii and Trichoderma longibrachiatum.

In another embodiment, fungal growth is growth of a fungus selected from Sclerotinia homoeocarpa, Rhizoctonia solani, or Fusarium graminearum.

Another aspect of the disclosure provides a method of preventing or inhibiting a fungal disease in a plant, comprising inoculating the plant with

a) a bacterial endophyte as described herein; or

b) a composition comprising the bacterial endophyte and optionally, a carrier.

Also provided is the use of

a) a bacterial endophyte as described herein, or

b) a composition comprising the bacterial endophyte and optionally, a carrier

for preventing or inhibiting a fungal disease in a plant.

In one embodiment, the fungal disease is dollar spot disease, brown patch disease, ear rot disease, kernel rot disease, or head blight disease. In one embodiment, the plant is a grass.

In one embodiment, the bacterial endophyte is a Burkholderia gladioli. In one embodiment, the bacterial endophyte comprises a 16S rRNA gene comprising a nucleotide sequence that has at least 96% sequence identity to the sequence set forth in SEQ ID NO:1, SEQ ID NO:2, SEQ ID NO:3, or SEQ ID NO: 26 or its progeny, or an isolated culture thereof, or mutants thereof. In one embodiment, the bacterial endophyte comprises at least one gene that has at least 80% sequence identity with a nucleic acid selected from any one of SEQ ID NOs: 4-25. In one embodiment, the bacterial endophyte expresses at least one polypeptide with an amino acid sequence selected from SEQ ID NOs: 29-35. In one embodiment, the bacterial endophyte comprises at least one gene involved in chitinase activity that is induced as a result of contact with a fungal pathogen. In one embodiment, the at least one gene involved in chitinase activity hydrolyzes 4-nitrophenyl N,N′-diacetyl-β-D-chitobioside or 4-nitrophenyl N-acetyl-β-D-glucosaminide.

In another embodiment, the bacterial endophyte is a Bacillus subtilis. In one embodiment, the bacterial endophyte comprises a 16S rRNA gene a nucleotide sequence that has at least 96% sequence identity to the sequence set forth in SEQ ID NO: 28 or its progeny, or an isolated culture thereof, or mutants thereof.

In another embodiment, the bacterial endophyte is a Paenibacillus polymyxa. In one embodiment, the bacterial endophyte comprises a 16S rRNA gene a nucleotide sequence that has at least 96% sequence identity to the sequence set forth in SEQ ID NO: 27 or its progeny, or an isolated culture thereof, or mutants thereof.

In another embodiment, inoculating a grass comprises coating the seeds of the grass and/or exposing the grass to a spray.

In another embodiment, the grass is a cereal or a turfgrass. In another embodiment, the grass is selected from the group consisting of maize, rice, wheat, barley, sorghum, bentgrass, Bermuda grass, bluegrass, fescue, ryegrass and zoysiagrass.

In another embodiment, the plant inoculated is a grass. In another embodiment, the grass is a cereal or a turfgrass. In another embodiment, the grass is selected from the group consisting of maize, rice, wheat, barley, sorghum, bentgrass, Bermuda grass, bluegrass, fescue, ryegrass and zoysiagrass. In some embodiments, the grass is creeping bentgrass.

In another embodiment, the fungus is selected from the group consisting of Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii and Trichoderma longibrachiatum. In another embodiment, the fungus is selected from Sclerotinia homoeocarpa, Rhizoctonia solani and Fusarium graminearum.

Another aspect of the disclosure provides a method of preventing or inhibiting dollar spot disease, brown patch disease, ear rot disease, kernel rot disease, or head blight disease in a grass, comprising inoculating a grass with
a) a bacterial endophyte wherein the bacterial endophyte is a Burkholderia gladioli; or
b) a composition comprising the bacterial endophyte and optionally, a carrier.

Another aspect of the disclosure provides a use of

(a) a bacterial endophyte; or

(b) a composition comprising the bacterial endophyte and optionally, a carrier

for inhibiting or preventing dollar spot disease, brown patch disease, ear rot disease, kernel rot disease, or head blight disease in a grass.

In one embodiment, the bacterial endophyte is a Burkholderia gladioli. In one embodiment, the bacterial endophyte comprises a 16S rRNA gene comprising a nucleotide sequence that has at least 96% sequence identity to the sequence set forth in SEQ ID NO:1, SEQ ID NO:2, SEQ ID NO:3 or SEQ ID NO: 26 or its progeny, or an isolated culture thereof, or mutants thereof.

In another embodiment, the grass a cereal or turfgrass. In other embodiments, the grass is selected from the group consisting of maize, rice, wheat, barley, sorghum, bentgrass, Bermuda grass, bluegrass, fescue, ryegrass and zoysiagrass. In some embodiments, the grass is creeping bentgrass.

The present inventors also identified several genes that are required for the antifungal activity of the isolated endophytes.

Another aspect of the disclosure provides a transformed bacterial cell, plant cell, plant or plant part expressing a nucleic acid molecule comprising a nucleic acid sequence that has at least 80% sequence identity with a nucleic acid sequence selected from any one of SEQ ID NOs:4-25, wherein said bacterial cell, plant cell, plant or plant part is resistant to fungal infection.

In one embodiment, said bacterial cell, plant cell, plant or plant part is resistant to fungal infection by Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii or Trichoderma longibrachiatum. In another embodiment, the bacterial cell, plant cell, plant or plant part is resistant to fungal infection by Sclerotinia homoeocarpa, Rhizoctonia solani or Fusarium graminearum.

Yet another aspect of the disclosure provides a method of increasing the resistance of a bacterial cell, plant cell, plant or plant part to a fungal pathogen comprising
(a) transforming the bacterial cell, plant cell, plant or plant part with a gene, wherein the gene comprises a nucleic acid sequence selected from any one of SEQ ID NOs:4-25, a recombinant construct comprising a nucleic acid sequence that has at least 80% sequence identity with a nucleic acid sequence selected from any one of SEQ ID NOs: 4-25, a recombinant construct comprising a nucleic acid sequence encoding a protein that has at least 80% sequence identity with any one of SEQ ID NOs: 29-35, and
(b) expressing the transformed gene in the bacterial cell, plant cell, plant or plant part.

In another aspect of the disclosure, there is provided a synthetic combination comprising a purified bacterial population in association with a plurality of seeds or seedlings of a plant. In one embodiment, the plant is an agricultural plant, optionally a grass. In one embodiment, the purified bacterial population comprises a bacterial endophyte as described herein that is heterologous to the seeds or seedlings. In one embodiment, the endophyte is present in the synthetic combination in an amount effective to provide a benefit to the seeds or seedlings of plants derived from the seeds or seedlings. In one embodiment, the benefit is selected from the group consisting of consisting of decreased ear rot, decreased kernel rot, decreased dollar spot disease, decreased brown patch disease, decreased head blight, improved growth, increased mass, and increased grain yield.

In another aspect, there is provided a method of preventing or inhibiting fungal growth on a plant, comprising contacting the surface of a plurality of seeds or seedlings with a formulation comprising a purified bacterial population that comprises a bacterial endophyte as described herein that is heterologous to the seeds or seedlings. In one embodiment, the endophyte is present in the synthetic combination in an amount effective to preventing or inhibiting fungal growth on the plants derived from the seeds or seedlings. In one embodiment, the plant is an agricultural plant, optionally a grass.

In another aspect, there is provided a method for preparing an agricultural seed composition, comprising contacting the surface of a plurality of seeds with a formulation comprising a purified bacterial population that comprises a bacterial endophyte as described herein that is heterologous to the seeds. In one embodiment, the endophyte is present in the synthetic combination in an amount effective to provide a benefit to the seeds or the plants derived from the seeds. In one embodiment, the benefit is selected from the group consisting of decreased ear rot, decreased kernel rot, decreased dollar spot disease, decreased brown patch disease, decreased head blight, improved growth, increased mass, and increased grain yield. In one embodiment, the seeds are seeds of an agricultural plant, optinally a grass. In one embodiment, the seeds are cereal seeds or turfgrass seeds. In one embodiment the seeds are seeds for a plant selected from the group consisting of maize, rice, wheat, barley, sorghum, bentgrass, Bermuda grass, bluegrass, fescue, ryegrass and zoysiagrass.

In one embodiment, the bacterial endophyte is a Burkholderia gladioli, such as a bacterial endophyte comprising a 16S rRNA gene comprising a nucleotide sequence that has at least 96% sequence identity to the sequence set forth in SEQ ID NO:1, SEQ ID NO:2, SEQ ID NO:3, or SEQ ID NO: 26 or its progeny, or an isolated culture thereof, or mutants thereof. In one embodiment, the bacterial endophyte comprises at least one gene involved in chitinase activity that is induced as a result of contact with a fungal pathogen. In one embodiment, the at least one gene involved in chitinase activity hydrolyzes 4-nitrophenyl N,N′-diacetyl-β-D-chitobioside or 4-nitrophenyl N-acetyl-β-D-glucosaminide.

In another embodiment, the bacterial endophyte is a Bacillus subtilis, such as a bacterial endophyte comprising a 16S rRNA gene comprising a nucleotide sequence that has at least 96% sequence identity to the sequence set forth in SEQ ID NO: 28 or its progeny, or an isolated culture thereof, or mutants thereof.

In another embodiment, the bacterial endophyte is a Paenibacillus polymyxa, such as a bacterial endophyte comprising a 16S rRNA gene comprising a nucleotide sequence that has at least 96% sequence identity to the sequence set forth in SEQ ID NO: 27 or its progeny, or an isolated culture thereof, or mutants thereof.

In any of the above aspects or embodiments, the fungal pathogen may belong to a class selected from the group consisting of Dothideomycetes, Ascomycetes, Agaricomycetes, Sordariomycetes, and Eurotiomycetes. In any of the above embodiments, the fungal pathogen may belong to an order selected from the group consisting of Pleosporales, Helotiales, Cantharellales, Hypocreales, Eurotiales, Capnodiales, and Botryosphaeriales. In any of the above embodiments, the fungal pathogen may belong to a family selected from the group consisting of Pleosporaceae, Sclerotiniaceae, Ceratobasidiaceae, Nectriaceae, Trichocomaceae, Davidiellaceae, Botryosphaeriaceae, Montagnulaceae, and Hypocreaceae.

In any of the above aspects or embodiments, the fungal pathogen may belong to a genus selected from the group consisting of Alternaria, Sclerotinia, Rhizoctonia, Fusarium, Aspergillus, Davidiella, Diplodia, Epicoccum, Gibberella, Nigrospora, Paraconiothyrium, Penicillium and Trichoderma. In any of the above aspects or embodiments, the fungal pathogen is selected from the group consisting of Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii and Trichoderma longibrachiatum. In one embodiment, the fungus is selected from Sclerotinia homoeocarpa, Rhizoctonia solani and Fusarium graminearum.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF DRAWINGS

FIG. 1 depicts screening of antifungal activity by maize endophytes against S. homoeocarpa. (A) is an agar plate showing in vitro screening of antifungal activity, (B) is a table showing scores of in vitro antifungal activity and (C-E) shows in planta screening of endophytes for antifungal activity on creeping bentgrass on sand after 4 weeks. In each image, the 2 tubes on the left side represent (C) endophyte treatment C11, (D) endophyte treatment 5C9, (E) endophyte treatment A12. The 2 tubes in the middle represent control pathogen only treatment and the 2 tubes on the right represent the control (no pathogen, no endophyte) treatment.

FIG. 2 depicts screening of antifungal activity in maize endophytes against Rhizoctonia solani. (A) is an agar plate showing in vitro screening of antifungal activity, (B) is a table showing scores of in vitro antifungal activity and (C-E) shows in planta screening of endophytes for antifungal activity on creeping bentgrass on sand after 4 weeks. In each image, the 2 tubes on the left side represent endophyte treatment C11 (C), endophyte treatment 5C9 (D) and endophyte treatment A12 (E). The 2 tubes in the middle represent control pathogen only treatment and the 2 tubes on the right represent the control (no pathogen, no endophyte) treatment.

FIG. 3 depicts testing of candidate endophytes (first set) as foliar sprays on turfgrass cup cuts from the field (Creeping bentgrass) after 7-10 days of inoculation with S. homoeocarpa. (A-D) is the first trial and (D-F) is the second trial. (A) is the control, no endophyte treatment, (B) is endophyte A12, (C) is endophyte C11, (D) is a graph showing the percentage disease lesions in each pot as measured by Assess software, (E) is the control, no endophyte treatment, (F) endophyte treatment A12, (G) is endophyte treatment C11 and (H) is a graph showing the percentage of disease lesions in each pot as measured by Assess software.

FIG. 4 depicts testing of candidate endophytes (second set) as foliar sprays on turfgrass cup cuts from field (Creeping bentgrass) after 7-10 days of inoculation with S. homoeocarpa. (A-D) is the first trial and (D-F) is the second trial. (A) is the control, no endophyte treatment, (B) is endophyte 5C9, (C) is negative endophyte A1, (D) is a graph showing the percentage disease lesions in each pot as measured by Assess software, (E) is the control, no endophyte treatment, (F) is endophyte treatment 5C9, (G) is negative endophyte treatment A1 and (H) is a graph showing the percentage disease lesions in each pot as measured by Assess software.

FIG. 5 depicts the mutant screen for isolating endophytic genes responsible for anti-fungal (S. homoeoarcpa) activity, and their subsequent verification in planta. (A) is an agar plate showing loss of inhibition zone for two of the mutants as an example. (B-S) are images showing in planta confirmation of loss of antifungal activity in creeping bentgrass where (B), (E), (H), (L) and (P) are plants from seeds coated with wild type endophyte A12 and mutant C2 (C), mutant 2C7 (D), mutant C3 (F), mutant 2C4 (G), mutant B8 (I), mutant 2D1 (J), mutant B12 (K), mutant B6 (M), mutant 2610 (N), mutant 2D2 (O), mutant 2C12 (Q), mutant C1 (R) and mutant 2C11 (S).

FIG. 6 depicts microscopy images showing the interaction between the fungus, S. homoeocarpa and candidate endophytes 3A12 (A-F) and C11 (G-L). In (A-F), the fungus was stained with Evans blue (A-C) in presence of bacteria 3A12 (A-C) and in absence of bacteria 3A12 (D-F). In G-L, the fungus was stained with neutral red in the presence of bacteria 3C11 (G-I) and in absence of bacteria 3C11 (J-L).

FIG. 7 depicts microscopy images of candidate anti-fungal endophytic bacteria 3A12. (A) is an electron microscopy image showing the rod shape of endophyte A12 and (B and C) are confocal microscopy images showing endophyte A12 tagged with GFP inside creeping bentgrass cells confirming its endophytic ability.

FIG. 8 depicts graphs showing the ability of the 3 endophytes, 3A12, 3C11 and 5C9, to colonize creeping bentgrass shoots and roots.

FIG. 9 depicts the methodology used to test candidate endophytes for ability to confer resistance to Sclerotinia homoeocarpa (dollar spot) using cupcuts of creeping bentgrass from the field. Source: H. Shehata, E. Lyons, K. Jordan and M. Raizada (unpublished).

FIG. 10 depicts the methodology used for the mutant screen.

FIG. 11 depicts the methodology for the plasmid rescue.

FIG. 12 depicts in vitro testing of maize endophytes for antifungal activity. (A) Example of a Petri dish dual culture screen showing zones of inhibition of Sclerotinia homoeocarpa by endophytes 3A12 and 3C11. (B) Graph showing the mean zone of inhibition diameter (cm) associated with each candidate endophyte and controls. (C) Summary of candidate endophytes with anti-Sclerotinia activity, their predicted taxonomy, and host plant source.

FIG. 13 depicts testing antifungal endophyte candidates on field cores of creeping bentgrass, after inoculation with S. homoeocarpa. (A-D) Validation of the disease assessments used in this study, using positive and negative controls as follows: (A) no pathogen, no endophyte treatment; (B) pathogen-only treatment; (C) pathogen, fungicide treatment (Banner maxx); (D) graph showing percentage lesion (n=4) as measured by Assess software. (E-M) First set of candidate anti-fungal endophytes: (E-H) first trial and (I-L) second trial; (E and I) no endophyte, no pathogen treatment (control); (F and J) no endophyte, pathogen only treatment (control); (G and K) pathogen with endophyte 3A12; (H and L) pathogen with endophyte 3C11. (M) Graph showing the mean percentage lesion after each treatment (n=4) as measured by Assess software. (N-V) Second set of candidate anti-fungal endophytes: (N-Q) first trial and (R-U) second trial; (N and R) no endophyte, no pathogen treatment (control); (O and S) no endophyte treatment, pathogen only treatment (control); (P and T) pathogen with endophyte 4H12; (Q and U) pathogen with endophyte 5C9. (V) Graph showing the mean percentage lesion after each treatment (n=4) as measured by Assess software. (W) Number of field cores that were healthy, defined as showing sub-threshold disease symptoms. The histograms represent the mean values, and the error bars represent the standard error of the mean (SEM). Asterisks indicate significant difference at 0.05 compared to the respective pathogen-only control.

FIG. 14 depicts the interactions of candidate bacterial endophytes with S. homoeocarpa after staining with the Evans blue stain. (A) Methodology used: PDA coated microscope slide with S. homoeocarpa in the center, flanked by a candidate endophyte (right) or LB buffer control (left). (B, D, F, H, J) Mycelia of S. homoeocarpa from the no-endophyte side (negative controls). (C, E, G, I, K) Corresponding mycelia of S. homoeocarpa from the side exposed to each respective endophyte: (C) endophyte 3A12, (E) endophyte 3C11, (G) endophyte 3H8, (I) endophyte 4H12 and (K) endophyte 5C9. The scale bar in all images is 20 μm.

FIG. 15 depicts In planta screening of antifungal activity in maize endophytes against Rhizoctonia solani in creeping bentgrass. (A) control no endophyte no pathogen treatment (B) control no endophyte pathogen only treatment (C) endophyte treatment 3A12, (D) endophyte treatment 3C11, (E) endophyte treatment 4H12, (F) endophyte treatment 5C9.

FIG. 16 depicts the interactions of bacterial endophytes with R. solani after staining with the Evans blue stain. (A) Methodology used: PDA coated microscope slide with R. solani in the center, flanked by a candidate endophyte (left) or LB buffer control (right). (B, D, F, H) Mycelia of R. solani from the endophyte side (C, E, G, I) Corresponding mycelia of R. solani from the no endophyte side (negative controls) to each respective endophyte: (B) endophyte 3A12, (D) endophyte 3C11, (F) endophyte 4H12, (H) endophyte 5C9. The scale bar in all images is 20 μm.

FIG. 17 depicts a mutant screen for loss of antifungal activity against R. solani. (A) In vitro screening for loss of antifungal activity. (B) Diameter of inhibition zones of R. solani growth around candidate mutants. (C-L) in planta confirmation of loss of antifungal activity in creeping bentgrass where (C and H) are plants from seeds coated with wild type endophyte 3A12 and (D) mutant C3, (E) mutant B8, (F) mutant 2C11, (G) mutant 2D1, (I) mutant C2, (J) mutant 2C7, (K) mutant 2C4, (L) mutant 2D2.

FIG. 18 compares suppression of Gibberella ear rot in corn by 4H12 (H12) to four potential candidate bacterial endophytes isolated from diverse cereal crops. (A) and (B) correspond to greenhouse trial 1. (A) is a graphical representation of percent of infection and (B) is a graphical representation of average yield in gram per ear. (C) and (D) correspond to greenhouse trial 2. (C) is a graphical representation of percent of infection and (D) is a graphical representation of average yield in gram per ear.

FIG. 19 compares suppression of Fusarium Head Blight in wheat by 4H12 (H12) to four potential candidate bacterial endophytes isolated from diverse cereal crops. (A) and (B) correspond to greenhouse trial 1. (A) is a graphical representation of percent of infection and (B) is a graphical representation of average yield in gram per plant. (C) and (D) correspond to greenhouse trial 2. (C) is a graphical representation of percent of infection and (D) is a graphical representation of average yield in gram per plant.

FIG. 20 shows screening for endophyte mutants that show loss or reduction in anti-fungal activity. (A) Recovered Tn-5 insertions on LB agar. (B) Example PDA agar plate showing loss of inhibition zones by candidate mutants (C) Summary of candidate mutants showing lost or reduced inhibition zones of S. homoeocarpa growth. (D-R) In planta confirmation of loss of antifungal activity in creeping bentgrass, where (D-H) are Set 1 plants from seeds coated with: (D) wild type strain 3A12, (E) mutant 1C2, (F) mutant 1C3, (G) mutant 2C4, or (H) mutant 2C7. (I-R) Set 2 plants from seeds coated with: (I) wild type strain 3A12, (J) mutant 1B6, (K) mutant 1B8, (L) mutant 1B12, (M) mutant 1C1, (N) mutant 2B10, (O) mutant 2C11, (P) mutant 2C12, (Q) mutant 2D1, and (R) mutant 2D2.

FIG. 21 shows characterization of the candidate anti-fungal mutants. (A-G) Motility assay on LB agar plates showing representative images of (A) wild type strain 3A12, (B) mutant m1B2, (C) mutant m2C12, (D) mutant m1C3, (E) mutant m2B10, (F) mutant m2D2, or (G) mutant m1C2. The numbers shown in (A-G) indicate the mean colony diameter (n=21) with the asterisks indicating significant difference in 2 independent trials. (H-N) Detection of flagella using transmission electron microscopy (TEM) for: (H) wild type strain 3A12, (I) mutant m1B12, (J) mutant m2C12, (K) mutant m1C3, (L) mutant m2B10, (M) mutant m2D2, and (N) mutant m1C2. The numbers shown in (H-N) indicate the percentage of bacteria that were observed to have flagella. (O-U) Colorimetric biofilm formation assay for: (O) wild type strain 3A12, (P) mutant m1B12, (Q) mutant m2C12, (R) mutant m1C3, (S) mutant m2B10, (T) mutant m2D2, and (U) mutant m1C2.

FIG. 22 shows examination of mutants for swarming, attachment and colony formation around their fungal target. Shown are light microscopy images of S. homoeocarpa mycelia grown on a microscope slide side by side with: (A) wild type 3A12, (B) mutant m1B12, (C) mutant m2C12, (D) mutant m1C3, (E) mutant m2B10, (F) mutant m2D2, and (G) mutant m1C2. The scale bar is 20 μm.

FIG. 23 shows other candidate anti-fungal genes as predicted from the genome sequence of strain 3A12. (A) List of candidate genes with their position(s) in the genome of strain 3A12, along with their Genbank BLASTN search predictions and functions. The letter S refers to the scaffold number. (B) Chitinase assay of strain 3A12 using two different enzyme substrates. (C) Chitinase assay of strain 3A12 cultured alone or in the presence of S. homoeocarpa using 4-nitrophenyl N-acetyl-β-D-glucosaminide as the enzyme substrate. Error bars represent the standard error of the mean.

FIG. 24 shows a proposed model for the anti-fungal gene network. Components with green fill are the products of genes identified in this study. Solid black arrows indicate results from this study. Solid blue arrows indicate information from the literature. Dotted black arrows indicate genes predicted from the genome sequence. Abbreviations: ADC, arginine decarboxylase; Agm, agmatine; Arg, arginine; Cav, cadaverine; FA, fatty acid; FAD, fatty acid desaturase; Fum, fumarate; IM, inner membrane; Lys, lysine; LDC, lysine decarboxylase; ODC, ornithine decarboxylase; OM, outer membrane; OMV, outer membrane vesicles; Orn, ornithine; PG, peptidoglycan; Polysacc, polysaccharide; Put, putrescine; ROS, reactive oxygen species; SDH, succinate dehydrogenase; Suc, succinate; TCA, tricarboxylic acid cycle.

FIG. 25 shows the characterization of the candidate anti-fungal mutants. (A-F) Motility assay on LB agar plates showing representative images of (A) wild type 3A12, (B) mutant m1C1, (C) mutant m2D1, (D) mutant m1B6, (E) mutant m2C4, or (F) mutant m2C11. The numbers shown in (A-F) indicate the mean colony diameter (n=21) with the asterisks indicating significant difference in 2 independent trials. (G-L) Detection of flagella using transmission electron microscopy (TEM) for: (G) wild type 3A12, (H) mutant m1C1, (I) mutant m2D1, (J) mutant m1B6, (K) mutant m2C4, and (L) mutant m2C11. The numbers shown in (G-L) indicate the percentage of bacteria that were observed to have flagella. (M-R) Colorimetric biofilm formation assay for: (M) wild type 3A12, (N) mutant m1C1, (O) mutant m2D1, (P) mutant m1B6, (Q) mutant m2C4, and (R) mutant m2C11.

FIG. 26 shows examination of mutants for swarming, attachment and colony formation around their fungal target. Shown are light microscopy images of S. homoeocarpa mycelia grown on a microscope slide side by side with: (A) wild type 3A12, (B) mutant m2D1, (C) mutant m1B6, (D) mutant m1C1, (E) mutant m2C4, and (F) mutant m2C11. The scale bar is 20 μm.

FIG. 27 shows gene expression analysis of candidate genes by quantitative real-time PCR. The treatments are: the endophyte culture only (Neg, negative control); endophyte treated with chitin (Chitin), and endophyte treated with S. homoeocarpa (Fungus). Shown is gene expression data of wild type 3A12 cells for: (A) YajQ, (B) Fatty acid desaturase, (C) Lysine-tRNA synthetase, (D) ToIR, (E) Arg/orn/lys decarboxylase, and (F)Succinate dehydrogenase.

FIG. 28 shows confocal microscopy image showing biofilm formation surrounding GFP tagged wild type 3A12 endophytic cells on a microscope slide stained with a red biofilm fluorescent stain (FilmTracer™ SYPRO® Ruby Biofilm Matrix Stain).

### DETAILED DESCRIPTION

The present disclosure relates to bacterial endophytes isolated from maize and which are capable of inhibiting growth of fungal pathogens including Sclerotinia homoeocarpa and Rhizoctonia solani. The bacterial endophytes are useful for conferring resistance to fungal diseases in grasses.

The present disclosure also relates to genes identified in the bacterial endophytes that are required for their antifungal activity.

### I. Definitions

The term “endophyte” as used herein refers to a class of microbial symbionts that reside within host plant roots, stems and/or leaves.

The term “inoculating a plant” with an endophyte, for example, as used herein refers to applying, contacting or infecting a plant (including its roots, stem, leaves or seeds) with an endophyte or a composition comprising an endophyte. The term “inoculated plant” refers to a plant to which an endophyte or a composition comprising an endophyte has been applied or contacted.

The term “plant” as used herein includes any member of the plant kingdom that can be colonized by a bacterial endophyte. In one embodiment, the plant is a grass including, without limitation, corn (Zea mays), wheat (Triticum aestivum), rice (Oryza sativa), barley (Hordeum vulgare), or sorghum (Sorghum bicolor), bentgrass (Agrostis), bermudagrass (Cynodon sp.), bluegrass (Poa sp.), fescue (Festuca sp.), ryegrass (Lolium sp.) and zoysiagrass (Zoysia sp.). In another embodiment, the plant is a turfgrass. As used herein, the term “plant” includes parts of a plant such as roots, stems, leaves and/or seeds that can be colonized by a bacterial endophyte.

The term “turfgrass” as used herein refers to perennial grass that is grown to form a turf/lawn that permits substantial trampling upon.

The present invention contemplates the use of “isolated” endophyte. As used herein, an isolated endophyte is an endophyte that is isolated from its native environment, and carries with it an inference that the isolation was carried out by the hand of man. An isolated endophyte is one that has been separated from at least some of the components with which it was previously associated (whether in nature or in an experimental setting).

The term “mutant of the bacterial endophyte” as used herein refers to a bacterial endophyte that has undergone a mutation in its genetic code, such as might be artificially created to enhance plant growth-related capabilities, to track the endophyte in the plant, or to track the endophyte in the environment to ensure consistency and provenance.

The term “progeny of the bacterial endophyte” as used herein refers to all cells deriving from the bacterial endophyte.

In some embodiments, the invention uses endophytes that are heterologous to a seed or plant in making synthetic combinations or agricultural formulations. An endophyte is considered heterologous to the seed or plant if the seed or seedling that is unmodified (e.g., a seed or seedling that is not treated with a bacterial endophyte population described herein) does not contain detectable levels of the endophyte. For example, the invention contemplates the synthetic combinations of plants, seeds or seedlings of agricultural plants (e.g., agricultural grass plants) and an endophyte population, in which the endophyte population is heterologously disposed on the exterior surface of or within a tissue of the agricultural plant, seed or seedling in an amount effective to colonize the plant. An endophyte is considered heterologously disposed on the surface or within a plant (or tissue) when the endophyte is applied or disposed on the plant in a number that is not found on that plant before application of the endophyte. For example, a bacterial endophytic population that is disposed on an exterior surface or within the seed can be an endophytic bacterium that may be associated with the mature plant, but is not found on the surface of or within the seed. As such, an endophyte is deemed heterologous or heterologously disposed when applied on the plant that either does not naturally have the endophyte on its surface or within the particular tissue to which the endophyte is disposed, or does not naturally have the endophyte on its surface or within the particular tissue in the number that is being applied.

The term “inhibiting fungal growth in a plant” as used herein means decreasing amount of fungal growth on a plant, decreasing the speed of fungal growth on a plant has decreased, decreasing the severity of a fungal infection in a plant, decreasing the amount of diseased area of a plant, decreasing the percentage or number of infected seeds, decreasing the percentage or number of disease lesions on a plant decreasing the percentage of apparent fungal infection of a plant and/or treating or preventing fungal growth in a plant.

The term “yield” refers to biomass or seed or fruit weight, seed size, seed number per plant, seed number per unit area, bushels per acre, tons per acre, kilo per hectare, and/or carbohydrate yield.

The term “promoting plant growth” as used herein means that the plant or parts thereof (such as seeds and roots) have increased in size or mass compared to a control plant, or parts thereof, that has not been inoculated with the endophyte or as compared to a predetermined standard.

The term “symbiosis” and/or “symbiotic relationship” as used herein refer to a mutually beneficial interaction between two organisms including the interaction plants can have with bacteria. Similarly, the term “symbiont” as used herein refers to an organism in a symbiotic interaction.

The term “sequence identity” as used herein refers to the percentage of sequence identity between two nucleic acid and/or polypeptide sequences. To determine the sequence identity of two nucleic acid sequences, the sequences are aligned for optimal comparison purposes (e.g., gaps can be introduced in the sequence of a first nucleic acid sequence for optimal alignment with a second nucleic acid sequence). The nucleic acid residues at corresponding nucleic acid positions are then compared. When a position in the first sequence is occupied by the same nucleotide as the corresponding position in the second sequence, then the molecules are identical at that position. The sequence identity between the two sequences is a function of the number of identical positions shared by the sequences (i.e., % identity=number of identical overlapping positions/total number of positions×100%). In one embodiment, the two sequences are the same length. The determination of sequence identity between two sequences can also be accomplished using a mathematical algorithm.

A “synthetic combination” includes a combination of a plant, such as an agricultural plant, and an endophyte. The combination may be achieved, for example, by coating the surface of the seed of a plant, such as an agricultural plant, or plant tissues with an endophyte.

As used herein, the terms “a” or “an” in relation to an object mean a representative example from a collection of that object.

### II. Bacterial Endophytes and Compositions Thereof

Endophytes, microbes that live inside a plant without causing disease, can confer beneficial traits to their host such as promoting health or protecting against specific host pathogens.

Bacterial endophyte cultures were isolated from samples of maize plants to identify endophytes that could act as biocontrols for fungi that cause fungal diseases in grasses such as turfgrass. Three candidate endophytes (A12, C11 and C9) were originally identified because they conferred resistance to both Sclerotinia homoeocarpa (the causative agent of dollar spot disease) and Rhizoctonia solani (the causative agent of brown patch disease). 16S rRNA sequencing revealed that the 16S rRNA genes of the three isolated endophytes had 100% sequence identity with the 16S rRNA gene of the bacterial species Burkholderia gladioli. SEQ ID NO:1 corresponds to the 16S rRNA gene of endophyte C9, SEQ ID NO: 2 corresponds to the 16S rRNA gene of endophyte A12 and SEQ ID NO:3 corresponds to the 16S rRNA gene of endophyte C11. Endophyte A12 has also been identified using its full genome sequence [17]. Additional sequencing of each of the isolated Burkholderia gladioli endophytes determined that the bacterial endophytes shared the identical 16S rRNA sequence shown in SEQ ID NO: 26.

Two additional endophytes (3H8 and 4H12) were also identified that exhibited antifungal activity. 16S rRNA sequencing revealed that the 16S rRNA gene of 3H8 (SEQ ID NO: 28) had sequence identity with the 16S rRNA gene of Bacillus subtilis. 16S rRNA sequencing revealed that the 16S rRNA gene of 4H12 (SEQ ID NO: 27) had sequence identity with the 16S rRNA gene of Paenibacillus polymyxa.

Accordingly, the disclosure provides a bacterial endophyte comprising a 16S rRNA gene comprising a nucleotide sequence that comprises the sequence set forth in SEQ ID NO:1, SEQ ID NO:2, SEQ ID NO:3, SEQ ID NO: 26, SEQ ID NO: 27 or SEQ ID NO: 28 or its progeny, or an isolated culture thereof, or mutants thereof, having the ability to inhibit fungal growth.

In another aspect, the disclosure provides a bacterial endophyte comprising a 16S rRNA gene comprising a nucleotide sequence that comprises the sequence set forth in SEQ ID NO:1, SEQ ID NO:2, SEQ ID NO:3, SEQ ID NO: 26, SEQ ID NO: 27 or SEQ ID NO: 28 or its progeny, or an isolated culture thereof, or mutants thereof having the ability to inhibit Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii and/or Trichoderma longibrachiatum growth.

The 16S rRNA gene is widely used for the classification and identification of microbes. It is well known in the art that bacteria of the same species need not share 100% sequence identity in the 16S rRNA sequences. Accordingly, in one aspect of the disclosure, the bacterial endophyte has a 16S rRNA gene comprising a nucleotide sequence that has at least 96% sequence identity to the sequence set forth in SEQ ID NO:1, SEQ ID NO:2, SEQ ID NO:3, SEQ ID NO:26, SEQ ID NO:27 or SEQ ID NO:28. In another aspect, the bacterial endophyte has a 16S rRNA gene comprising a nucleotide sequence has at least 97%, 97.5%, 98%, 98.5%, 99%, 99.5% or 99.9% sequence identity to the sequence set forth in SEQ ID NO:1, SEQ ID NO:2, SEQ ID NO:3, SEQ ID NO: 26, SEQ ID NO:27 or SEQ ID NO:28.

In another aspect, the bacterial endophyte has a 16S rRNA gene comprising at least 100, 200, 300, 400, 450, 500 or 525 consecutive nucleotides of the sequence set forth in SEQ ID NO:1, SEQ ID NO:2, SEQ ID NO:3, SEQ ID NO:26, SEQ ID NO:27 or SEQ ID NO:28.

In another aspect, the bacterial endophyte is Burkholderia gladioli. B. gladioli is a species of aerobic gram-negative rod-shaped bacteria. In another aspect, the bacterial endophyte is Bacillus subtilis. In another aspect, the bacterial endophyte is Paenibacillus polymyxa.

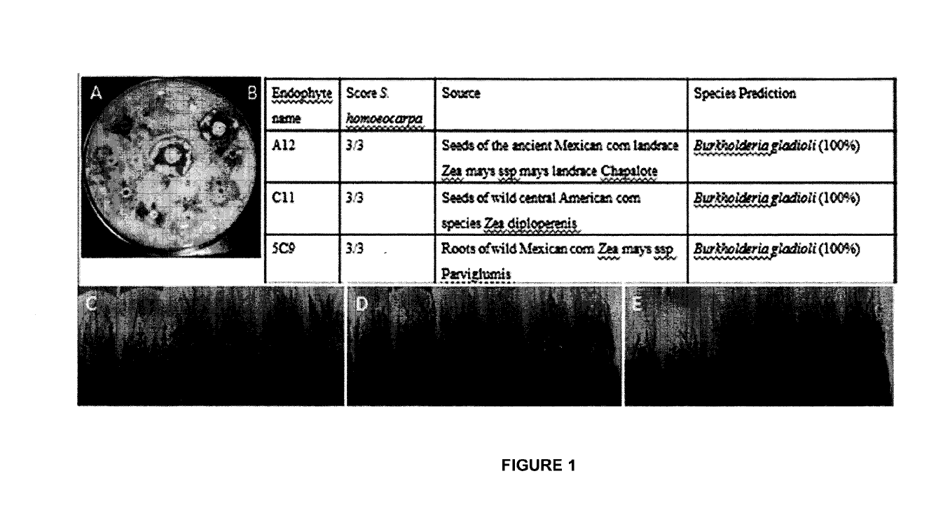

The bacterial endophytes having antifungal activity can readily be obtained using the information and methods described herein. For example, the bacterial endophytes can be isolated from the plant sources identified in FIGS. 1, 2 and 12 as previously described [5, 6]. Endophytes can be tested for antifungal activity such as by using the in vitro and in planta methods described in Examples 1-3. Furthermore, bacterial endophytes having a 16S rRNA gene with sequence identity to the sequence set forth in SEQ ID NO:1, SEQ ID NO:2, SEQ ID NO:3, SEQ ID NO:26, SEQ ID NO:27 or SEQ ID NO:28 can be identified by sequencing the 16S rRNA gene of a bacterial endophyte and comparing the sequence to SEQ ID NO:1, SEQ ID NO:2, SEQ ID NO:3, SEQ ID NO:26, SEQ ID NO:27 or SEQ ID NO:28 to determine the percentage of sequence identity.

Compositions for inoculating the plants with the isolated bacterial endophyte described herein are also disclosed. In one aspect, the disclosure provides an inoculating composition, comprising a bacterial endophyte comprising a 16S rRNA gene comprising a nucleotide sequence that has at least 96% sequence identity to the sequence set forth in SEQ ID NO:1, SEQ ID NO:2, SEQ ID NO:3, SEQ ID NO:26, SEQ ID NO:27 or SEQ ID NO:28 or its progeny, or an isolated culture thereof or mutants thereof and optionally, a carrier.

As used herein, the term “carrier” refers to the means by which the bacterial endophyte is delivered to the target plant. Carriers that may be used in accordance with the present disclosure include oils, polymers, plastics, wood, gels, colloids, sprays, drenching means, emulsifiable concentrates and so forth. The selection of the carrier and the amount of carrier used in a composition may vary and depends on several factors including the specific use and the preferred mode of application.

The carrier can be a solid carrier or liquid carrier, and in various forms including microspheres, powders, emulsions and the like. The carrier may be any one or more of a number of carriers that confer a variety of properties, such as increased stability, wettability, or dispersability. Wetting agents such as natural or synthetic surfactants, which can be nonionic or ionic surfactants, or a combination thereof can be included in a composition of the invention. Water-in-oil emulsions can also be used to formulate a composition that includes the purified bacterial population (see, for example, U.S. Pat. No. 7,485,451, which is incorporated herein by reference in its entirety). Suitable formulations that may be prepared include wettable powders, granules, gels, agar strips or pellets, thickeners, and the like, microencapsulated particles, and the like, liquids such as aqueous flowables, aqueous suspensions, water-in-oil emulsions, etc. The formulation may include grain or legume products, for example, ground grain or beans, broth or flour derived from grain or beans, starch, sugar, or oil.

In some embodiments, the agricultural carrier may be soil or a plant growth medium. Other agricultural carriers that may be used include water, fertilizers, plant-based oils, humectants, or combinations thereof. Alternatively, the agricultural carrier may be a solid, such as diatomaceous earth, loam, silica, alginate, clay, bentonite, vermiculite, seed cases, other plant and animal products, or combinations, including granules, pellets, or suspensions. Mixtures of any of the aforementioned ingredients are also contemplated as carriers, such as but not limited to, pesta (flour and kaolin clay), agar or flour-based pellets in loam, sand, or clay, etc. Formulations may include food sources for the cultured organisms, such as barley, rice, or other biological materials such as seed, plant parts, sugar cane bagasse, hulls or stalks from grain processing, ground plant material or wood from building site refuse, sawdust or small fibers from recycling of paper, fabric, or wood. Other suitable formulations will be known to those skilled in the art.

In one embodiment, the composition comprises a suspension of the isolated bacterial endophyte and a seed coating agent as carrier. Optionally, the seed coating agent is polyvinyl pyrrolidine (PVP). In one example, 500 μL of bacterial suspension, optionally 10 μl to 1 mL of bacterial suspension, is mixed with 10 ml of PVP, optionally 1 ml to 100 ml PVP.

In one embodiment, the composition includes at least one member selected from the group consisting of a tackifier, a microbial stabilizer, a fungicide, an antibacterial agent, an herbicide, a nematicide, an insecticide, a plant growth regulator, a rodenticide, a dessicant, and a nutrient.

In one embodiment, the formulation can include a tackifier or adherent. Such agents are useful for combining the bacterial population of the invention with carriers that can contain other compounds (e.g., control agents that are not biologic), to yield a coating composition. Such compositions help create coatings around the plant or seed to maintain contact between the microbe and other agents with the plant or plant part. In one embodiment, adherents are selected from the group consisting of: alginate, gums, starches, lecithins, formononetin, polyvinyl alcohol, alkali formononetinate, hesperetin, polyvinyl acetate, cephalins, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and polyoxyethylene-polyoxybutylene block copolymers. Other examples of adherent compositions that can be used in the synthetic preparation include those described in EP 0818135, CA 1229497, WO 2013090628, EP 0192342, WO 2008103422 and CA 1041788, each of which is incorporated herein by reference in its entirety.

The formulation can also contain a surfactant. Non-limiting examples of surfactants include nitrogen-surfactant blends such as Prefer 28 (Cenex), Surf-N(US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); and organo-silicone surfactants include Silwet L77 (UAP), Silikin (Terra), Dyne-Amic (Helena), Kinetic (Helena), Sylgard 309 (Wilbur-Ellis) and Century (Precision). In one embodiment, the surfactant is present at a concentration of between 0.01% v/v to 10% v/v. In another embodiment, the surfactant is present at a concentration of between 0.1% v/v to 1% v/v.

In certain cases, the formulation includes a microbial stabilizer. Such an agent can include a desiccant. As used herein, a “desiccant” can include any compound or mixture of compounds that can be classified as a desiccant regardless of whether the compound or compounds are used in such concentrations that they in fact have a desiccating effect on the liquid inoculant. Such desiccants are ideally compatible with the bacterial population used, and should promote the ability of the microbial population to survive application on the seeds and to survive desiccation. Examples of suitable desiccants include one or more of trehalose, sucrose, glycerol, and methylene glycol. Other suitable desiccants include, but are not limited to, non-reducing sugars and sugar alcohols (e.g., mannitol or sorbitol). The amount of desiccant introduced into the formulation can range from about 5% to about 50% by weight/volume, for example, between about 10% to about 40%, between about 15% and about 35%, or between about 20% and about 30%.

In some cases, it is advantageous for the formulation to contain agents such as a fungicide, an antibacterial agent, an herbicide, a nematicide, an insecticide, a plant growth regulator, a rodenticide, or a nutrient. Such agents are ideally compatible with the agricultural seed or seedling onto which the formulation is applied (e.g., it should not be deleterious to the growth or health of the plant). Furthermore, the agent is ideally one which does not cause safety concerns for human, animal or industrial use (e.g., no safety issues, or the compound is sufficiently labile that the commodity plant product derived from the plant contains negligible amounts of the compound).

In one embodiment of the disclosure, the composition is in a fluid form suitable for spray application or seed coating. In the liquid form, for example, solutions or suspensions, the bacterial endophytic populations of the present invention can be mixed or suspended in water or in aqueous solutions. Suitable liquid diluents or carriers include water, aqueous solutions, petroleum distillates, or other liquid carriers.

In another embodiment, said composition is in a paste-like form. In still another embodiment, the composition is in a substantially dry and powdered form for dusting. Solid compositions can be prepared by dispersing the bacterial endophytic populations of the invention in and on an appropriately divided solid carrier, such as peat, wheat, bran, vermiculite, clay, talc, bentonite, diatomaceous earth, fuller's earth, pasteurized soil, and the like. When such formulations are used as wettable powders, biologically compatible dispersing agents such as nonionic, anionic, amphoteric, or cationic dispersing and emulsifying agents can be used.

The composition is optionally applied as a spray. In another embodiment, the composition is applied to seeds, as a seed coating. In yet another embodiment, the composition is applied both as a spray and a seed coating.

In an embodiment, the composition comprises a suspension of the isolated bacterial endophyte and a seed coating agent as carrier. Optionally, the seed coating agent is polyvinyl pyrrolidine (PVP). In one example, 500 μL of bacterial suspension, optionally 10 μl to 1 mL of bacterial suspension, is mixed with 10 ml of PVP, optionally 1 ml to 100 ml PVP.

In another embodiment, the composition comprises a suspension of the bacterial endophyte and a carrier suitable for spray application. For example, bacteria may be suspended in 10 mM Tris Hcl, pH 7 to OD₅₉₅ 0.5, optionally OD₅₉₅ 0.1-0.8.

The formulations comprising the bacterial endophytic population of the present invention typically contains between about 0.1 to 95% by weight, for example, between about 1% and 90%, between about 3% and 75%, between about 5% and 60%, between about 10% and 50% in wet weight of the bacterial population of the present invention. It is preferred that the formulation contains at least about 10³ CFU per ml of formulation, for example, at least about 10⁴, at least about 10⁵, at least about 10⁶, at least 10⁷ CFU, at least 10⁸ CFU per ml of formulation.

In one embodiment, the composition can inhibit fungal growth. One of skill in the art can readily determine the amount or concentration of the composition that can be applied to the plant or plant seed to inhibit fungal growth. For example, the bacterial density of the inoculate can range from an OD600 of 0.1 to 0.8. In one embodiment, the bacterial density of the inoculate at OD600 is 0.5, optionally approximately 0.5.

Also provided are synthetic combinations of the isolated bacterial endophyte described herein in association with a plant. In one embodiment, the bacterial endophyte reside within the seeds, roots, stems and/or leaves of the plant as an endophyte. Optionally, the plant may be a plant seed or seedling. In one embodiment, the bacterial endophyte is heterologous to the microbial population of the plant. For example, synthetic combination may be a bacterial strain having antifungal properties as described herein which has been artificially inoculated on a plant that does not naturally harbor or contain the bacterial endophyte. In one embodiment, the agricultural plant is a grass. In one embodiment, the grass is a cereal or a turfgrass. In one embodiment, grass is selected from the group consisting of maize, rice, wheat, barley, sorghum, bentgrass, Bermuda grass, bluegrass, fescue, ryegrass and zoysiagrass.

### III. Methods and Uses of the Bacterial Endophytes

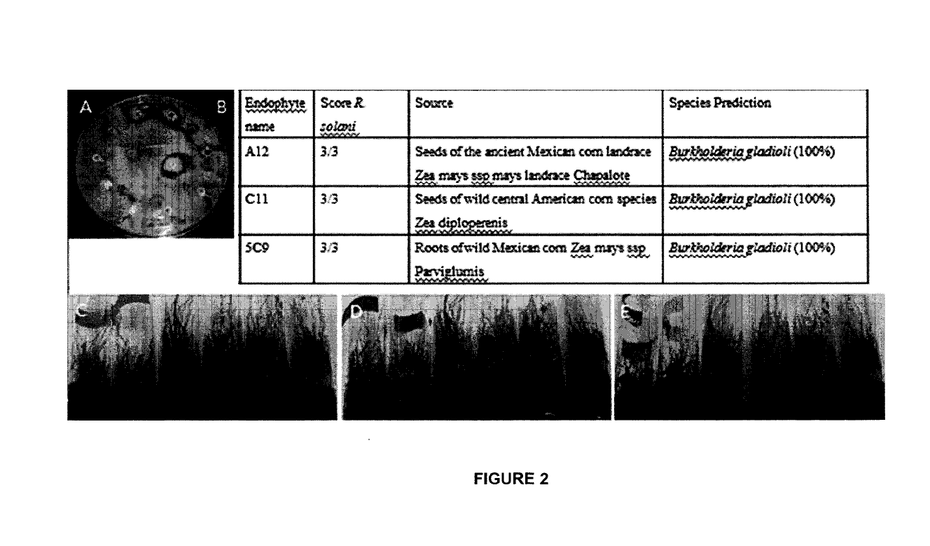

It is shown that the bacterial endophytes described herein have antifungal activity. For example, the isolated bacterial endophytes A12, C11 and C9 are able to suppress the growth of Scelerotinia homeocarpa and Rhizoctonia solani as shown in FIGS. 1 and 2. Endophytes A12 and C11 are also shown to inhibit the growth of 16 additional crop pathogenic fungi (see Table 4).

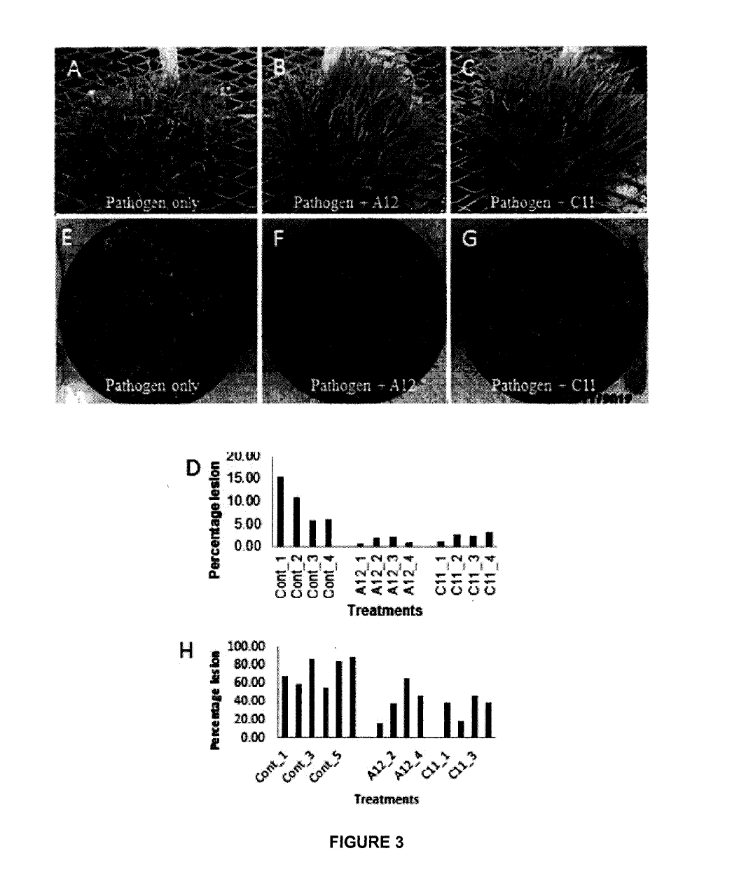

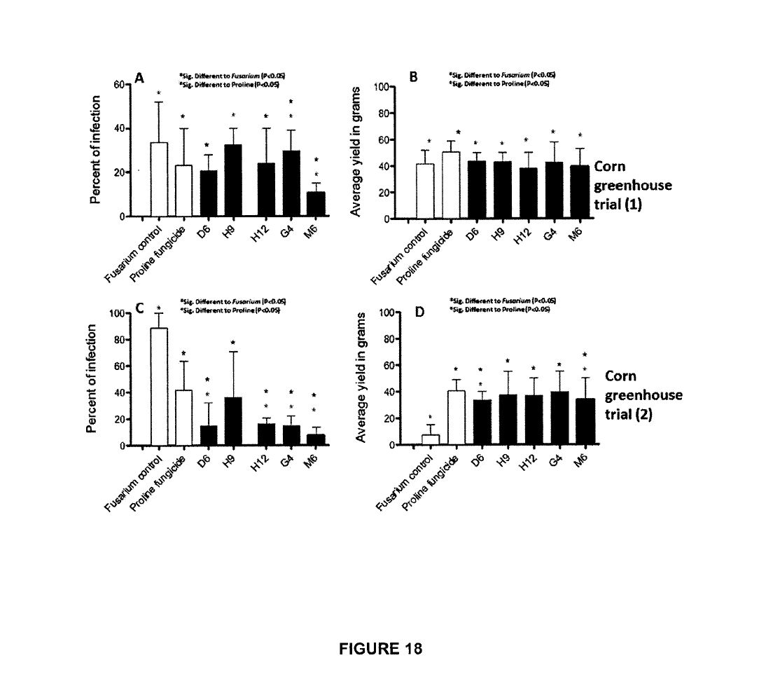

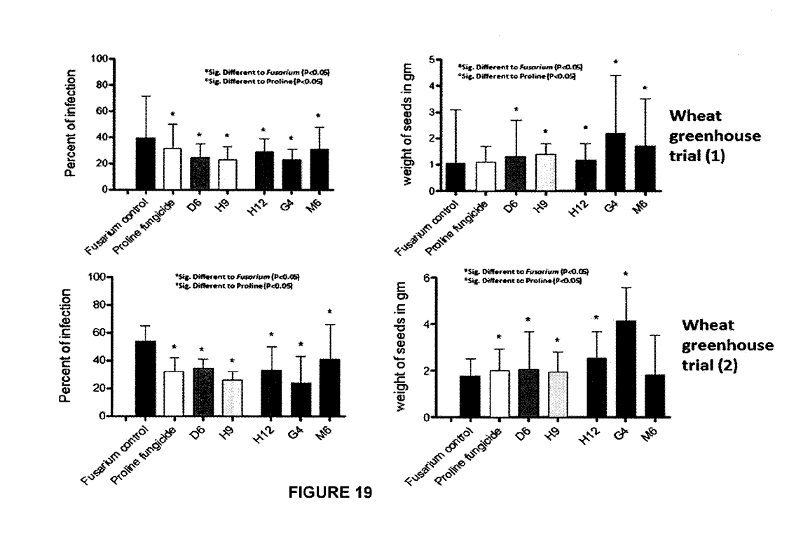

It is further shown herein that inoculation by endophytes A12, C11 and C9 in creeping bentgrass decreases the percentage of dollar spot lesions in the plants (FIGS. 3, 4 and 13). Still further, it is shown herein that inoculation by endophyte 4H12 decreases the percent infection of Fusarium graminearum and results in increased yield (FIGS. 18 and 19). Endophyte 3H8 has been shown to have antifungal activity against both S. homeocarpa and R. Solani in vitro.

Therefore, in one aspect, the disclosure provides a method of preventing or inhibiting fungal growth on a plant, comprising inoculating a plant with the bacterial endophytes described herein.

In another embodiment, the disclosure provides a use of the bacterial endophytes described herein to prevent or inhibit fungal growth on a plant.

Various fungi can be inhibited by the bacterial endophytes described herein. In one aspect of the disclosure, the fungus belongs to a class selected from the group consisting of Dothideomycetes, Ascomycetes, Agaricomycetes, Sordariomycetes, and Eurotiomycetes. In another aspect of the disclosure, the fungal pathogen belongs to an order selected from the group consisting of Pleosporales, Helotiales, Cantharellales, Hypocreales, Eurotiales, Capnodiales, and Botryosphaeriales. In yet another aspect of the disclosure, the fungal pathogen may belong to a family selected from the group consisting of Pleosporaceae, Sclerotiniaceae, Ceratobasidiaceae, Nectriaceae, Trichocomaceae, Davidiellaceae, Botryosphaeriaceae, Montagnulaceae, and Hypocreaceae.

In another aspect of the disclosure, the fungus belongs to one of the following genera: Alternaria, Sclerotinia, Rhizoctonia, Fusarium, Aspergillus, Davidiella, Diplodia, Epicoccum, Nigrospora, Parconiothyrium, Penicillium or Trichoderma. In another aspect of the disclosure, the fungus is Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum (Gibberella avenacea), Fusarium lateritium, Fusarium sporotrichioides, Nigrospora oryzae, Nigrospora sphaerica, Paraconiothyrium brasiliense, Penicillium commune, Penicillium expansum, Penicillium olsonii or Trichoderma longibrachiatum.

“Inhibiting fungal growth” includes, but is not limited to, decreasing the amount of fungal growth on a plant, decreasing the speed of fungal growth on a plant, decreasing the severity of a fungal infection on a plant, decreasing the amount of diseased area of a plant, decreasing the percentage or number of infected seeds, decreasing the percentage or number of disease lesions on a plant decreasing the percentage of apparent fungal infection of a plant and/or treating or preventing fungal growth in a plant. Any of the above criteria can be decreased by at least 5%, 7.5%, 10%, 15%, 20%, 25%, 30%, 40%, 50%, 75%, 100%, 150% or 200% in an inoculated plant compared to a non-inoculated plant.

“Inhibiting fungal growth” also includes preventing fungal growth.

“Inhibiting fungal growth on a plant” can result in improved growth of the inoculated plant. Determining an improvement in plant growth using the bacterial endophytes described herein can be assessed in a number of ways. For example, the size or weight of the entire plant or a part thereof (such as seeds or roots) can be measured. In an embodiment, the average mass of an inoculated plant is increased at least 5%, 7.5%, 10%, 15%, 20%, 25%, 30%, 40%, 50%, 75%, 100%, 150% or 200% fresh weight or dry weight. In another embodiment, the average mass of the seeds of an inoculated plant is increased at least 5%, 7.5%, 10%, 15%, 20%, 25%, 30%, 40%, 50%, 75%, 100%, 150% or 200% fresh weight or dry weight. In still another embodiment, the endophyte-associated plant exhibits at least 4%, 5%, 6%, 7%, 8%, 9%, 10%, 15%, 20%, 25%, 30%, 40%, 50%, 75%, 100%, 150% or 200% or more fruit or grain yield, than the reference agricultural plant grown under the same conditions.

The bacterial endophytes described herein may also be used as prophylactic agents to decrease the chance of a fungal infection from occurring in a plant.

The bacterial endophytes described herein may also be used for treating and/or preventing dollar spot disease caused by Sclerotinia homoeocarpa in grass. Treating and/or preventing dollar spot disease in grass includes, but is not limited to, decreasing the amount of Sclerotinia homoeocarpa growth on a plant, decreasing the speed of Sclerotinia homoeocarpa growth on a plant, decreasing the severity of Sclerotinia homoeocarpa infection on a plant, decreasing the amount of diseased area of a plant, decreasing the percentage or number of infected seeds, decreasing the percentage or number of disease lesions on a plant, and/or decreasing the percentage of apparent Sclerotinia homoeocarpa infection on a plant. Any of the above criteria can be decreased by at least 5%, 7.5%, 10%, 15%, 20%, 25%, 30%, 40%, 50%, 75%, 100%, 150% or 200% in an inoculated plant compared to a non-inoculated plant.

Treating and/or preventing dollar spot disease in grass can also result in improved growth of the inoculated grass. Improved growth of the grass can be assessed in a number of ways. For example, the size or weight of the entire plant or a part thereof can be measured. Improved growth can also be measured by an increase in the speed of growth of the grass.

The bacterial endophytes described herein may also be used for treating and/or preventing brown patch disease caused by Rhizoctonia solani in grass. Treating and/or preventing brown patch disease in grass includes, but is not limited to, decreasing the amount of Rhizoctonia solani growth on a plant, decreasing the speed of Rhizoctonia solani growth on a plant, decreasing the severity of Rhizoctonia solani infection on a plant, decreasing the amount of diseased area of a plant, decreasing the percentage or number of infected seeds, decreasing the percentage or number of disease lesions on a plant, and/or decreasing the percentage of apparent Rhizoctonia solani infection on a plant. Any of the above criteria can be decreased by at least 5%, 7.5%, 10%, 15%, 20%, 25%, 30%, 40%, 50%, 75%, 100%, 150% or 200% in an inoculated plant compared to a non-inoculated plant.

Treating and/or preventing brown patch disease in grass can also result in improved growth of the inoculated grass. Improved growth of the grass can be assessed in a number of ways. For example, the size or weight of the entire plant or a part thereof can be measured. Improved growth can also be measured by an increase in the speed of growth of the grass.

The bacterial endophyte described herein may also be used for treating and/or preventing ear and/or kernel rot diseases in corn. In one aspect of the disclosure, the bacterial endophyte described herein is used to treat Gibberalla ear rot caused by F. graminearum in corn. Treating and/or preventing ear and/or kernel rot diseases in corn includes, but is not limited to, decreasing the amount of ear and/or kernel rot, decreasing the severity of ear and/or kernel rot, decreasing the amount of diseased area of a plant, decreasing the percentage of infected seeds and/or decreasing the percentage of apparent ear and/or kernel rot. Any of the above criteria can be decreased by at least 5%, 7.5%, 10%, 15%, 20%, 25%, 30%, 40%, 50%, 75%, 100%, 150% or 200% in an inoculated plant compared to a non-inoculated plant.

Treating and/or preventing ear and/or kernel rot diseases in corn can also result in improved growth of the inoculated corn plant. Improved growth of the corn plant can be assessed in a number of ways. For example, the size or weight of the entire plant or a part thereof (such as kernels) can be measured. Improved growth can also be measured by an increase in the speed of growth of the plant.

In an embodiment, the average mass of an inoculated plant is increased at least 5%, 7.5%, 10%, 15%, 20%, 25%, 30%, 40%, 50%, 75%, 100%, 150% or 200% fresh weight or dry weight. In another embodiment, the average mass of the kernels of an inoculated corn plant is increased at least 5%, 7.5%, 10%, 15%, 20%, 25%, 30%, 40%, 50%, 75%, 100%, 150% or 200% fresh weight or dry weight. In still another embodiment, the endophyte-associated plant exhibits at least 4%, 5%, 6%, 7%, 8%, 9%, 10%, 15%, 20%, 25%, 30%, 40%, 50%, 75%, 100%, 150% or 200% or more grain yield, than the reference agricultural plant grown under the same conditions.

The bacterial endophyte described herein may also be used for treating and/or preventing head blight diseases in plants such as wheat or barley. In one aspect of the disclosure, the bacterial endophyte described herein is used to treat head blight in plants caused by F. graminearum. Treating and/or preventing head blight in a plant includes, but is not limited to, decreasing the amount of head blight, decreasing the severity of head blight, decreasing the amount of diseased area of a plant, decreasing the percentage of infected seeds and/or decreasing the percentage of apparent head blight. Any of the above criteria can be decreased by at least 5%, 10%, 25%, 50%, 75%, 100%, 150% and 200% in an inoculated plant compared to a non-inoculated plant.

Treating and/or preventing head blight diseases in plants such as wheat or barley can also result in improved growth of the inoculated plant. Improved growth of the wheat or barley plant can be assessed in a number of ways. For example, the size or weight of the entire plant or a part thereof can be measured. Improved growth can also be measured by an increase in the speed of growth of the plant.

In an embodiment, the average mass of an inoculated wheat or barley plant is increased at least 5%, 7.5%, 10%, 15%, 20%, 25%, 30%, 40%, 50%, 75%, 100%, 150% or 200% fresh weight or dry weight. In another embodiment, the percentage of infected seeds in an inoculated wheat or barley plant is increased at least 5%, 7.5%, 10%, 15%, 20%, 25%, 30%, 40%, 50%, 75%, 100%, 150% or 200%. In still another embodiment, the endophyte-associated plant exhibits at least 4%, 5%, 6%, 7%, 8%, 9%, 10%, 15%, 20%, 25%, 30%, 40%, 50%, 75%, 100%, 150% or 200% or more grain yield, than the reference agricultural plant grown under the same conditions.

The methods described herein can be applied to any plant in need thereof. It is known that bacterial endophytes readily colonize a wide diversity of plant species and thus inoculation with the endophytes described herein will colonize a variety of plant species.

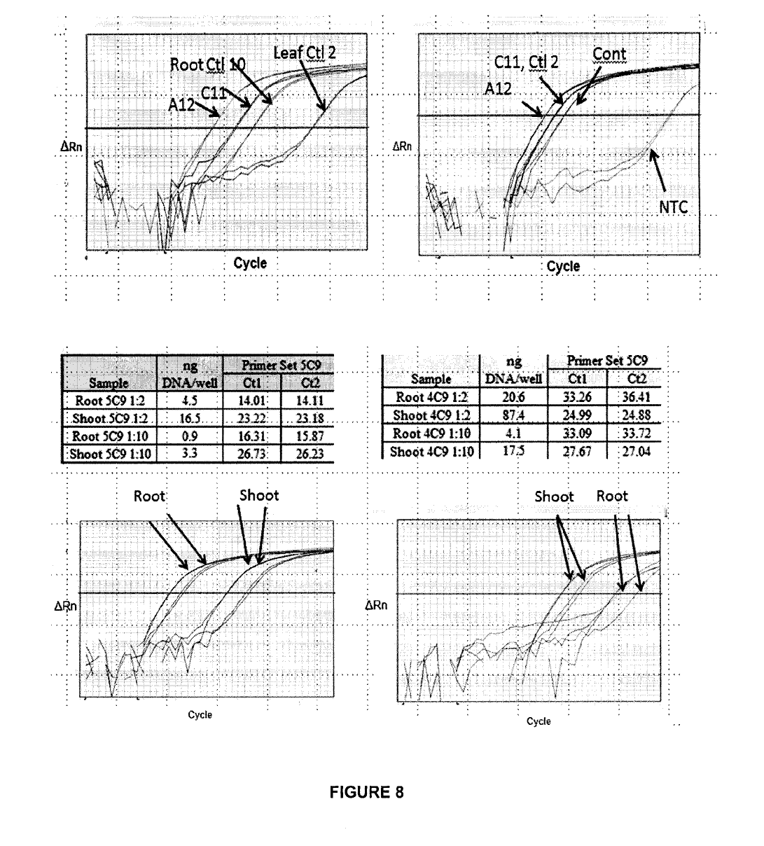

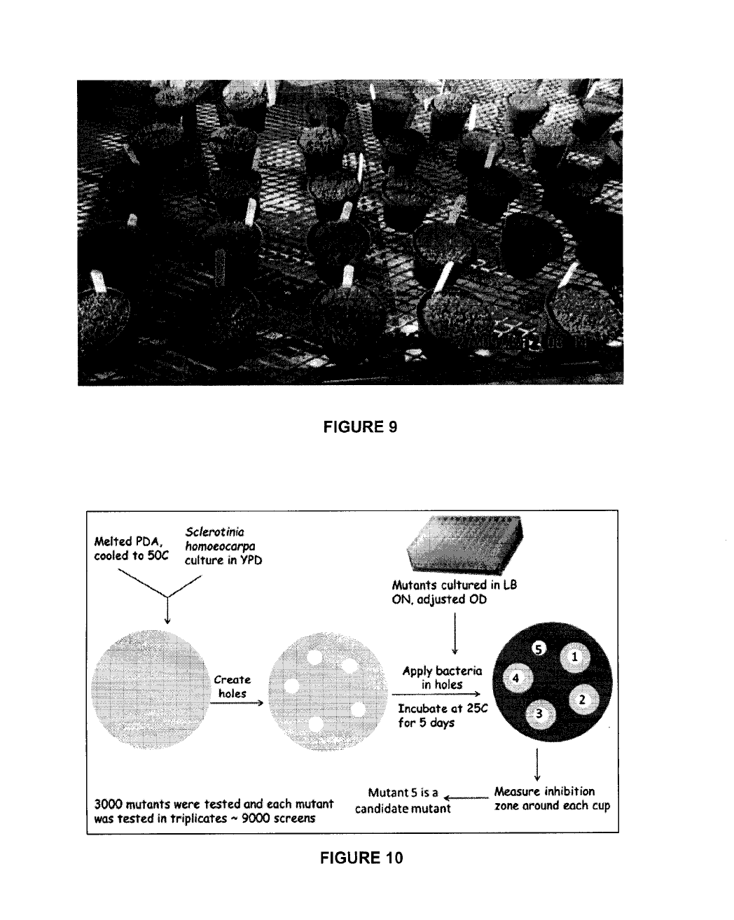

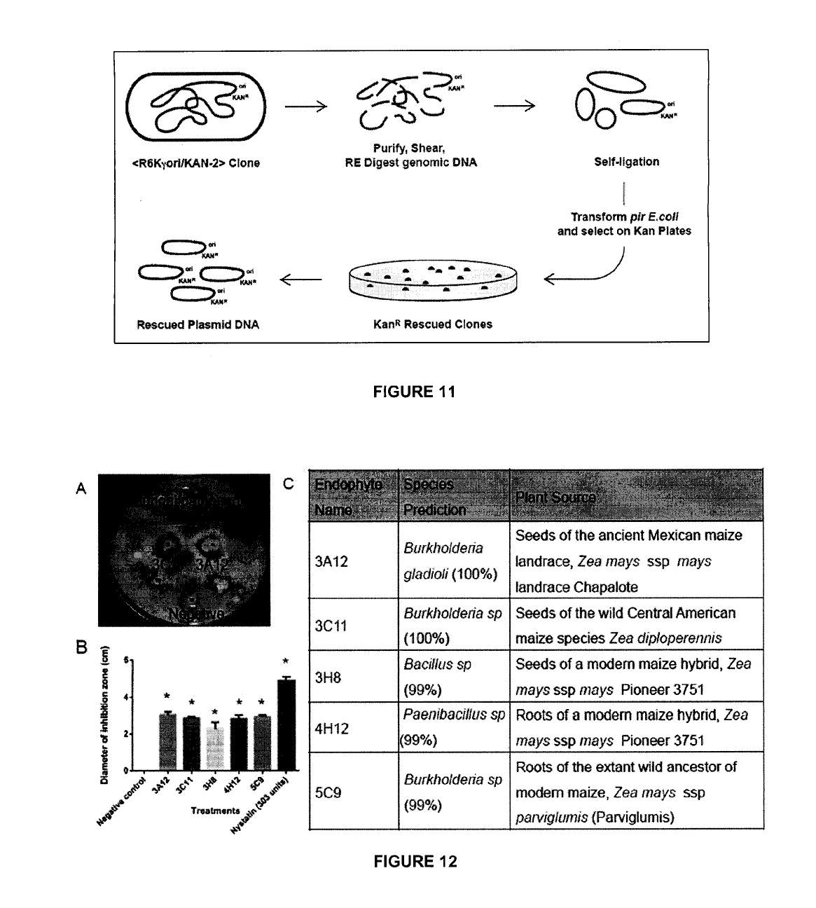

Endophyte A12, C11 and C9 colonization has been shown to occur in creeping bentgrass (FIGS. 7 and 8). Thus, in one embodiment, the plant is a grass plant. In another embodiment, the grass is a turfgrass. In yet another embodiment, the grass is bentgrass (Agrostis), bermudagrass (Cynodon sp.), bluegrass (Poa sp.), fescue (Festuca sp.), ryegrass (Lolium sp.) or zoysiagrass (Zoysia sp.).

In another embodiment, the plant is from the Poaceae family. In yet another embodiment, the plant is corn (Zea mays), wheat (Triticum aestivum), rice (Oryza sativa), barley (Hordeum vulgare), or sorghum (Sorghum bicolor).

The plant can be inoculated with the bacterial endophytes described herein or a composition comprising the bacterial endophytes described herein, using techniques known in the art. For example, the bacterial endophytes may be applied to the roots of the plant, or to young germinated seedlings, or to ungerminated or germinated seeds.

### IV. Genes and Uses Thereof

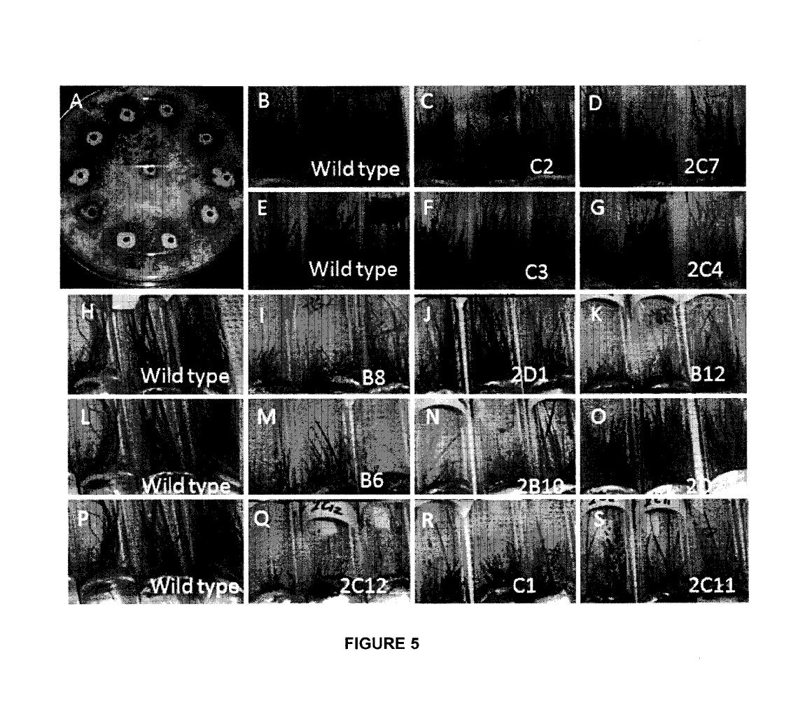

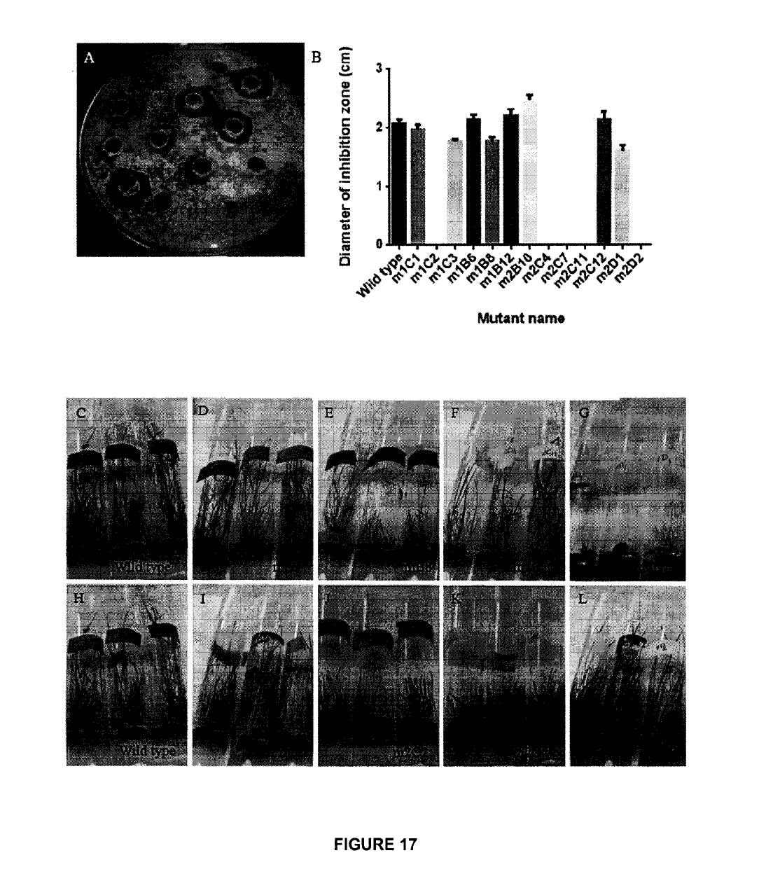

Several genes are shown herein to be required for the antifungal activity of endophyte A12 (Tables 2, 3, 5, 6, 8 and 9 and FIGS. 5 and 17).

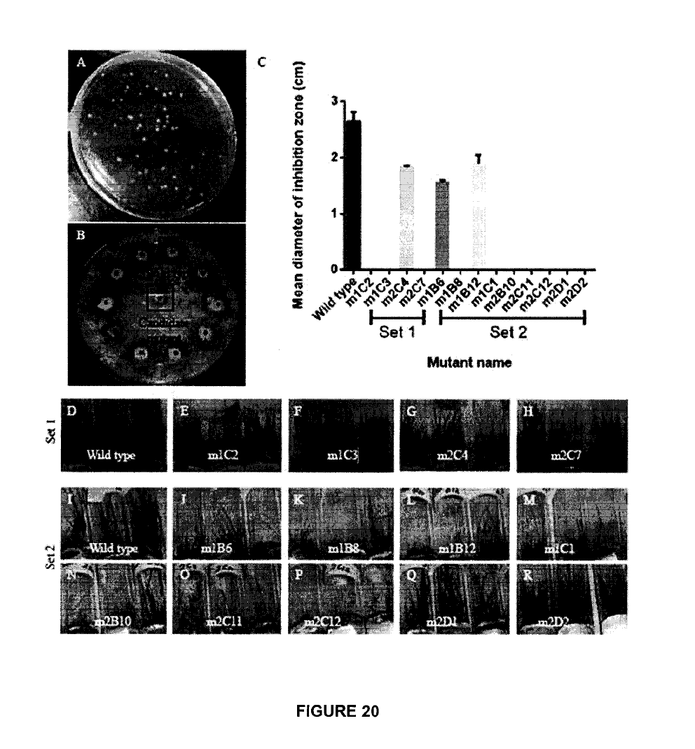

Using Tn5 transposon mutagenesis, thirteen mutants of endophyte A12 were identified that caused a loss of anti S. homeocarcpa activity (Table 3). Twelve of the thirteen mutants were subsequently verified in planta (FIG. 5). The seven underlining genes corresponding to the twelve mutants were identified based on the best BLAST match (Table 3). Eight mutants were identified that caused a loss of anti Rhizoctonia solani activity as shown in FIG. 17. Additional testing of endophyte A12 mutants is also shown in Example 4 and FIGS. 20-23, 25 and 26.

Accordingly, in one aspect of the disclosure, an isolated gene comprising a nucleotide sequence that has at least 70%, 80%, 85%, 90%, 95%, 96%, 97%, 98%, or 99% sequence identity to any one of SEQ ID NOs: 4-25 is provided. In another aspect of the disclosure, an isolated gene comprising or consisting of the nucleotide sequence set forth in any one of SEQ ID NOs: 4-25 is provided. In one embodiment, the isolated gene encodes for a protein that is capable of conferring antifungal activity, optionally anti-Sclerotinia homoeocarpa activity and/or anti-Rhizoctonia solani activity and/or anti-Fusarium activity, to a bacteria and/or plant.

In one embodiment, the gene encodes for a protein identified in Table 3, 5, 6, 8 or 9. In one embodiment, the gene encodes for a protein selected from the group consisting of YajQ (SEQ ID NO:29), Long-chain-fatty-acid-CoA ligase (EC 6.2.1.3) (SEQ ID NO:30), Fatty acid desaturase (EC 1.14.19.1); Delta-9 fatty acid desaturase (EC 1.14.19.1) (SEQ ID NO:31), lysine-tRNA synthetase(SEQ ID NO:32), ToIR protein(SEQ ID NO:33), Arginine/Ornithine/Lysine decarboxylase (SEQ ID NO:34) and Succinate dehydrogenase (SEQ ID NO:35).

In another aspect of the disclosure, an isolated protein comprising an amino acid sequence that has at least 70%, 80%, 85%, 90%, 95%, 96%, 97%, 98%, or 99% sequence identity to any one of SEQ ID NOs:29-35 is provided. In another aspect of the disclosure, an isolated protein comprising or consisting of the amino acid sequence set forth in any one of SEQ ID NOs:29-35 is provided. In one embodiment, the protein that is capable of conferring antifungal activity, optionally anti-Sclerotinia homoeocarpa activity and/or anti-Rhizoctonia solani activity and/or anti-Fusarium activity, to a bacteria and/or plant.

In another aspect of the disclosure, a recombinant DNA construct comprising an isolated gene comprising a nucleotide sequence that has at least 70%, 80%, 85%, 90%, 95%, 96%, 97%, 98%, or 99% sequence identity to any one of SEQ ID NOs: 4-25 is provided. In another aspect of the disclosure, a recombinant DNA construct comprising an isolated gene comprising or consisting of the nucleotide sequence set forth in any one of SEQ ID NOs: 4-25 is provided.

In another aspect of the disclosure, a recombinant DNA construct comprising a nucleotide sequence encoding a protein identified in Table 3, 5, 6, 8 or 9. In one embodiment, the recombinant DNA construct comprises a nucleotide sequence encoding a protein that has at least 70%, 80%, 85%, 90%, 95%, 96%, 97%, 98%, or 99% sequence identity to any one of SEQ ID NOs:29-35 is provided. In another aspect of the disclosure, a recombinant DNA construct comprising a nucleotide sequence encoding a protein set forth in any one of SEQ ID NOs:29-35 is provided.

The novel genes described herein are useful for conferring antifungal activity to a bacteria and/or plant. In one embodiment, expression of at least one of the novel genes in a bacteria and/or plant cell results in increased antifungal activity of the bacteria and/or plant cell. In another embodiment, the increased antifungal activity is increased anti-Sclerotinia homoeocarpa activity and/or increased anti-Rhizoctonia solani activity and/or anti-Fusarium activity.

Accordingly, another aspect of the disclosure provides transformed plant cells, plants, and plant parts, comprising the nucleic acid molecules of the disclosure and methods of generating the transformed plant cells, plants, and plant parts. As used herein, the term “plant parts” includes any part of the plant including the seeds.

Another aspect of the disclosure provides transformed bacterial cells, comprising the nucleic acid molecules of the disclosure and methods of generating the bacterial cells.

Transformation is a process for introducing heterologous DNA into a bacterial cell, plant cell, plant or plant part. Transformed bacterial cells, plant cells, plants, and plant parts are understood to encompass not only the end product of a transformation process, but also transgenic progeny thereof. “Transformed,” “transgenic,” and “recombinant” refer to a host organism such as a bacterial endophyte or a plant into which a heterologous nucleic acid molecule has been introduced. The nucleic acid molecule can be stably integrated into the genome of the host or the nucleic acid molecule can also be present as an extrachromosomal molecule.

Methods of transformation are well known in the art. In one aspect of the present disclosure, transformation comprises introducing into a bacterial cell, plant cell, plant, or plant part an expression construct comprising a nucleic acid molecule of the present disclosure to obtain a transformed bacterial cell, plant cell, plant, or plant part, and then culturing the transformed bacterial cell, plant cell, plant, or plant part. The nucleic acid molecule can be under the regulation of a constitutive or inducible promoter. The method can further comprise inducing or repressing expression of a nucleic acid molecule of a sequence in the plant for a time sufficient to modify the concentration and/or composition in the bacterial cell, plant cell, plant, or plant part.

In one aspect of the disclosure, the transformed bacterial cell, plant cell, plant, or plant part is resistant to infection by pathogenic fungi. In one embodiment, the pathogenic fungi is selected from the group consisting of Alternaria alternata, Sclerotinia homoeocarpa, Rhizoctonia solani, Fusarium graminearum, Aspergillus niger, Davidiella tassiana, Diplodia pinea, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii and Trichoderma longibrachiatum. In another embodiment, the fungus is selected from Sclerotinia homoeocarpa, Rhizoctonia solani and Fusarium graminearum.

Table 1 details various plants that can be affected by the pathogenic fungi listed above. Accordingly, in one embodiment, a strawberry plant, Japanese pear plant, papaya fruit plant or plant from the Cucurbit family (including cucumbers, melons, squashes, pumpkin) is transformed with at least one of the genes described herein for increasing resistance to Alternaria alternata.

In another embodiment, a pepper, tomato, eggplant or tobacco plant is transformed with at least one of the genes described herein for increasing resistance to Aspergillus niger.

In another embodiment, a cantaloupe, cucumber, tomato, apple or pear plant is transformed with at least one of the genes described herein for increasing resistance to Epicoccum nigrum.

In another embodiment, an okra plant is transformed with at least one of the genes described herein for increasing resistance to Fusarium lateritium.

In another embodiment, an asparagus officinalis (asparagus), Avena sativa (oats), Brassica oleracea var. botrytis (cauliflower), Brassica oleracea var. capitata (cabbage), Cicer arietinum (chickpea), Cucumis sativus (cucumber), Daucus carota (carrot), Fragaria vesca (wild strawberry), Glycine max (soyabean), Helianthus annuus (sunflower), Hordeum vulgare (barley), Lens culinaris subsp. culinaris (lentil), Oryza sativa (rice), Phaseolus vulgaris (common bean), Prunus persica (peach), Prunus persica var. nucipersica (nectarine), Rubus idaeus (raspberry), Solanum lycopersicum (tomato), Solanum tuberosum (potato), Triticum aestivum (wheat), Vicia faba (faba bean) or Zea mays (maize) plant is transformed with at least one of the genes described herein for increasing resistance to Gibberella avenacea.

In another embodiment, a Oryza sativa (rice) plant is transformed with at least one of the genes described herein for increasing resistance to Nigrospora oryzae.

In another embodiment, a Prunus spp., apple or pear plant transformed with at least one of the genes described herein for increasing resistance to Paraconiothyrium brasiliense.

In another embodiment, a winter wheat, rye, pea (Pisum sativum) or broccoli plant is transformed with at least one of the genes described herein for increasing resistance to Fusarium avenaceum.

In another embodiment, a corn or oat plant is transformed with at least one of the genes described herein for increasing resistance to Fusarium sporotrichioides.

In another embodiment, a pear, strawberry, apple, tomato, corn, or rice plant is transformed with at least one of the genes described herein for increasing resistance to Penicillium expansum.

TABLE 1
List of plants affected by various fungal pathogens

| Fungus | Plants |
|---|---|
| Alternaria alternata | has a wide host range (380 host species are |
| | affected by different pathotypes such as |
| | strawberry, Japanese pear, papaya fruit, |
| | Cucurbit family (including cucumbers, melons, |
| | squashes, pumpkin)) |
| Aspergillus niger | pepper, tomato, eggplant and tobacco |
| Epicoccum nigrum | cantaloupe, cucumber, tomato, apple and pear |
| Fusarium lateritium | Okra (Abelmoscbus esculentus) |
| Gibberella avenacea | Asparagus officinalis (asparagus), Avena sativa |
| | (oats) Brassica oleracea var. botrytis |
| | (cauliflower), Brassica oleracea var. capitata |
| | (cabbage), Cicer arietinum (chickpea), |
| | Cucumis sativus (cucumber), Daucus carota |
| | (carrot), Fragaria vesca (wild strawberry), |
| | Glycine max (soyabean), Helianthus annuus |
| | (sunflower), Hordeum vulgare (barley), |
| | Lens culinaris subsp. culinaris (lentil), |
| | Oryza sativa (rice), Phaseolus vulgaris |
| | (common bean), Prunus persica (peach), |
| | Prunus persica var. nucipersica (nectarine), |
| | Rubus idaeus (raspberry), Solanum |
| | lycopersicum (tomato), Solanum tuberosum |
| | (potato), Triticum aestivum (wheat), Vicia faba |
| | (faba bean), Zea mays (maize) |
| Nigrospora oryzae | Oryza sativa (rice) |
| Paraconiothyrium | Prunus spp., apple and pear |
| brasiliense | |
| Fusarium avenaceum | winter wheat, rye, pea (Pisum sativum) and |
| (the anamorphic state of | broccoli |
| Gibberella avenacea) | |
| Fusarium | Forage Corn and oat |
| sporotrichioides | |
| Penicillium expansum | pears, strawberries, apple, tomatoes, corn, and |
| | rice |

The above disclosure generally describes the present application. A more complete understanding can be obtained by reference to the following specific examples. These examples are described solely for the purpose of illustration and are not intended to limit the scope of the application. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present application:

### EXAMPLES

### Example 1

In plants, microbes that inhabit internal tissues without causing disease are called endophytes [7]. Endophytes have been shown to help host plants acquire nutrients, stimulate root growth and suppress pests and pathogens [7, 10]. A recent, systematic global survey of bacterial endophytes of corn successfully cultured ˜250 bacterial endophytes [5, 6, 8]. Corn is a grass, related to turf. Approximately 200 of the corn endophytes were tested in vitro in agar plates and as seed coating in tubes for their ability to confer resistance by creeping bentgrass to dollar spot and brown patch.

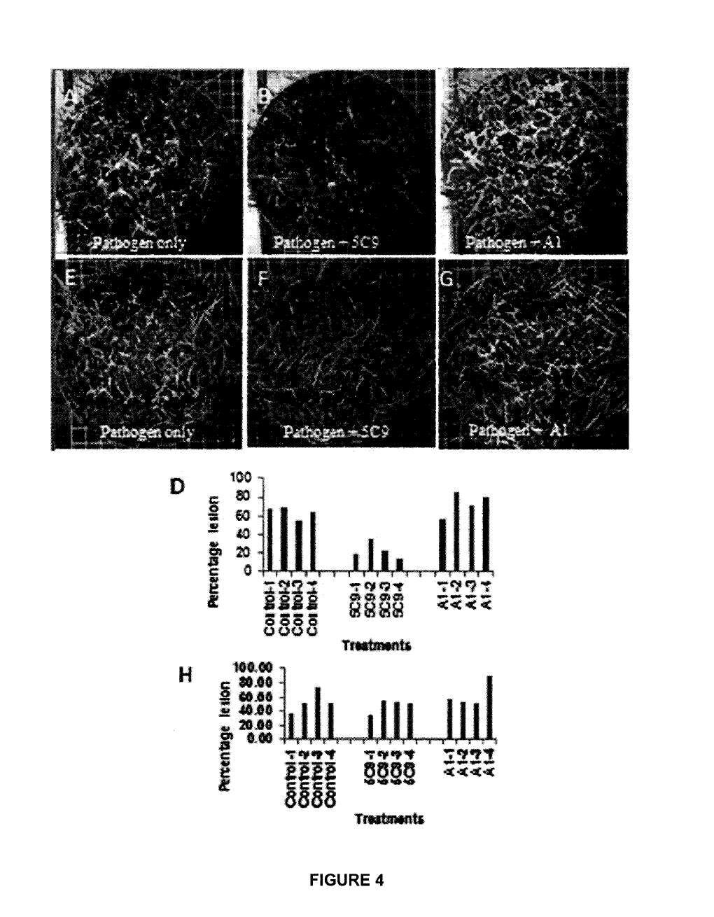

Four candidates from these in vitro and in planta tube experiment (FIGS. 1 and 2) were identified. The four candidates were tested as a foliar spray (using field cupcuts) in a greenhouse experiment against S. homoeocarpa. Three strong positive candidates following two independent, replicated trials (See FIGS. 3 and 4). These endophytes are: endophyte 3A12 (isolated from the seeds of the ancient Mexican corn landrace Zea mays ssp mays landrace Chapalote; endophyte identified preliminarily as Burkholderia gladioli (100% identity); endophyte 3C11 isolated from the seeds of wild central American corn species Zea diploperenis; endophyte identified preliminarily as Burkholderia gladioli (100% identity); and endophyte 5C9 (isolated from the roots of Parviglumis; endophyte identified preliminarily as Burkholderia gladioli (100% identity). The 16S rRNA sequences of the endophytes 3A12, 3C11 and 5C9 are listed in Table 7.

These endophytes also conferred resistance to dollar spot in annual ryegrass showing that these microbes are effective across a range of turf species.

Endophyte 3A12 was selected for further analysis to understand the molecular mode(s) of action of disease-suppressing activity. A mutant screen was performed using 3000 random transposon (Tn-5) insertions. The 3000 insertions were screened in triplicate for loss of anti-S. homoeocarpa activity in vitro. Thirteen mutants showed complete or partial loss of activity and were selected as candidate mutants (FIG. 5A). Table 2 shows the optical density of overnight culture of candidate mutants used in the mutant screen and diameter of inhibition zones of S. homoeocarpa growth around candidate mutants.

TABLE 2
Optical density of overnight culture of candidate mutants used in the mutant screen
and diameter of inhibition zones of S. homoeocarpa growth around candidate mutants

| | | Diameter of inhibition | | | | | Diameter of inhibition | | |
|---|---|---|---|---|---|---|---|---|---|
| Mutant | | zones of S. homoeocarpa | | | Mutant | | zones of S. homoeocarpa | | |
| name | OD₅₉₅ | growth around mutant (cm) | | | name | OD₅₉₅ | growth around mutant (cm) | | |
| Wild type A12 | 0.3 | 2.5 | 3 | 2.4 | C3 | 0.4 | 0 | 0 | 0 |
| B12 | 0.5 | 1.8 | 1.7 | 2.2 | 2B10 | 0.5 | 0 | 0 | 0 |
| 2C4 | 0.4 | 1.8 | 1.8 | 1.5 | 2C7 | 0.3 | 0 | 0 | 0 |
| B6 | 0.5 | 1.5 | 1.6 | 1.6 | 2D2 | 0.5 | 0 | 0 | 0 |
| 2C12 | 0.3 | 0 | 0 | 0 | B8 | 0.4 | 0 | 0 | 0 |
| 2C11 | 0.3 | 0 | 0 | 0 | C2 | 0.1 | 0 | 0 | 0 |
| C1 | 0.5 | 0 | 0 | 0 | 2D1 | 0.5 | 0 | 0 | 0 |

Thirteen candidate mutants were tested in planta to confirm the loss of antifungal activity in creeping bentgrass. Twelve out of the thirteen tested candidates showed loss of activity in planta (FIG. 5 B-S).

TABLE 3
BLAST search for retrieved sequences (candidate genes) from candidate mutants

| | SEQ | | | | | E-value/ |
|---|---|---|---|---|---|---|
| Candidate | ID | | | BLAST against | | Nucleotide |
| mutant | NO: | Position | E-value | genome sequence | BLASTN | identity |
| m1B12-f | 13 | 6.1 | 0 | YajQ protein | Burkholderia | 0/99% |
| | | 115949-114984 | | | gladioli | |
| | | | | | hypothetical | |
| | | | | | protein | |
| m1B12-r | 12 | 6.1 | 0 | Long-chain-fatty- | Burkholderia | 0/99% |
| | | 115949-114984 | | acid--CoA ligase | gladioli | |
| | | | | (EC 6.2.1.3) | AMP-binding | |
| | | | | | enzyme family | |
| | | | | | protein | |
| m1C1-f | 6 | 6.1 | 2e−61 | Fatty acid | Burkholderia | 0/99% |
| m2C12-f | 20 | 174416-174542 | | desaturase (EC | gladioli | |
| | | | | 1.14.19.1); Delta-9 | fatty acid | |
| | | | | fatty acid | desaturase | |
| | | | | desaturase (EC | family protein | |
| | | | | 1.14.19.1) | | |
| m1C1-r | 7 | 6.1 | 6e−74 | Fatty acid | Burkholderia | 0/99% |
| m2C12-r | 21 | 174542-174404 | | desaturase (EC | gladioli | |
| | | | | 1.14.19.1); Delta-9 | fatty acid | |
| | | | | fatty acid | desaturase | |
| | | | | desaturase (EC | family protein | |
| | | | | 1.14.19.1) | | |
| m1B6-f | 24 | 34.1 | 0 | Mobile element | Burkholderia | 4e−126/98% |
| | | 90533-89625 | | protein | glumae | |
| | | | | | transposase | |
| | | | | | IS3/IS911 | |
| m1B6-r | 25 | 34.1 | 0 | hypothetical protein | No significant | |
| | | 88781-89713 | | | similarity | |
| m1C3-f | 10 | 14.1 | 0 | Mobile element | Burkholderia | 0/97% |
| m2D1-f | | 1182-555 | | protein | glumae | |
| | | | | | integrase core | |
| | | | | | domain protein | |
| m1C3-r | 11 | 34.1 | 0 | hypothetical protein | No significant | |
| | | 88693-89652 | | | similarity | |
| m2D1-r | | 87404-88311 | | lysine-tRNA | | |
| | | | | synthetase | | |
| m2B10-f | 14 | 15.1 | 0 | Hypothetical | Burkholderia | 2e−149/99% |
| m2C4-f | 16 | 98354-99278 | | protein | gladioli | |
| m2C11-f | 18 | | | | beta- | |
| | | | | | eliminating | |
| | | | | | lyase family | |
| | | | | | protein | |
| m2B10-r | 15 | 15.1 | 0 | TolR protein | Burkholderia | 0/99% |
| m2C4-r | 17 | 102260-101339 | | | gladioli | |
| m2C11-r | 19 | | | | TolR protein/ | |
| | | | | | TolA protein | |
| m2D2-f | 22 | 75.1 | 6e−37 | Arginine | Burkholderia | 0/99% |
| | | 21871-21947 | | decarboxylase (EC | gladioli | |
| | | | | 4.1.1.19); Ornithine | orn/Lys/Arg | |
| | | | | decarboxylase (EC | decarboxylase, | |
| | | | | 4.1.1.17); Lysine | N-terminal | |
| | | | | decarboxylase (EC | domain protein | |
| | | | | 4.1.1.18) | | |
| m2D2-r | 24 | 75.1 | 5e−47 | Arginine | Burkholderia | 0/99% |
| | | 21947-21854 | | decarboxylase (EC | gladioli | |
| | | | | 4. 1.1.19); Ornithine | orn/Lys/Arg | |
| | | | | decarboxylase (EC | decarboxylase, | |
| | | | | 4.1.1.17); Lysine | N-terminal | |
| | | | | decarboxylase (EC | domain protein | |
| | | | | 4.1.1.18) | | |
| m1C2-f | 8 | 7.1 | 0 | Succinate | Burkholderia | 0/99% |
| | | 157563-156790 | | dehydrogenase | gladioli | |
| | | | | flavoprotein subunit | succinate | |
| | | | | (EC 1.3.99.1) | dehydrogenase, | |
| | | | | | flavoprotein | |
| | | | | | subunit | |
| m1C2-r | 9 | 7.1 | 0 | Succinate | Burkholderia | 0/99% |
| | | 156790-157590 | | dehydrogenase | gladioli | |
| | | | | flavoprotein subunit | succinate | |
| | | | | (EC 1.3.99.1) | dehydrogenase, | |
| | | | | | flavoprotein | |
| | | | | | subunit | |

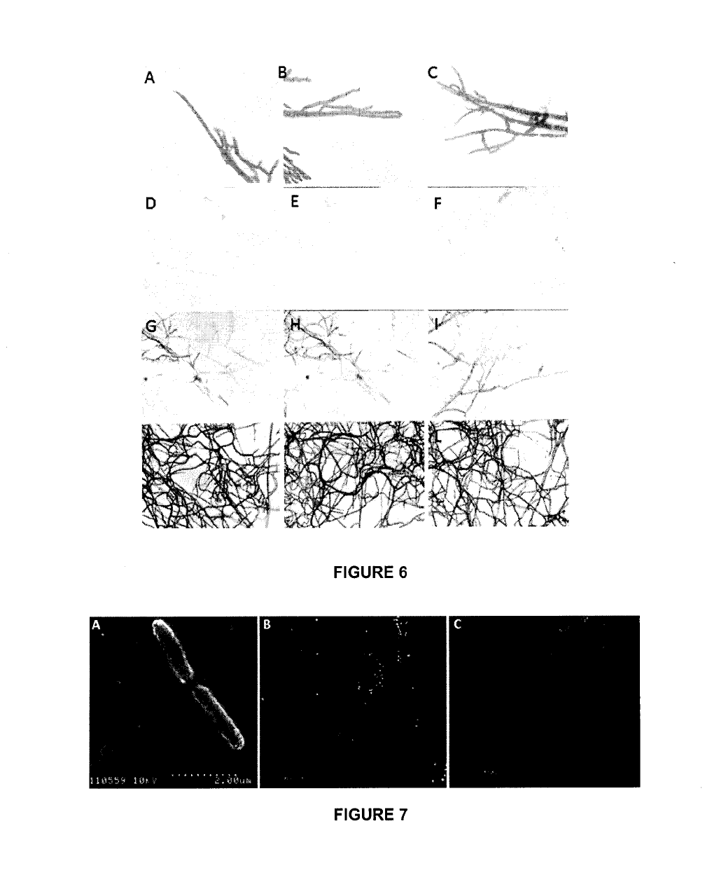

Microscopy experiments were performed to study the interaction between S. homoeocarpa and candidate 3A12 and 3C11 endophytes. After staining the fungus with neutral red and Evans blue, it was demonstrated that endophytes 3A12 and 3C11 can kill S. homoeocarpa (FIG. 6).

Candidate endophytes 3A12 and 3C11 were tested for their spectrum of activity against 18 different crop pathogenic fungi. Both bacteria were found to be active against 16 out of 18 tested fungi (Table 4) demonstrating that the endophytes may have the potential to combat the pathogens of diverse, economically important crops.

TABLE 4
Testing the spectrum of antifungal activity of endophytes
A12 and C11 against 18 different crop pathogenic fungi

| | | Diameter of inhibition zone (cm) | | | | | |
|---|---|---|---|---|---|---|---|
| | Fungus name | A12 | | | C11 | | |
| 1 | Alternaria alternata | 2.9 | 2.9 | 3 | 2.3 | 2.4 | 3 |
| 2 | Alternaria | 0 | 0 | 0 | 0 | 0 | 0 |
| | arborescens | | | | | | |
| 3 | Aspergillus niger | 1.5 | 0 | 1.7 | 1.7 | 0 | 1.8 |
| 4 | Davidiella tassiana | 3.5 | 3.5 | 3.5 | 3.4 | 3.5 | 3.5 |
| 5 | Diplodia pinea | 1.6 | 1.6 | 1.6 | 1.6 | 1.6 | 1.6 |
| 6 | Diplodia seriata | 0 | 0 | 0 | 0 | 0 | 0 |
| 7 | Epicoccum | 2.2 | 1.7 | 2.1 | 2.2 | 1.7 | 2 |
| | nigrum | | | | | | |
| 8 | Fusarium | 2 | 1.7 | 2 | 2.2 | 1.7 | 1.6 |
| | avenaceum | | | | | | |
| 9 | Fusarium | 2 | 2 | 2 | 2 | 1.9 | 2 |
| | lateritium | | | | | | |
| 10 | Fusarium | 2.3 | 2 | 0 | 2 | 2 | 0 |
| | sporotrichioides | | | | | | |
| 11 | Gibberella | 2 | 1.6 | 2 | 1.9 | 1.5 | 1.8 |
| | avenacea | | | | | | |
| 12 | Nigrospora oryzae | 2.2 | 2 | 2.1 | 2.1 | 2.1 | 2.2 |
| 13 | Nigrospora | 2.2 | 2.3 | 2.1 | 2.2 | 2.2 | 2.1 |
| | sphaerica | | | | | | |
| 14 | Paraconiothyrium | 2.1 | 2.1 | 2.5 | 2 | 2 | 2.5 |
| | brasiliense | | | | | | |
| 15 | Penicillium | 2.2 | 2.3 | 2 | 2.1 | 2.3 | 2 |
| | commune | | | | | | |
| 16 | Penicillium | 1.8 | 1.7 | 1.9 | 1.7 | 1.8 | 1.8 |
| | expansum | | | | | | |
| 17 | Penicillium | 2.2 | 2.1 | 2.2 | 2.3 | 1.9 | 2.3 |
| | olsonii | | | | | | |
| 18 | Trichoderma | 2.5 | 2.4 | 2.2 | 2.3 | 2.2 | 2.3 |
| | longibrachiatum | | | | | | |

### Materials and Methods

1. Methodology for In Vitro Screening for Endophytes that can Inhibit Growth of S. homoeocarpa or R. solani in Agar Plates

The agar diffusion method was used. Sclerotinia homoeocarpa and Rhizoctonia solani were cultured in YPD media at 25° C. at 80 rpm for 3 days. Previously sterilized Potato Dextrose Agar (PDA) was melted, allowed to cool to 50° C., mixed with S. homoeocarpa culture or R. solani culture at the ratio of 1:25 (v/v), then the inoculated PDA was poured into Petri plates (150 mm×15 mm) and allowed to completely solidify. Holes were created into the agar using sterile Pasteur pipettes and the plugs were removed using a sterilized wire loop. In parallel, bacteria from the maize endophyte library were cultured in LB media and allowed to grow overnight at 37° C. with shaking at 250 rpm. The OD595 of the growing endophytes was adjusted to 0.4 to 0.6. Thirty microliters from each endophyte culture was applied in parallel to the S. homoeocarpa or R. solani inoculated plates in triplicate. Plates were incubated at 25° C. for 3-5 days and zones of inhibition of fungal growth were measured and recorded. All endophytes associated with a fungal zone of inhibition were selected for further experiments.

2. Methodology to Screen for Resistance to S. homoeocarpa and R. solani in Creeping Bentgrass or Annual Ryegrass Seeds in Glass Tubes

Preparation of endophyte inoculum: Maize endophytes were allowed to grow overnight in LB medium at 37° C. with shaking at 250 rpm. Cells were collected by centrifugation for 10 min at 4000 rpm, washed twice in 10 mM tris HCl (pH 7), suspended in 10 mM tris HCl (pH 7) to OD595=0.5. Five hundred microliters of each bacterial suspension was diluted in 5 ml of 9.3% PVP aqueous solution (P-5288, Sigma, USA) in 15 ml Falcon tubes. These endophyte-PVP mixtures were used to coat turfgrass seeds.

Surface sterilization of turfgrass seeds: Creeping bentgrass seeds and annual ryegrass seeds were surface sterilized by washing for 1 min with 70% ethanol then for 20 min with bleach and finally washed 6 times with water.

Coating of turfgrass seeds: Approximately 30 annual ryegrass seeds or 70 surface sterilized creeping bentgrass seeds were added to each endophyte-PVP mixture (5 ml) and coated for 1 hour on a low speed rotary shaker.

Growing Turfgrass: A sand or Phytagel based modified MS medium was used to germinate and grow turfgrass. For the sand treatment, 15 g of sand (non calcareous granitic, dry top dressing sand, Hutcheson Sand & Mixes Company, Huntsville, ON, Canada) was mixed with 4 ml of double distilled water, added into sterile 15 cm×25 mm glass tubes (tubes: C5916, Sigma, USA), covered (caps, C5791, Sigma, USA) and autoclaved. The MS medium (pH 5.8) consisted of (per L): half-strength modified basal salt MS (M571, Phytotechnology Laboratories, USA), 250 μl of nicotinic acid (1 mg/ml), 500 μl of pyridoxine HCl (0.5 mg/ml), 5 ml of thiamine HCl (100 mg/l), 500 μl of glycine (2 mg/ml), 2 g Phytagel (P8169, Sigma, USA) in double distilled water. To help solidify Phytagel, 0.166 g/l of CaCl2 was added along with 90 mg/l MgSO4. Fifteen ml of the sterile MS medium were again aliquoted into sterile 15 cm×25 mm covered glass tubes. Per tube (sand or MS Phytagel), seven endophyte-coated annual ryegrass seeds or 20 endophyte-coated creeping bentgrass seeds were placed on the media surface. There were 3 to 5 replicate tubes per treatment, randomly distributed in the growth chamber. Seeds were allowed to germinate in the dark for 7 days at room temperature then moved to a growth chamber (BTC-60, Enconair, Winnipeg, Canada) and grown under the following conditions: 25° C. constant, 16 hours of cool white fluorescent light (Philips F72T8/TL841/HO 65W, 115-145 μmol m−2 s−1 measured using a Quantum Meter model BQM, Apogee Instruments Inc, Logan, Utah, USA). Seeds coated with PVP without any endophytes were used as the negative control.

Reinoculation of turfgrass: On the 15th day of turfgrass growth, each glass tube was re-inoculated with 100 μl of endophyte cell suspension (OD595=0.5 in 10 mM tris HCl, pH 7) to seed surfaces. For control plants, 100 μl of 10 mM tris HCl (pH 7) were used.

Inoculation with Sclerotinia homoeocarpa or Rhizoctonia solani: S. homoeocarpa and R. solani pathogen strains were grown on PDA for 5 days at 28° C. Fungal inoculation discs from this media were made using a 1 cm wide tube (previously autoclaved) and then one disc was dropped into each tube of turfgrass after 10 days of turfgrass growth. Seeds coated with PVP without any endophytes added, and inoculated with S. homoeocarpa or R. solani, were used as a positive control. Seeds coated with PVP without any endophytes added, and not inoculated with S. homoeocarpa or R. solani, were used as a negative control. Tubes were recorded for infection intensity 3-5 weeks later.

### 3. Greenhouse Trial Methodology

Cupcuts (12 cm diameter, 9 cm deep) were harvested using a golf cup cutter from fields of creeping bentgrass (cultivar Mackenzie, grown on 80:20 sand:peat, according to USGA specification) taken from the Guelph Turfgrass Institute (Guelph, ON Canada) and placed into pots (12 cm diameter). Pots were incubated in a greenhouse at 23° C. day/18° C. night, 16-hour daylight, with a mixture of high pressure sodium lights with fixtures that are rated at 400W (400-600 μmol m−2 s−1 PPFD at pot level) Light was measured using a quantum meter (model QMSS, Apogee Instruments Inc, Logan, Utah, USA). There were five bacterial treatments: the two antifungal candidates, a negative control bacteria (Zea endophyte with 99% identity to Pantoea agglomerans, clone 3A1), a negative control without bacteria and a control with the maximum recommended dose of fungicide (51 ml/100 m2, Banner Maxx, Propiconazole 14.3%, 60207-90-1, Syngenta Crop Protection, Canada) For each endophyte treatment, there were 4 replicate cupcuts inoculated with S. homoeocarpa and 4 controls (not inoculated with S. homoeocarpa). Controls that were infected with an endophyte but not inoculated with the fungal pathogen were used to measure for any pathogenicity caused by the endophytes.

To prepare the bacterial endophyte inoculants, each bacterium was cultured for 1-2 nights in 200 ml of LB in 500 ml flasks with shaking at 250 rpm at 37° C. (control, Pantoea agglomerans) or 30° C. (candidate anti-fungal endophytes). Cells were collected by centrifugation, washed in 10 mM Tris HCl pH 7, resuspended in 10 mM Tris HCl pH 7 to OD595=0.3.

On the third day after cupcuts had been transplanted into the greenhouse, each pot received 5 ml of bacterial suspension in the form of a top spray. Control pots were sprayed with 5 ml of buffer (10 mM Tris HCl, pH 7). The pots were randomized in the greenhouse, clipped as needed, and re-sprayed with endophytic bacteria one week later. Prior to fungal infection, plants were either irrigated daily with a top spray of deionized water (Trial 1) or pots were placed on a misting bench (Trial 2). Two days after the second bacterial spray, 0.2 g of S. homoeocarpa (coated onto Kentucky bluegrass seed as carrier) was sprinkled in each pot.

The pathogen inoculums were prepared by autoclaving 200 g of Kentucky bluegrass seeds, adding 100 ml of sterile water, which was then mixed, allowed to stand overnight, and mixed with ½ plate of S. homoeocarpa grown on PDA plates (100 mm×15 mm agar, cut into small pieces). The inoculum seeds were then covered and incubated for 2-3 weeks, spread out on newspaper to air dry, passed through a 2 mm sieve to break clumps, placed into plastic bags and refrigerated.

Following inoculation of the fungal pathogen, turf pots were then covered with plastic bags to help maintain high humidity to favor disease development. Pots were observed daily for disease development. Plant health was measured using qualitative visual scoring (disease index); quantitative scoring using disease imaging software from picture scans; and chlorophyll measurements (Aeldscout CM1000 chlorophyll meter, model no. 2950, Spectrum Technologies Inc, Aurora, Ill., USA).

### 4. Methodology to Identify the Gene(s) Responsible for the Antifungal Activity

Preparation of competent cells from endophyte A12: Endophyte A12 was cultured in LB media and incubated overnight at 37° C. with shaking at 250 rpm. The overnight culture was used to inoculate 0.5 L of LB in the ratio 1:100 and incubated at 37° C. with shaking at 250 rpm. The OD was measured every hour. When the OD reached 0.3-0.4, the flask was chilled on ice before centrifugation at 4000×g for 10 min at 4° C. The pellet was washed twice in half volume of ice cold water, centrifuged as above, resuspended in 10 ml of ice cold 10% glycerol, centrifuged, resuspended in 2 ml of ice cold 10% glycerol. The final suspension was aliquoted into 40 μl volume per tube and quick frozen in liquid nitrogen. The tubes were stored at −80° C.

Tn5 Mutagenesis: The EZ-Tn5<R6Kγori/KAN-2>Tnp Transposome™ Kit was used (TSM08KR, Epicentre, USA). One μl of Transposome was electroporated into 40 μl of A12 competent cells. Electroporated cells were immediately recovered in 1 ml of LB media and transferred to a tube and incubated on a shaker incubator at 37° C. for 1 hour at 250 rpm. One hundred microliters of undiluted cells were plated on LB plates supplemented with 25 μg/ml kanamycin. Plates were incubated at 37° C. and colonies were screened for in vitro loss of antifungal activity (see below).

Mutant screen: Tn5 insertions were screened for loss of the zone of inhibition of S. homoeocarpa growth using the agar diffusion method. Colonies with Tn5 insertions recovered on LB plates were cultured in LB media overnight at 37° C. with shaking at 250 rpm. S. homoeocarpa was cultured in YPD media 3 days before the screen at 25° C. at 80 rpm. Potato dextrose agar was melted, allowed to cool to 50° C., mixed with S. homoeocarpa culture at the ratio of 1:25 (vol/vol); the PDA mixed with S. homoeocarpa culture was poured into plates and allowed to completely solidify. Holes were created into agar using a sterile Pasteur pipette and the resulting agar plugs were removed using a sterilized wire loop. The ODs of the growing Tn5-containing cultures were measured and only those giving ODs similar to the wild type A12 were used (0.3-0.5). Thirty microliters from each Tn5 insertion culture were applied into an agar hole in the S. homoeocarpa inoculated plates in triplicate. Plates were incubated at 25° C. for 5 days and fungal growth inhibition zones were measured and recorded. In total, ˜3000 unique Tn5-containing cultures were screened in three replicates. A Tn5 insertion that gave no inhibition zones or gave inhibition zones smaller than wild type were recorded as candidate mutants (FIG. 10).

In planta confirmation of loss of antifungal activity: The same protocol used for the in planta screen of antifungal activity on phytagel based medium using creeping bentgrass seeds was used (see above).

Plasmid rescue and BLAST analysis: Candidate mutants were cultured in LB supplemented with 25 μg/ml kanamycin overnight at 37° C. with shaking at 250 rpm. Genomic DNA was extracted using a Bacterial Genomic DNA Isolation Kit (#17900, Norgen Biotek, Canada). Five hundred nanograms to one microgram of DNA was digested using BamHI (#15201023, Invitrogen, USA) at 37° C. for 1 hour, then the reaction mixture was purified using illustra GFX PCR DNA and Gel Band Purification Kits (#28-9034-70, GE Healthcare, USA), and self-ligated using ExpressLink™ T4 DNA Ligase (A13726, Invitrogen, USA) for 1 hour at room temperature. The reaction mixture was purified again using illustra GFX PCR DNA and Gel Band Purification Kits. Three microliters of the ligation mixture were electroporated into TransforMax™ EC100D™ pir-116 Electrocompetent E. coli (EC6P095H, Epicentre, USA). Electrocompetent E. coli cells were recovered in 1 ml of LB and incubated on a shaker at 37° C. and 250 rpm for 1 hour. Recovered DH5a cells were plated on LB plates supplemented with 25 μg/ml kanamycin, and plates were incubated at 37° C. Plasmid DNA was extracted using QIAprep Spin Miniprep Kit (#27106, Qiagen, USA) from recovered colonies and submitted for sequencing to the University of Guelph Genomics Facility using the following primers (supplied in the kit): Forward Primer, KAN-2 FP-1 (5′-ACCTACAACAAAGCTCTCATCAACC-3′), and Reverse Primer, R6KAN-2 RP-1 (5′-CTACCCTGTGGAACACCTACATCT-3′). Amplicon sequences were analyzed using BLAST analysis.

### 5. Characterization of In Vitro Interactions Between Endophyte and Pathogen

The in vitro interactions between endophyte 3A12 and S. homoeocarpa was visualized on a microscope slide. S. homoeocarpa was cultured in YPD media for 2-3 days at 25° C. at 80 rpm. A12 was cultured in liquid LB overnight at 37° C. with shaking at 250 rpm. One ml of PDA was spread on a sterilize glass slide placed in a Petri dish and allowed to solidify. A fragment of S. homoeocarpa was applied to the center of the slide, then 20 μl of A12 culture was applied to one side of the S. homoeocarpa, and on the other side 20 μl of LB media was applied. Slides were incubated at 25° C. overnight. Slides were stained using Neutral Red (#N6264, Sigma, USA) and Evans blue (#206334, Sigma, USA) then examined using light microscopy (B1372, Axiophot, Zeiss, Germany) and Northern Eclipse software.

### 6. In Vitro Screen of 3A12 and 3C11 Antifungal Activity Against Different Crop Fungal Pathogens

Using the agar diffusion method, the target specificity of the antifungal activity of endophyte A12 was tested against a library of diverse crop pathogenic fungi (Alternaria alternata, Alternaria arborescens, Aspergillus niger, Davidiella tassiana, Diplodia pinea, Diplodia seriata, Epicoccum nigrum, Fusarium avenaceum, Fusarium lateritium, Fusarium sporotrichioides, Gibberella avenacea, Nigrospora oryzae, Nigrospora sphaerica, Paraconiothyrium brasiliense, Penicillium commune, Penicillium expansum, Penicillium olsonii, Trichoderma). 3A12 and 3C11 were cultured in LB media and allowed to grow overnight at 37° C. with shaking at 250 rpm. The different fungi were cultured in YPD media for 3 days before the screen at 25° C. at 80 rpm. Previously sterilized PDA was melted, allowed to cool to 50° C., mixed with each fungal culture, poured into plates and allowed to completely solidify. Holes were created into the agar using a sterile Wessermann tube, and the resulting agar plugs were removed using a sterilized wire loop. Thirty microliters of the endophyte culture (OD595=0.8) was applied in each hole in triplicate for each fungus. Plates were incubated at 25° C. for 3-5 days and inhibition zones were measured and recorded. Endophytic bacteria (3C8) was used as a negative control. Both experiments were independently repeated.

### Example 2

Two additional endophytes that exhibited antifungal activity were identified in vitro using the agar diffusion method as described in Example 1. FIG. 12B shows the activity of endophytes 3H8 and 4H12 against S. homeocarpa along with endophytes 3A12, 3C11 and 5C9. Taxonomic identification of the additional endophytes was done by 16S rRNA sequencing. Endophyte 3H8 most closely resembled Bacillus sp (99%) and 4H12 resembled Paenibacillus sp (99%) (FIG. 12C). Respectively, 3A12, 3C11 and 3H8 originated from seeds of: an ancient Mexican maize landrace (Zea mays ssp mays wild Central American perennial maize (Zea diploperennis); and a modern commercial hybrid (Zea mays ssp mays, Pioneer 3751). Endophyte 4H12 originated from roots of the Pioneer 3751 hybrid, while 5C9 originated from roots of the extant wild ancestor of modern maize (Zea mays ssp parviglumis) (FIG. 12C).

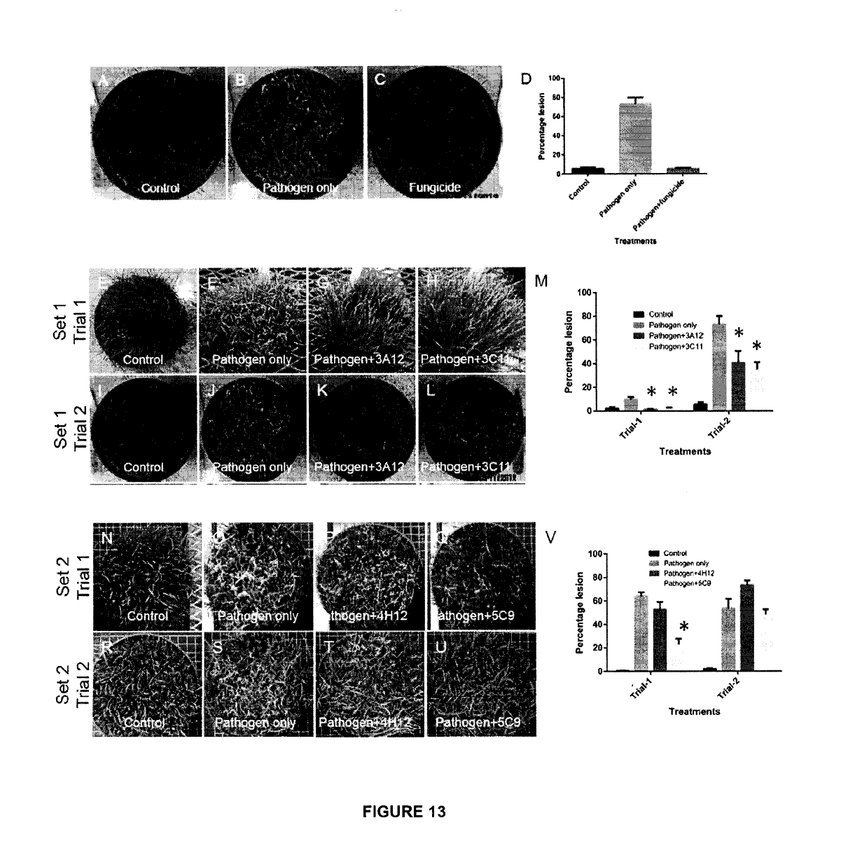

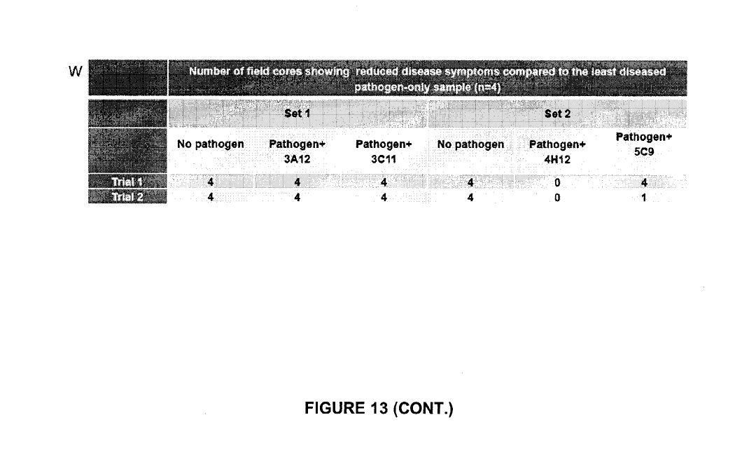

The antifungal endophytes were tested for their ability to suppress dollar spot disease in replicated greenhouse trials. To determine the reliability of Assess software for disease scoring, positive and negative controls were first evaluated (FIG. 13A-D). Assess software was effective at pinpointing diseased tissues (data not shown).

After validating the disease scoring methodology, the endophytes were applied as sprays on creeping bentgrass field cores prior to inoculation with S. homoeocarpa (FIG. 13). Endophyte (3H8) was excluded from greenhouse testing, as it failed to suppress the disease in a pre-trial involving test tubes (data not shown). Endophytes 3A12 and 3C11 were found to suppress mean dollar spot disease symptoms in two independent trials (FIG. 13E-M). Endophyte 5C9 was found to suppress mean dollar spot disease symptoms in only one of the trials. Endophyte 4H12 did not show disease suppression in either trial (FIG. 13N-V). The field cores showed pot to pot disease variation; however, when evaluated based on a threshold of disease symptoms (defined as the pathogen-only sample with the lowest percentage lesions), endophytes 3A12, 3C11 and 5C9 consistently caused at least one pathogen-exposed field core to be healthier in both trials. None of the 4H12 treated field cores was healthier than the least diseased pathogen-only sample (FIG. 13W).

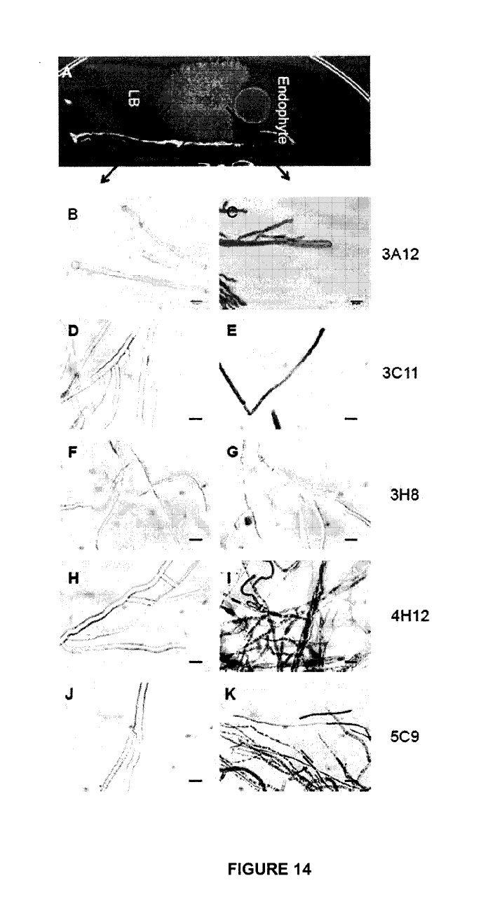

To help understand the anti-fungal mode of action of the candidate endophytes, they were grown side by side with S. homoeocarpa on microscope slides then stained with Evans blue, which stains mycelia blue when dead (FIG. 14A).

None of the fungal mycelia stained blue on the side exposed only to LB media (control) (FIGS. 14B, D, H and J) but they stained blue when in contact with endophytes 3A12, 3C11, 4H12 and 5C9 indicating mycelial death (FIGS. 14C, E, I and K); endophyte 3H8 was the exception (FIGS. 14F and G). Endophytes 3A12, 3C11, 4H12 and 5C9 therefore exhibit fungicidal activity against S. homoeocarpa in vitro, whereas 3H8 may be fungistatic.

### Example 3

Additional testing was performed using the candidate endophytes identified in Examples 1 and 2 for antifungal activity using Rhizoctonia solani.

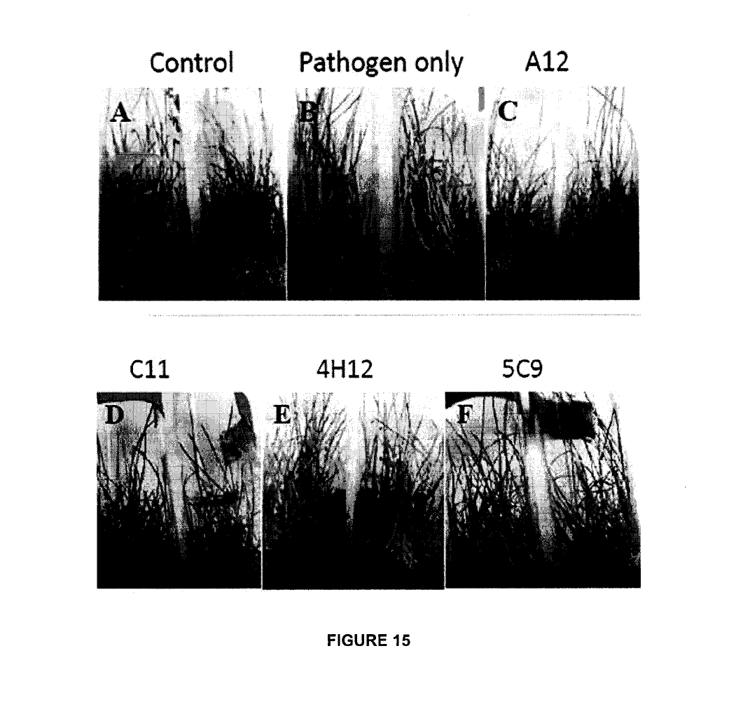

As shown in FIG. 15, in planta screening of antifungal activity in creeping bentgrass demonstrated that endophytes A12, C11, 4H12 and 5C9 each exhibited antifungal activity and reduced the incidence of disease relative to creeping bentgrass treated with pathogen (R. solani) only.

To further characterize the anti-fungal mode of action of the endophytes, they were grown side by side with R. solani on microscope slides then stained with Evans blue, which stains mycelia blue when dead.

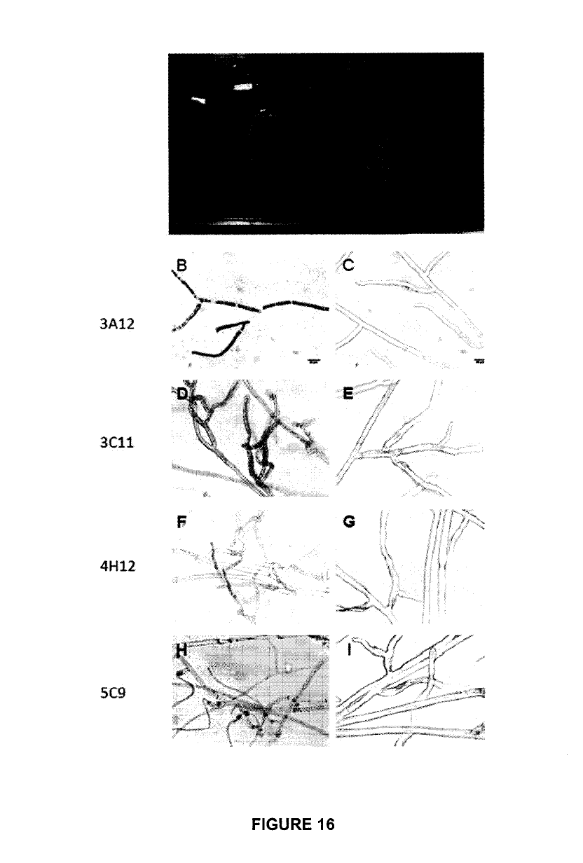

None of the fungal mycelia stained blue on the side exposed only to LB media (control) (FIGS. 16C, E, G and I) but they stained blue when in contact with endophytes 3A12, 3C11, 4H12 and 5C9 indicating mycelial death (FIGS. 16B, D, F and H).

Mutants of endophyte A12 generated using Tn5 transposon mutagenesis identified in Table 3 were also tested in vitro for loss of antifungal activity against R. solani. As shown in FIG. 17B, a number of endophytes tested resulted in a zone of inhibition in vitro. Further testing in planta confirmed the loss of antifugal activity in mutants C3, B8, 2C11, 2D1, C2, 2C7, 2C4 and 2D2.

### Example 4

### Results

### Identification of the Gene(s) Responsible for the Fungicidal Activity

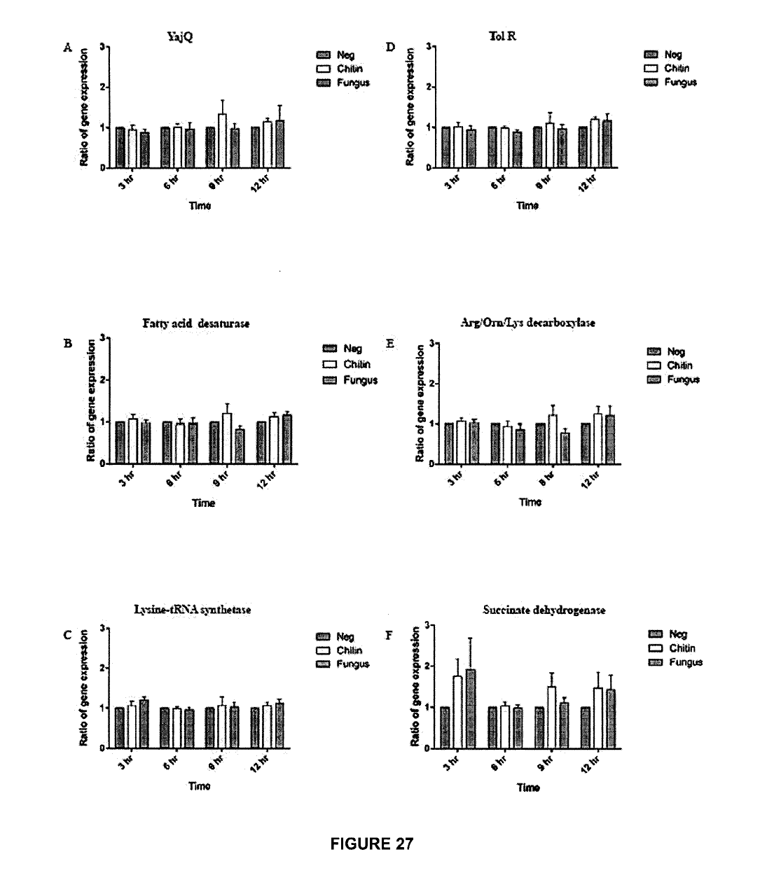

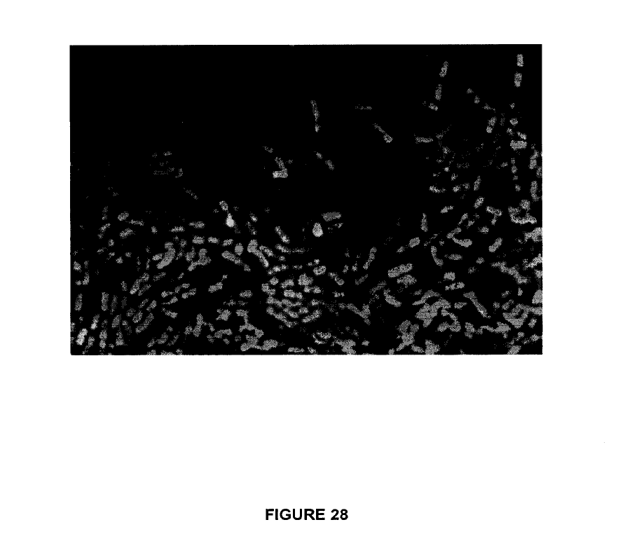

To identify the endophytic genes responsible for its fungicidal activity, ˜3000 independent Tn5 insertions were screened in vitro (in triplicate) for loss of antifungal activity against S. homoeocarpa (FIG. 20A-B). This screen resulted in 13 candidate insertions (mutants) that showed loss or reduction in the diameter of inhibition zones of S. homoeocarpa growth (FIG. 20C). The 13 candidate mutations were confirmed to lose the antifungal activity in planta (FIG. 20D-R), though m2D1 demonstrated incomplete loss of anti-fungal activity (⅔ tubes, FIG. 20Q). The sequences flanking the Tn5 insertions for 11 of the 13 candidate genes were successfully identified following plasmid rescue using the reference genome sequence of strain 3A12 [17]. The retrieved gene sequences were further analyzed via the use of BLASTN searches against Genbank at NCBI. Some genes were isolated multiple times, narrowing the list to six unique genes required for anti-fungal activity. The genes were predicted to encode: (1) a ToIR protein, (2) a YajQ protein, (3) a hypothetical protein identified as lysine-tRNA synthetase in the Conserved Domain Database, (4) arginine/ornithine/lysine decarboxylase, (5) a fatty acid desaturase, and (6) a succinate dehydrogenase (Table 5). Testing for the ability of S. homoeocarpa or chitin to induce candidate antifungal genes did not provide evidence for significant induction or repression by these potential elicitors in vitro (FIG. 27).

TABLE 5
Summary of candidate genes

| | | | | | E-value/ |
|---|---|---|---|---|---|
| Candidate | | | BLAST against | | Nucleotide |
| mutant | Position | E-value | genome sequence | BLASTN | identity |
| m1B12-f | 6.1 | 0 | YajQ protein | Burkholderia | 0/99% |
| | 115949-114984 | | | gladioli | |
| | | | | hypothetical protein | |
| m1B12-r | 6.1 | 0 | Long-chain-fatty- | Burkholderia | 0/99% |
| | 115949-114984 | | acid--CoA ligase | gladioli | |
| | | | (EC 6.2.1.3) | AMP-binding | |
| | | | | enzyme family | |
| | | | | protein | |
| m1C1-f | 6.1 | 2e−61 | Fatty acid | Burkholderia | 0/99% |
| m2C12-f | 174416-174542 | | desaturase (EC | gladioli | |
| | | | 1.14.19.1); Delta-9 | fatty acid | |
| | | | fatty acid | desaturase family | |
| | | | desaturase (EC | protein | |
| | | | 1.14.19.1) | | |
| m1C1-r | 6.1 | 6e−74 | Fatty acid | Burkholderia | 0/99% |
| m2C12-r | 174542-174404 | | desaturase (EC | gladioli | |
| | | | 1.14.19.1); Delta-9 | fatty acid | |
| | | | fatty acid | desaturase family | |
| | | | desaturase (EC | protein | |
| | | | 1.14.19.1) | | |
| m1B6-f | 34.1 | 0 | Mobile element | Burkholderia | 4e−126/98% |
| | 90533-89625 | | protein | glumae | |
| | | | | transposase | |
| | | | | IS3/IS911 | |
| m1B6-r | 34.1 | 0 | hypothetical protein | No significant | |
| | 88781-89713 | | | similarity | |
| m1C3-f | 14.1 | 0 | Mobile element | Burkholderia | 0/97% |
| m2D1-f | 1182-555 | | protein | glumae | |
| | | | | integrase core | |
| | | | | domain protein | |
| m1C3-r | 34.1 | 0 | hypothetical protein | No significant | |
| | 88693-89652 | | | similarity | |
| m2D1-r | 87404-88311 | | lysine-tRNA synthetase | | |
| m2B10-f | 15.1 | 0 | Hypothetical protein | Burkholderia | 2e−149/99% |
| m2C4-f | 98354-99278 | | | gladioli | |
| m2C11-f | | | | beta-eliminating | |
| | | | | lyase family protein | |
| m2B10-r | 15.1 | 0 | ToIR protein | Burkholderia | 0/99% |
| m2C4-r | 102260-101339 | | | gladioli | |
| m2C11-r | | | | ToIR protein/ToIA | |
| | | | | protein | |
| m2D2-f | 75.1 | 6e−37 | Arginine | Burkholderia | 0/99% |
| | 21871-21947 | | decarboxylase (EC | gladioli | |
| | | | 4.1.1.19); Ornithine | orn/Lys/Arg | |
| | | | decarboxylase (EC | decarboxylase, N- | |
| | | | 4.1.1.17); Lysine | terminal domain | |
| | | | decarboxylase (EC | protein | |
| | | | 4.1.1.18) | | |
| m2D2-r | 75.1 | 5e−47 | Arginine | Burkholderia | 0/99% |
| | 21947-21854 | | decarboxylase (EC | gladioli | |
| | | | 4.1.1.19); Ornithine | orn/Lys/Arg | |
| | | | decarboxylase (EC | decarboxylase, N- | |
| | | | 4.1.1.17); Lysine | terminal domain | |
| | | | decarboxylase (EC | protein | |
| | | | 4.1.1.18) | | |
| m1C2-f | 7.1 | 0 | Succinate | Burkholderia | 0/99% |
| | 157563-156790 | | dehydrogenase | gladioli | |
| | | | flavoprotein subunit | succinate | |
| | | | (EC 1.3.99.1) | dehydrogenase, | |
| | | | | flavoprotein subunit | |
| m1C2-r | 7.1 | 0 | Succinate | Burkholderia | 0/99% |
| | 156790-157590 | | dehydrogenase | gladioli | |
| | | | flavoprotein subunit | succinate | |
| | | | (EC 1.3.99.1) | dehydrogenase, | |
| | | | | flavoprotein subunit | |

### Effect of Mutants on Motility

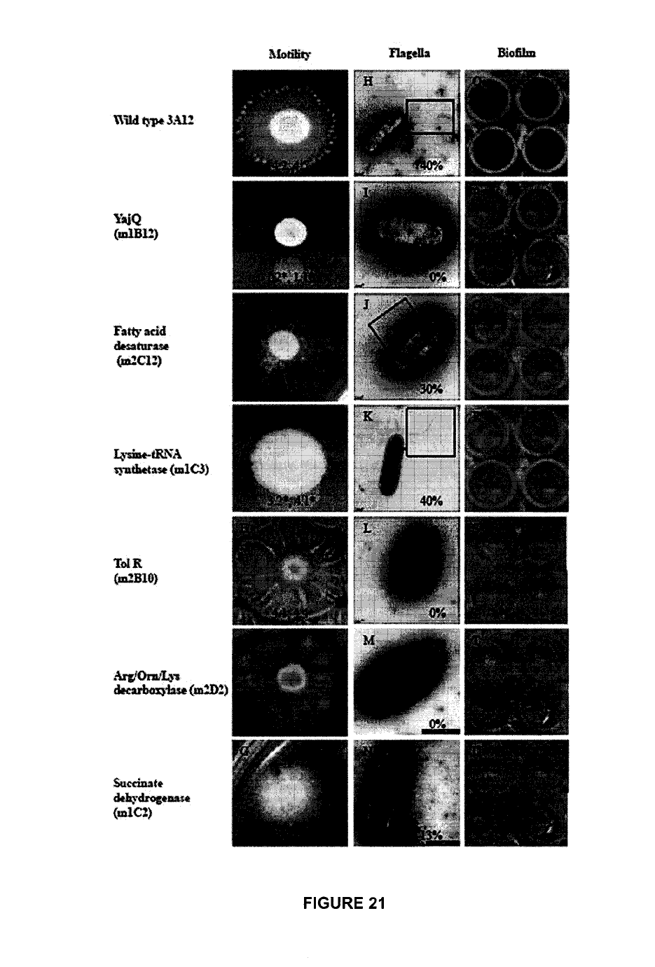

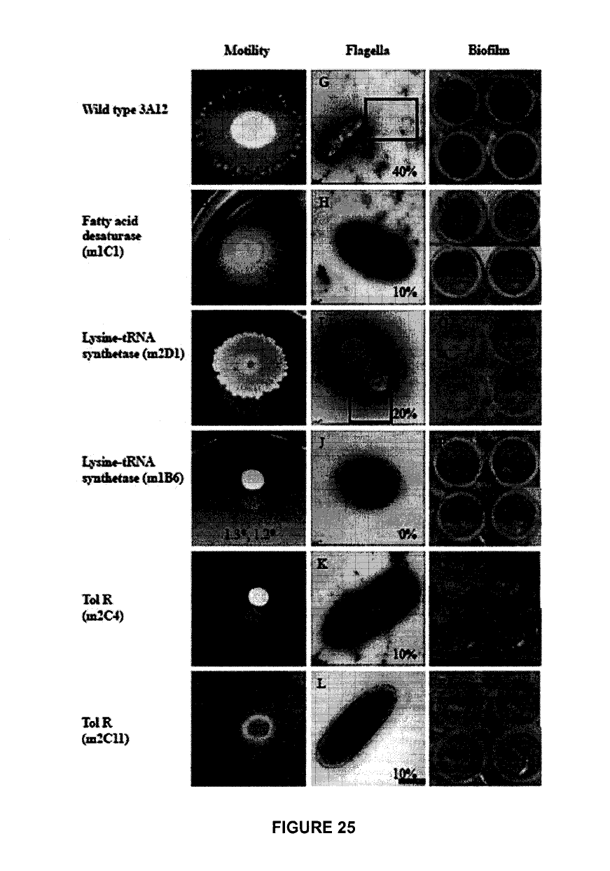

The motility of candidate mutants was quantified by measuring the diameters of colonies on low percentage agar plates [20]. The colony diameters of mutant m1B6, m1B12, m1C1, m1C2, m2C4, m1C3 were significantly different from that of wild type strain 3A12 in two independent trials. Mutant 2C12 and m2C11 were significantly different in one trial only while colony diameters of mutant m2D2, m2D1 and m2B10 were not significantly different in two independent trials (FIG. 21A-G, Table 6 and FIG. 25A-F).

TABLE 6
Summary of functions of candidate mutants

| | In vitro | In planta | | TEM % | |
|---|---|---|---|---|---|
| Mutant | antifungal | antifungal | Motility | flagella | Biofilm |
| Wild Type 3A12 | + | + | ++ | +++ | ++ |
| m1B12 | − | − | −− | − | −− |
| (YajQ protein) | | | | | |
| m1C1 | − | − | −− | + | −− |
| (Fatty acid | | | | | |
| desaturase) | | | | | |
| m2C12 | − | − | +− | ++ | −− |
| (Fatty acid | | | | | |
| desaturase) | | | | | |
| m1B6 | − | − | −− | − | −− |
| (Lysine tRNA | | | | | |
| synthetase) | | | | | |
| m1C3 | − | − | −− | +++ | −− |
| (Lysine tRNA | | | | | |
| synthetase) | | | | | |
| m2D1 | − | − | ++ | ++ | −− |
| (Lysine tRNA | | | | | |
| synthetase) | | | | | |
| m2C4 (TolR) | − | − | −− | + | −− |
| m2C11 (TolR) | − | − | +− | + | −− |
| m2B10 (TolR) | − | − | ++ | − | −− |
| m2D2 | − | − | ++ | − | −− |
| (Arginine/ | | | | | |
| Ornithine/Lysine | | | | | |
| decarboxylase) | | | | | |
| m1C2 | − | − | −− | + | −− |
| (Succinate | | | | | |
| dehydrogenase) | | | | | |

### Effect of Mutants on Flagella Number

Examining wild type 3A12 using transmission electron microscopy (TEM) showed that 40% of examined cells possess flagella. Mutants m1C1, m2C11, m2C4, m1C2, m2D1, m2C12 and m1C3 also possessed flagella in 10%-40% of examined cells, as indicated, while mutants m2B10, m1B6, m1B12, 2D2 were found to have no flagella on any of the observed cells (n=10-15) (FIG. 21H-N, Table 6 and FIG. 25G-L).

### Effect of Mutants on Biofilm Formation

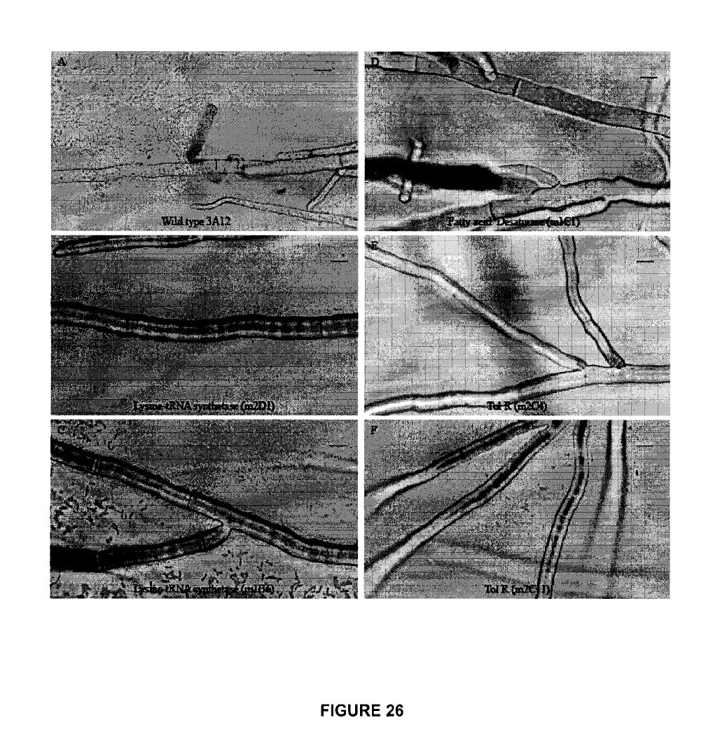

The candidate mutants were assayed for alterations in biofilm formation by quantifying cells that bind to 96-well plates following staining with crystal violet which absorbs at 570 nm [21]. Wild type strain 3A12 showed intense crystal violet staining suggestive of biofilm formation (FIG. 21O), which was confirmed independently using FilmTracer™ SYPRO® Ruby Biofilm Matrix Stain (F10318, Invitrogen) (FIG. 26). By contrast, the absorbance A_{570 nm} readings from all 11 candidate mutants were significantly different than those of strain 3A12 (FIG. 21O-U, Table 6 and FIG. 25M-R). These results suggest that all the candidate mutants have impaired biofilm formation compared to wild type.

Effect of Mutants on Swarming, Adhesion and Colony Formation Around their Fungal Target

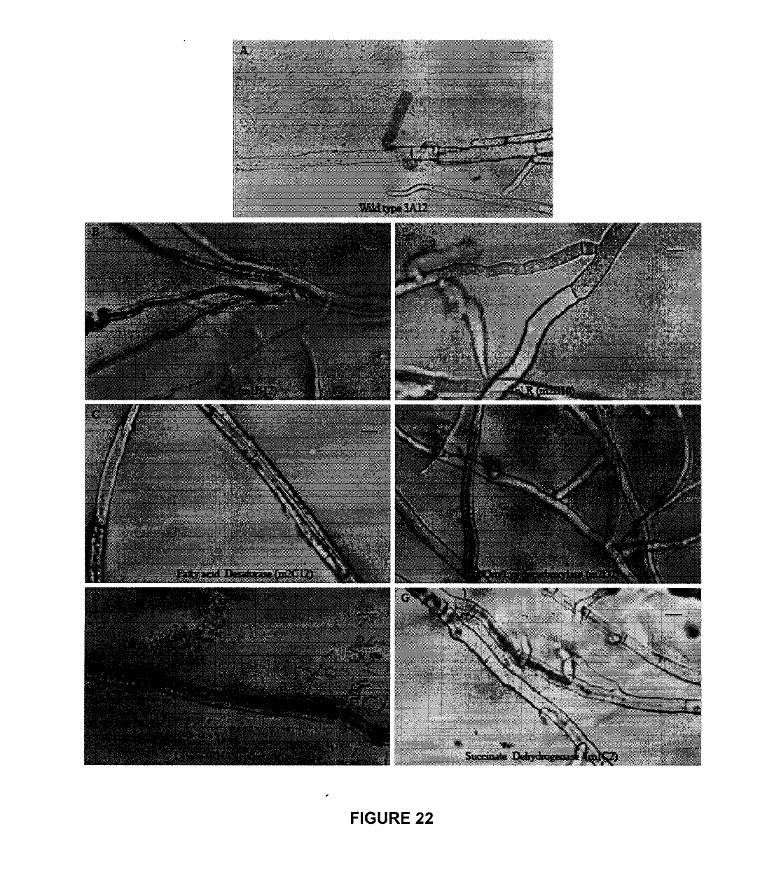

When wild type strain 3A12 was spotted at a distance from S. homoeocarpa mycelia, bacteria were observed to swarm, adhere to and form microcolonies around its fungal target (FIG. 22A). By contrast, the majority of the mutants (m1B12, m1C1, m2C12, m2B10, m2C4, m2C11, m1C2 and m2D2) showed loss of these traits, while mutants ml B6, m1C3 and m2D1 were still able to swarm and adhere to the target fungus but showed reduced microcolony formation (FIG. 22 and FIG. 26).

### Candidate Gene Predictions and Assay for Chitinase Activity

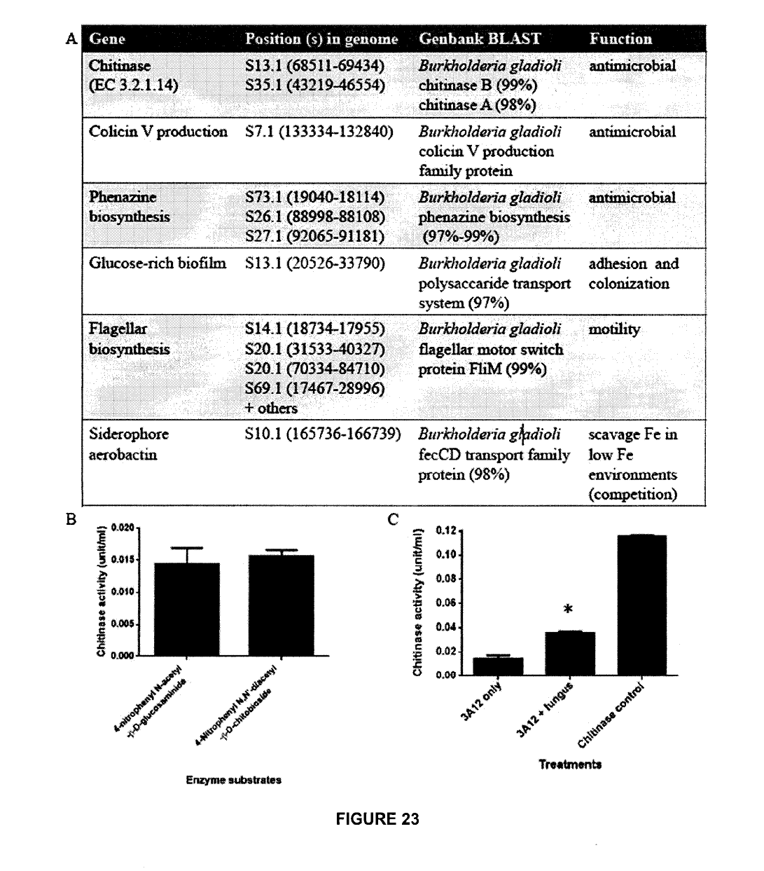

RAST-server based bioinformatic mining of the 3A12 genome [17] revealed the presence of several additional candidate anti-fungal genes including chitinase (FIG. 23A). A few of these genes were present in the genome as multiple copies. Strain 3A12 was confirmed to have chitinase activity using two different enzyme substrates, 4-nitrophenyl N,N′-diacetyl-β-D-chitobioside and 4-nitrophenyl N-acetyl-β-D-glucosaminide (FIG. 23B). The chitinase activity was tested when strain 3A12 was inoculated with S. homoeocarpa using 4-nitrophenyl N-acetyl-β-D-glucosaminide as a substrate. The chitinase activity was induced by S. homoeocarpa (FIG. 23C).

### Discussion

Strain 3A12 has fungicidal activity; not only against S. homoeocarpa, but a broad spectrum of plant-associated fungi endophytes. The strain retained its endophytic ability when moved from its original host (Zea) to a grass relative, creeping bentgrass. A mutagenesis screen revealed that several endophytic genes were required for the anti-fungal activity of strain 3A12 in vitro and in planta. The candidate antifungal genes were found to encode putative orthologs of the receptor YajQ, a fatty acid desaturase, lysine-tRNA synthetase, toIR, arginine/ornithine/lysine decarboxylase and succinate dehydrogenase (Table 5). Surprisingly, these mutations in apparently diverse genes caused a similar suite of mutant phenotypes, including reduced swarming, loss of flagella, reduced biofilm formation, reduced attachment and microcolony formation at the target fungus (FIGS. 21, 22, 25, 26 and Table 6), suggesting that the genes may belong to the same genetic pathway or network.

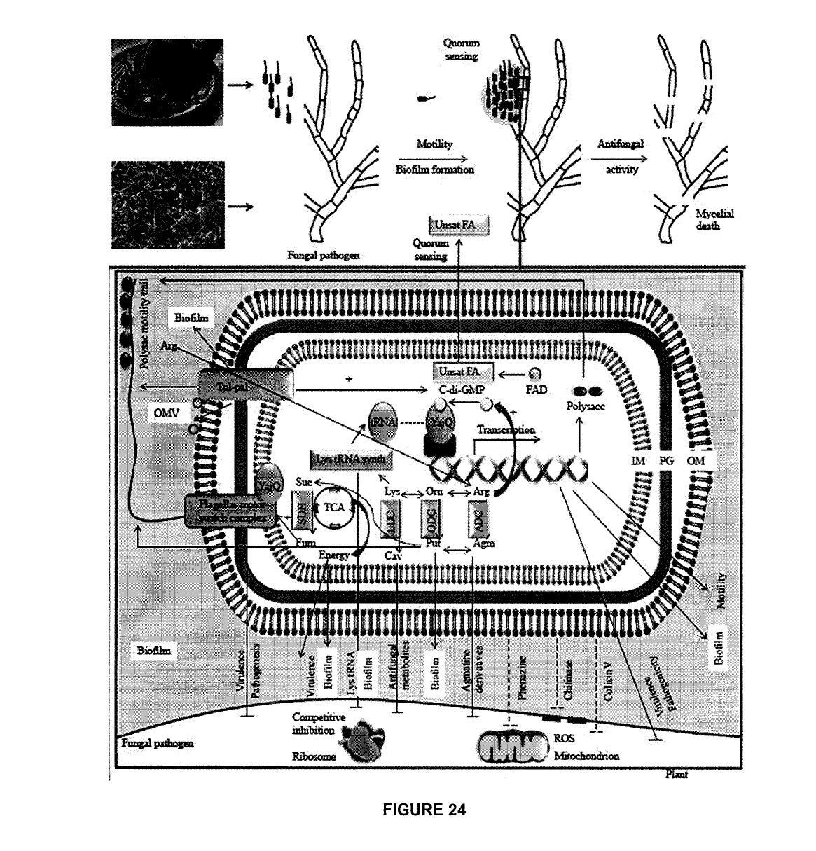

FIG. 24 shows a model by which endophyte 3A12 suppresses fungal pathogen(s). Following pathogen sensing, the endophyte swarms towards the target fungal pathogen where it contributes to micro-colony formation around the fungal pathogen; as quorum is achieved, unsaturated fatty acids cross the membrane to trigger the secondary messenger c-di-GMP which binds to its receptor YajQ to affect the expression of genes involved in virulence, biofilm formation and motility—the latter promoted by synthesis and secretion of polysaccharides that help guide the flagella. YajQ then interacts with lysine-tRNA, which may then be converted into a nucleotide antibiotic to disrupt ribosomal translation in the pathogen target. The c-di-GMP activity may also be promoted by the Tol-pal system which maintains the integrity of the outer membrane, transports virulence factors, and promotes motility and biofilm formation. Tol-pal may also uptake arginine which can subsequently increase c-di-GMP levels. Once inside, arginine may be converted to ornithine. Ornithine/arginine decarboxylase may then convert these molecules to agmatine which subsequently may produce anti-fungal derivatives, and to putrescine, which is essential for swarming. Ornithine may also serve as a metabolic precursor for lysine as well as succinate. Succinate dehydrogenase is part of the TCA cycle which provides the energy required for virulence and biofilm formation. Succinate dehydrogenase converts succinate to fumarate, which subsequently controls the flagella switch of direction of rotation, and thus may be necessary for the motility of strain 3A12 towards its pathogen target. The flagellar motor switch complex binds to the c-di-GMP receptor, in this case perhaps YajQ, to complete the regulon. Other antifungal compounds may be involved in the antifungal activity including chitinase, phenazines and colicinV.

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents, and patent applications are herein incorporated by reference in their entirety to the same extent as if each individual publication, patent or patent application was specifically and individually indicated to be incorporated by reference in its entirety.

### REFERENCES CITED

1. Campbell-Nelson, K., J. Popko, and G. Jung. 2011. Turf Pathology Report: Managing Dollar Spot with Resistance to DMI Fungicides. University of Massachusetts-Amherst
2. Ellram, A., B. Horgan, and B. Hulke. 2007. Mowing strategies and dew removal to minimize dollar spot on creeping bentgrass. Crop Science 47:2129-2137.
3. Giordano, P. R., J. M. Vargas, T. A. Nikolai, and R. Hammerschmidt. 2012. Why lightweight rolling decreases dollar spot., Golf Course Management
4. Jo, Y.-K., S. W. Chang, M. Boehm, and G. Jung. 2008. Rapid development of fungicide resistance by Sclerotinia homeocarpa on turfgrass. Phytopathology 98:1297-1304.
5. Johnston-Monje, D., W. K. Mousa, G. Lazarovits, and M. N. Raizada. 2012. Impact of Swapping Soils on the Endophytic Bacterial Communities of pre-domesticated, ancient and modern maize. BMC Plant Biol. 2014; 14:233.
6. Johnston-Monje, D., and M. N. Raizada. 2011. Conservation and Diversity of Seed Associated Endophytes in Zea across Boundaries of Evolution, Ethnography and Ecology. PLoS One 6:e20396.
7. Johnston-Monje, D., and M. N. Raizada. 2011. Integration of Biotechnologies—Plant and Endophyte Relationships: Nutrient Management., p. 713-727. In M. Moo-Young (ed.), Comprehensive Biotechnology, Second Edition, vol. 4. Elsevier, Amsterdam.
8. Johnston-Monje, D., and M. N. Raizada. 2013. Surveying diverse Zea seed for populations of bacterial endophytes In F. J. de Bruijn (ed.), Molecular Microbial Ecology of the Rhizosphere, vol. 2. Wiley-Blackwell, Berlin.
9. Landschoot, P. J., and A. S. McNitt. 1997. Effect of nitrogen fertilizers on suppression of dollar spot disease of Agrostis stolonifera L. International Turfgrass Society Research Journal 8:905-911.
10. Mousa, W. K., and M. N. Raizada. 2012. The diversity of anti-pathogenic secondary metabolites produced by fungal endophytes: An interdisciplinary perspective. Submitted to Fungal Diversity.
11. NCDC220. 2012. Biology, Etiology, and Management of Dollar Spot in Turfgrasses http://nimss.umd.edu/homepages/home.cfm?trackID=12176.
12. NCState. 2012. North Caroline State University Turfgrass Extension Website.
13. NTEP. 2012. National Turfgrass Evaluation Program http://www.ntep.orq.
14. Putman, A. I., G. Jung, and J. E. Kaminski. 2010. Geographic distribution of fungicide insensitive Sclerotinia homoeocarpa isolates from golf courses in the northeastern United States. Plant Disease 94:186-195.
15. Williams, D. W., A. J. Powell, P. Vincelli, and C. T. Dougherty. 1996. Dollar spot on bentgrass influenced by displacement of leaf surface moisture, nitrogen, and clipping removal. Crop Science 36:1304-1309.
16. Smith, D. L. and Kerns, J. P. 2010. Dollar Days: Improving the ability to predict dollar spot epidemics. Golf Course Industry Magazine. April 2010.
17. Ettinger C L, Shehata H R, Johnston-Monje D, Raizada M N, Eisen J A. Draft genome sequence of Burkholderia gladioli strain UCD-UG_CHAPALOTE (phylum Proteobacteria). Genome Announcements. 2015; 3(1). doi:10.1128/genomeA.01462-14.
18. Bau, H. J., Y. I. H. Cheng, T. A. Yu, J. S. Yang, and S. D. Yeh. 2003. Broad-spectrum resistance to different geographic strains of Papaya ringspot virus in coat protein gene transgenic papaya. Phytopathology 93:112-20.
19. Mahy, B. W. J. and M. H. V van Regenmortel. 2009. Desk Encyclopedia of Plant and Fungal Virology, Academic Press, pp. 25.
20. Easom C, Clarke D. Motility is required for the competitive fitness of entomopathogenic Photorhabdus luminescens during insect infection. BMC Microbiol. 2008; 8(1):168.
21. Stepanović S, Vuković D, Dakić I, Savić B, \ddot{S}vabić-Vlahović M. A modified microtiter-plate test for quantification of staphylococcal biofilm formation. J Microbiol Methods. 2000; 40(2):175-9.

### Sequences

TABLE 7
Sequences of 16S rRNA of three candidate endophytes

| SEQ ID | Endophyte | |
|---|---|---|
| NO: | name | 16S rRNA |
| 1 | 5 C9 | TTTCCTTAGTAACGTAGCTAACGCGTGAAGTTGACC |
| | | GCCTGGGGAGTACGGTCGCAAGATTAAAACTCAAA |
| | | GGAATTGACGGGGACCCGCACAAGCGGTGGATGA |
| | | TGTGGATTAATTCGATGCAACGCGAAAAACCTTACC |
| | | TACCCTTGACATGGTCGGAATCCTGGAGAGATCTG |
| | | GGAGTGCTCGAAAGAGAACCGATACACAGGTGCTG |
| | | CATGGCTGTCGTCAGCTCGTGTCGTGAGATGTTGG |
| | | GTTAAGTCCCGCAACGAGCGCAACCCTTGTCCTTA |
| | | GTTGCTACGCAAGAGCACTCTAGGGAGACTGCCGG |
| | | TGACAAACCGGAGGAAGGTGGGGATGACGTCAAGT |
| | | CCTCATGGCCCTTATGGGTAGGGCTTCACACGTCA |
| | | TACAATGGTCGGAACAGAGGGTCGCCAACCCGCGA |
| | | GGGGGAGCTAATCCCAGAAAACCGATCGTAGTCCG |
| | | GATTGCACTCTGCAACTCGAGTGCATGAAGCTGGA |
| | | ATCGCTAGTAATCGCGGATCAGCATGCCGCGGTGA |
| | | ATACGTTCCCGGGTCTTGTACACACCGCCCGTCAC |
| | | ACCATGGGAGTGGGTTTTACCAGAAGTGGCTAGTC |
| | | TAACCGCAAGGAGGACGGTCACCACGGTAGGATTC |
| | | ATGACTGGGGTGAAGTCGTA |
| 2 | 3 A12 | TCCTCCTTGCGGTTAGACTAGCCACTTCTGGTAAAA |
| | | CCCACTCCCATGGTGTGACGGGCGGTGTGTACAAG |
| | | ACCCGGGAACGTATTCACCGCGGCATGCTGATCCG |
| | | CGATTACTAGCGATTCCAGCTTCATGCACTCGAGTT |
| | | GCAGAGTGCAATCCGGACTACGATCGGTTTTCTGG |
| | | GATTAGCTCCCCCTCGCGGGTTGGCGACCCTCTGT |
| | | TCCGACCATTGTATGACGTGTGAAGCCCTACCCATA |
| | | AGGGCCATGAGGACTTGACGTCATCCCCACCTTCC |
| | | TCCGGTTTGTCACCGGCAGTCTCCCTAGAGTGCTC |
| | | TTGCGTAGCAACTAAGGACAAGGGTTGCGCTCGTT |
| | | GCGGGACTTAACCCAACATCTCACGACACGAGCTG |
| | | ACGACAGCCATGCAGCACCTGTGTATCGGTTCTCTT |
| | | TCGAGCACTCCCAGATCTCTCCAGGATTCCGACCA |
| | | TGTCAAGGGTAGGTAAGGTTTTTCGCGTTGCATCGA |
| | | ATTAATCCACATCATCCACCGCTTGTGCGGGTCCCC |
| | | GTCAATTCCTTTGAGTTTTAATCTTGCGACCGTACT |
| | | CCCCAGGCGGTCAACTTCACGCGTTAGCTACGTTA |
| | | CTAAGGAAATGAATCCCCAACAACTAGTTGACATCG |
| | | TTTAGGGCGTGGACTACCAGGGTA |
| 3 | 3 C11 | TCCTCCTTGCGGTTAGACTAGCCACTTCTGGTAAAA |
| | | CCCACTCCCATGGTGTGACGGGCGGTGTGTACAAG |
| | | ACCCGGGAACGTATTCACCGCGGCATGCTGATCCG |
| | | CGATTACTAGCGATTCCAGCTTCATGCACTCGAGTT |
| | | GCAGAGTGCAATCCGGACTACGATCGGTTTTCTGG |
| | | GATTAGCTCCCCCTCGCGGGTTGGCGACCCTCTGT |
| | | TCCGACCATTGTATGACGTGTGAAGCCCTACCCATA |
| | | AGGGCCATGAGGACTTGACGTCATCCCCACCTTCC |
| | | TCCGGTTTGTCACCGGCAGTCTCCCTAGAGTGCTC |
| | | TTGCGTAGCAACTAAGGACAAGGGTTGCGCTCGTT |
| | | GCGGGACTTAACCCAACATCTCACGACACGAGCTG |
| | | ACGACAGCCATGCAGCACCTGTGTATCGGTTCTCTT |
| | | TCGAGCACTCCCAGATCTCTCCAGGATTCCGACCA |
| | | TGTCAAGGGTAGGTAAGGTTTTTCGCGTTGCATCGA |
| | | ATTAATCCACATCATCCACCGCTTGTGCGGGTCCCC |
| | | GTCAATTCCTTTGAGTTTTAATCTTGCGACCGTACT |
| | | CCCCAGGCGGTCAACTTCACGCGTTAGCTACGTTA |
| | | CTAAGGAAATGAATCCCCAACAACTAGTTGACATCG |
| | | TTTAGGGCGTGGACTACCAGGG |
| 26 | | CCTGGTAGTCCACGCCCTAAACGATGTCAACTAGTT |
| | | GTTGGGGATTCATTTCCTTAGTAACGTAGCTAACGC |
| | | GTGAAGTTGACCGCCTGGGGAGTACGGTCGCAAGAT |
| | | TAAAACTCAAAGGAATTGACGGGGACCCGCACAAG |
| | | CGGTGGATGATGTGGATTAATTCGATGCAACGCGAA |
| | | AAACCTTACCTACCCTTGACATGGTCGGAATCCTGG |
| | | AGAGATCTGGGAGTGCTCGAAAGAGAACCGATACA |
| | | CAGGTGCTGCATGGCTGTCGTCAGCTCGTGTCGTGA |
| | | GATGTTGGGTTAAGTCCCGCAACGAGCGCAACCCTT |
| | | GTCCTTAGTTGCTACGCAAGAGCACTCTAGGGAGAC |
| | | TGCCGGTGACAAACCGGAGGAAGGTGGGGATGACG |
| | | TCAAGTCCTCATGGCCCTTATGGGTAGGGCTTCACA |
| | | CGTCATACAATGGTCGGAACAGAGGGTCGCCAACCC |
| | | GCGAGGGGGAGCTAATCCCAGAAAACCGATCGTAG |
| | | TCCGGATTGCACTCTGCAACTCGAGTGCATGAAGCT |
| | | GGAATCGCTAGTAATCGCGGATCAGCATGCCGCGGT |
| | | GAATACGTTCCCGGGTCTTGTACACACCGCCCGTCA |
| | | CACCATGGGAGTGGGTTTTACCAGAAGTGGCTAGTC |
| | | TAACCGCAAGGAGGAC |
| 27 | 4H12 | TCGATACCCTTGGTGCCGAAGTTAACACATTAAGCA |
| | | TTCCGCCTGGGGAGTACGGTCGCAAGACTGAAACTC |
| | | AAAGGAATTGACGGGGACCCGCACAAGCAGTGGAG |
| | | TATGTGGTTTAATTCGAAGCAACGCGAAGAACCTTA |
| | | CCAGGTCTTGACATCCCTCTGACCGGTCTAGAGATA |
| | | GGNCTTTCCTTCGGGACAGAGGAGACAGGTGGTGCA |
| | | TGGTTGTCGTCAGCTCGTGTCGTGAGATGTTGGGTTA |
| | | AGTCCCGCAACGAGCGCAACCCTTATGCTTAGTTGC |
| | | CAGCAGGTCAAGCTGGGCACTCTAAGCAGACTGCCG |
| | | GTGACAAACCGGAGGAAGGTGGGGATGACGTCAAA |
| | | TCATCATGCCCCTTATGACCTGGGCTACACACGTACT |
| | | ACAATGGCCGGTACAACGGGAAGCGAAGGAGCGAN |
| | | NTGGAGCCAATCCTAGAAAAGCCGGTCTCAGTTCGG |
| | | ATTGTAGGCTGCAACTCGCCTACATGAAGTCGGAAT |
| | | TGCTAGTAATCGCGGATCAGCATGCCGCGGTGAATA |
| | | CGTTCCCGGGTCTTGTACACACCGCCCGTCACACCA |
| | | CGAGAGTTTACAACACCCGAAGTCGGTGAGGTAACC |
| | | GCAAGG |
| 28 | 3H8 | CCCTTAGTGCTGCAGCTAACGCATTAAGCACTCCGC |
| | | CTGGGGAGTACGGTCGCAAGACTGAAACTCAAAGG |
| | | AATTGACGGGGGCCCGCACAAGCGGTGGAGCATGT |
| | | GGTTTAATTCGAAGCAACGCGAAGAACCTTACCAGG |
| | | TCTTGACATCCTCTGACAATCCTAGAGATAGGACGT |
| | | CCCCTTCGGGGGCAGAGTGACAGGTGGTGCATGGTT |
| | | GTCGTCAGCTCGTGTCGTGAGATGTTGGGTTAAGTC |
| | | CCGCAACGAGCGCAACCCTTGATCTTAGTTGCC |
| | | AGCATTCAGTTGGGCACTCTAAGGTGACTGCCGGTG |
| | | ACAAACCGGAGGAAGGTGGGGATGACGTCAAATCA |
| | | TCATGCCCCTTATGACCTGGGCTACACACGTGCTAC |
| | | AATGGACAGAACAAAGGGCAGCGAAACCGCGAGGT |
| | | TAAGCCAATCCCACAAATCTGTTCTCAGTTCGGATC |
| | | GCAGTCTGCAACTCGACTGCGTGAAGCTGGAATCGC |
| | | TAGTAATCGCGGATCAGCATGCCGCGGTGAATACGT |
| | | TCCCGGGCCTTGTACACACCGCCCGTCACACCACGA |
| | | GAGTTTGTAACACCCGAAGTCGGTGAGGTAACCTTT |
| | | TAGGAGCCAGCCGCCGAAGGTGGGACAGATGATTG |
| | | GGGTGAAGT |

TABLE 8
Sequences of isolated genes from candidate mutants

| SEQ ID | Mutant | |
|---|---|---|
| NO: | name | Gene sequence |
| 4 | 2 C7-f | GCAGCGTCAGCTGGTTTGCCACCACGGAGTGCTGCA |
| | | GAATCGCATCCTGCGGCTCCGGCTGGTATGCAGGGC |
| | | GCGCGTTATCATTGTAGTGTGGCCGCATATCGTTAAA |
| | | GTTGGTGCGCAGCGTGAAGCCAAACATCACGGTGTT |
| | | GCCGCGCTCGTAGCTGAGGTTAACGTCGGCCCAGTC |
| | | GGTGACGCGATAAATGGCGCCGACGTTAAACTTGCTC |
| | | TTCTGCTCAATCTTCCCGGCGAAGTCCTGCGAGTAGT |
| | | CATTCCCTTCATATTCCAGCTTCAGGCGTAATGGCTG |
| | | CCAGGGCGTTTGATACTCCACGCCGCCAAACAGCGAT |
| | | GCCGGACCGTGGAACATCTGGTCACCGTTGATGGAA |
| | | CCCGCTTTCTTATAGCTGTTATCGCGGTAGCAGTATTT |
| | | ATCGCTGTAGGAGCAAAACGGATTTTTCACGTTACCG |
| | | CCAGTGCCCAGGTAGCCCCATCCCAGGCCGAGCGAG |
| | | AAGTCGAACGGCCCCCAGGCTTTACTGGCCACGATGT |
| | | ATTCAGCATCAAACAGACCGGTACCACCGATATCTTT |
| | | GGCGCCCACGGACACCTGCGGCATCCAGTAGCTCTC |
| | | TTCCCACAGGCGCAGCTTGACGTCGAAGGCTTTATCT |
| | | TTGTAGGTCTGGTCGCCGGAGAACGCATCAACGCTG |
| | | CTGTACTGTTTCGTACGCACGTCGGTGTAGCGCAGCG |
| | | TGGTTTCAAGCCACGGGAACAGCTGCACCGACGCCG |
| | | AGTAGTAACGATACTGATCGTTATCACGGTAGTTAANG |
| | | NCTGTCTCTTATACACATCTCAACCATCATCGATGAAT |
| | | TGCTTCGTTAATACAGATGT |
| 5 | 2 C7-r | GTGTATAAGAGACAGGCCTTAACTACCGTGATAACGA |
| | | TCAGTATCGTTACTACTCGGCGTCGGTGCAGCTGTTC |
| | | CCGTGGCTTGAAACCACGCTGCGCTACACCGACGTG |
| | | CGTACGAAACAGTACAGCAGCGTTGATGCGTTCTCCG |
| | | GCGACCAGACCTACAAAGATAAAGCCTTCGACGTCAA |
| | | GCTGCGCCTGTGGGAAGAGAGCTACTGGATGCCGCA |
| | | GGTGTCCGTGGGCGCCAAAGATATCGGTGGTACCGG |
| | | TCTGTTTGATGCTGAATACATCGTGGCCAGTAAAGCC |
| | | TGGGGGCCGTTCGACTTCTCGCTCGGCCTGGGATGG |
| | | GGCTACCTGGGCACTGGCGGTAACGTGAAAAATCCG |
| | | TTTTGCTCCTACAGCGATAAATACTGCTACCGCGATAA |
| | | CAGCTATAAGAAAGCGGGTTCCATCAACGGTGACCAG |
| | | ATGTTCCACGGTCCGGCATCGCTGTTTGGCGGCGTG |
| | | GAGTATCAAACGCCCTGGCAGCCATTACGCCTGAAGC |
| | | TGGAATATGAAGGGAATGACTACTCGCAGGACTTCGC |
| | | CGGGAAGATTGAGCAGAAGAGCAAGTTTAACGTCGG |
| | | CGCCATTTATCGCGTCACCGACTGGGCCGACGTTAAC |
| | | CTCAGCTACGAGCGCGGCAACACCGTGATGTTTGGCT |
| | | TCACGCTGCGCACCAACTTTAACGATATGCGGCCACA |
| | | CTACAATGATAACGCGCGCCCTGCATACCAGCCGGA |
| | | GCCGCANGATGCGATTCTGCAGCACTCCGTGGTGGC |
| | | AAACCAGCTGACGCTGCTGAAATACAATGCCGGCCTG |
| | | GCGGATCCCCGCCACGGTTGATGAGAGCTTTGTTGTN |
| | | NNGGACCAGTTGGTGATTTTGAACTTTTGCTTTGCCAC |
| | | GGAACGGTCTGCGTTGTCGGGAAGATGCGTGATCTG |
| | | ATCCTTCAACTCAGCAAAAGTTCGATTTNNTCANAAAG |
| | | CCGCCGTCCCGTCNGTCAGCGTANGNTCTGNCAGTG |
| 6 | C1-f | CAGCGTCAGCTGGTTTGCCACCACGGAGTGCTGCAG |
| | | AATCGCATCCTGCGGCTCCGGCTGGTATGCAGGGCG |
| | | CGCGTTATCATTGTAGTGTGGCCGCATATCGTTAAAG |
| | | TTGGTGCGCAGCGTGAAGCCAAACATCACGGTGTTGC |
| | | CGCGCTCGTAGCTGAGGTTAACGTCGGCCCAGTCGG |
| | | TGACGCGATAAATGGCGCCGACGTTAAACTTGCTCTT |
| | | CTGCTCAATCTTCCCGGCGAAGTCCTGCGAGTAGTCA |
| | | TTCCCTTCATATTCCAGCTTCAGGCGTAATGGCTGCC |
| | | AGGGCGTTTGATACTCCACGCCGCCAAACAGCGATG |
| | | CCGGACCGTGGAACATCTGGTCACCGTTGATGGAAC |
| | | CCGCTTTCTTATAGCTGTTATCGCGGTAGCAGTATTTA |
| | | TCGCTGTAGGAGCAAAACGGATTTTTCACGTTACCGC |
| | | CAGTGCCCAGGTAGCCCCATCCCAGGCCGAGCGAGA |
| | | AGTCGAACGGCCCCCAGGCTTTACTGGCCACGATGTA |
| | | TTCAGCATCAAACAGACCGGTACCACCGATATCTTTG |
| | | GCGCCCACGGACACCTGCGGCATCCAGTAGCTCTCT |
| | | TCCCACAGGCGCAGCTTGACGTCGAAGGCTTTATCTT |
| | | TGTAGGTCTGGTCGCCGGAGAACGCATCAACGCTGC |
| | | TGTACTGTTTCGTACGCACGTCGGTGTAGCGCAGCGT |
| | | GGTTTCAAGCCACGGGAACAGCTGCACCGACGCCGA |
| | | GTAGTAACGATACTGATCGTTATCACGGTAGTTAAGG |
| | | CCTGTCTCTTATACACATCTCAACCATCATCGATGAAT |
| | | TGCTTCGTTAATACAGATGTAGGTGTTCCACAGGGTA |
| | | GCCAGCAGCATCCTGCGATGCAGATNCCGNATGCCA |
| | | TTTCATTACCTCTTTCTCCGCACCCGANNTAGATCCNA |
| | | ANATCAGCAGTTCANNNGNNATAGTACGTACTA |
| 7 | C1-r | GGTTGAGATGTGTATAAGAGACAGGCCTTAACTACCG |
| | | TGATAACGATCAGTATCGTTACTACTCGGCGTCGGTG |
| | | CAGCTGTTCCCGTGGCTTGAAACCACGCTGCGCTACA |
| | | CCGACGTGCGTACGAAACAGTACAGCAGCGTTGATG |
| | | CGTTCTCCGGCGACCAGACCTACAAAGATAAAGCCTT |
| | | CGACGTCAAGCTGCGCCTGTGGGAAGAGAGCTACTG |
| | | GATGCCGCAGGTGTCCGTGGGCGCCAAAGATATCGG |
| | | TGGTACCGGTCTGTTTGATGCTGAATACATCGTGGCC |
| | | AGTAAAGCCTGGGGGCCGTTCGACTTCTCGCTCGGC |
| | | CTGGGATGGGGCTACCTGGGCACTGGCGGTAACGTG |
| | | AAAAATCCGTTTTGCTCCTACAGCGATAAATACTGCTA |
| | | CCGCGATAACAGCTATAAGAAAGCGGGTTCCATCAAC |
| | | GGTGACCAGATGTTCCACGGTCCGGCATCGCTGTTTG |
| | | GCGGCGTGGAGTATCAAACGCCCTGGCAGCCATTAC |
| | | GCCTGAAGCTGGAATATGAAGGGAATGACTACTCGCA |
| | | GGACTTCGCCGGGAAGATTGAGCAGAAGAGCAAGTTT |
| | | AACGTCGGCGCCATTTATCGCGTCACCGACTGGGCC |
| | | GACGTTAACCTCAGCTACGAGCGCGGCAACACCGTG |
| | | ATGTTTGGCTTCACGCTGCGCACCAACTTTAACGATAT |
| | | GCGGCCACACTACAATGATAACGCGCGCCCTGCATAC |
| | | CAGCCGGAGCCGCANGATGCGATTCTGCAGCACTCC |
| | | GTGGTGGCAAACCAGCTGACGCTGCTGAAATACAATG |
| | | NCCGGNCTGGCGGATCCCCGCCACGGTTGATGAGAG |
| | | CTTTGTTGTNNTGGACCAGTTGGTGATTTTGAACTTTT |
| | | GCTTTGCCACGGAACGGTCTGCGTT |
| 8 | C2-f | GCCNTCNCCNAGGNNGCGGCAAGCGCACGGCCATC |
| | | GTCGTGTTCGTCGTGTCGCTGGCGCTGACGCTGGTG |
| | | TTCGCGCTCAAACTGTTCGGAGCATTCTAAGAAAATG |
| | | GCAGGCAACAACCGAATCGGCTCGAAGCGCCTCGTG |
| | | GTCGGCGCTCACTACGGCCTGCGCGACTGGCTCGCG |
| | | CAACGCATCACCGGCGTCATCATGGCGGTCTACACC |
| | | GTGATCCTGCTCGCCTGGTTCTTCGCGGCGCGCGATT |
| | | TCTCCTACGACGGCTGGGCATCGATCTTCGCCACGCA |
| | | ATGGATGAAGCTCGCGACCTTCGTCACGCTGCTGGC |
| | | GCTGTTCTATCACGCCTGGGTCGGCATTCGCGATATC |
| | | TGGATGGATTACGTGAAGCCGGTCGGCGTGCGGCTG |
| | | CTGCTGCAATCGCTGACGATCGTCTGGCTGCTCGCGT |
| | | GCGCGGGCTACGCCGCGCAGATTCTCTGGAGAGTGT |
| | | AAAAGAATGGCTGCAATCAATACTTCCCTGCCGCGTC |
| | | GCAAGTTCGACGTGGTCATCGTCGGCGCGGGCGGCT |
| | | CGGGGATGCGCGCCTCGCTGCAACTCGCGCGCGCG |
| | | GGCCTGTCGGTCTGCGTGCTGTCGAAGGTGTTCCCG |
| | | ACGCGTTCGCACACGGTCGCCGCGCAAGGCGGGATC |
| | | GGTGCCTCGCTGGGCAACATGAGCGAAGACAACTGG |
| | | CACTACCACTTCTACGACACGATCAAGGGCTCCGACT |
| | | GGCTCGGCGANCAGGACGCGATCGAGTTCATGTGCC |
| | | GCGAAGCGCCGAATGCCGTCTACGAGCTGTCTCTTAT |
| | | ACACATCTCAACCATCATCGATGAATTGCTTCGTTAAT |
| | | ACAGATGTANNTGTTCCACAGGGTAGCCAGCAGCATC |
| | | CTGCGATGCAGATNCNGNATGCCATTTCATTACCTCTT |
| | | TCTCCGCACCCGANNTANATCCGANNTCAGCAG |
| 9 | C2-r | GAACTCGATCGCGTCCTGGTCGCCGAGCCAGTCGGA |
| | | GCCCTTGATCGTGTCGTAGAAGTGGTAGTGCCAGTTG |
| | | TCTTCGCTCATGTTGCCCAGCGAGGCACCGATCCCGC |
| | | CTTGCGCGGCGACCGTGTGCGAACGCGTCGGGAACA |
| | | CCTTCGACAGCACGCAGACCGACAGGCCCGCGCGCG |
| | | CGAGTTGCAGCGAGGCGCGCATCCCCGAGCCGCCC |
| | | GCGCCGACGATGACCACGTCGAACTTGCGACGCGGC |
| | | AGGGAAGTATTGATTGCAGCCATTCTTTTACACTCTCC |
| | | AGAGAATCTGCGCGGCGTAGCCCGCGCACGCGAGCA |
| | | GCCAGACGATCGTCAGCGATTGCAGCAGCAGCCGCA |
| | | CGCCGACCGGCTTCACGTAATCCATCCAGATATCGCG |
| | | AATGCCGACCCAGGCGTGATAGAACAGCGCCAGCAG |
| | | CGTGACGAAGGTCGCGAGCTTCATCCATTGCGTGGC |
| | | GAAGATCGATGCCCAGCCGTCGTAGGAGAAATCGCG |
| | | CGCCGCGAAGAACCAGGCGAGCAGGATCACGGTGTA |
| | | GACCGCCATGATGACGCCGGTGATGCGTTGCGCGAG |
| | | CCAGTCGCGCAGGCCGTAGTGAGCGCCGACCACGAG |
| | | GCGCTTCGAGCCGATTCGGTTGTTGCCTGCCATTTTC |
| | | TTAGAATGCTCCGAACAGTTTGAGCGCGAACACCAGC |
| | | GTCAGCGCCAGCGACACGACGAACACGACGATGGCC |
| | | GTGCGCTTGCCGCTTTCCTTGGTGACGGCGTCATGGT |
| | | TGATCCCCGCCACGGTTGATGAGAGCTTTGTTGTNNT |
| | | GGACCAGTTGGTGATTTTGAACTTTTGCTTTGCCACG |
| | | GAACGGTCTGCGTTGTCGGGAAGATGCGTGATCTGAT |
| | | CCNTCA |
| 10 | C3-f | ACGGATGCGCAGAATGCTGCGCCGACTTTTTCGTAGA |
| | | GATGGCCGAGGACGCGTTCGTCTGCGTTGTGGCGGG |
| | | AGAGGATGCTGCGCCAGCGGAAATTCAGGTGGCGGT |
| | | GTGGGTGGATCAGGGATTCGAGATCGTCGCTGGAGG |
| | | GGGCGGGGAGGGCGGAGAGGTAGTCGGTGTAGAGC |
| | | TTGGTGATTCGGGCGTTGTCGTCCAACTGGAAATCTT |
| | | CCCTCAATTGCGGGTCCATTTGGTCTGGAGTTGCCCC |
| | | CGTAACTCCGGACACGGCACCCACTTAGGTTGCTGAA |
| | | TCCGTCGCGCGTCGAAACTCGCGGGGTGAGCGGTAC |
| | | TTCAACGCGCTATGGGGATGCTTTTCGTTGTAGTGCT |
| | | CAAATGCAATGGCCAGATTCCTGGCCGCGGTCGCTG |
| | | CGTCCGGCTTCGGCATGATAGCGACGTAATCGCGCTT |
| | | CATGGTCTTCACGAAGCTTTCCGCCATGCCGTTGCTC |
| | | TGCGGGCTGCACACCGGCGTGGTCAACGGCTTCAGG |
| | | CCGAGCAGCACCGCAAACTGACGTGTTTCGTCGGCC |
| | | GTATAGCCCGAGCCGTTGTCGCTCAGCCACTCGATTT |
| | | CGGACTCGGTATGCAGCACATCCCCAAACCGGTTTTC |
| | | CACCGCAGCCAGCATCACGTCGCGCACGATGTCGCC |
| | | GCTATGGCCGGCCGTCGTGGCTGCCCAGCTCATCGC |
| | | TTCGCGGTCGCAGCAGTCGAGCGCGAACGTCACGCG |
| | | CAACGGCTCGCCGTTGTCGCAGCGAAACTCGAAGCC |
| | | GTCNGAACACCACCGTTGATTGCTGCGCTCCACCGCA |
| | | ACCTTGCCATCGTGACGGCGCTGCGGCCGAACCNGG |
| | | TGCCGCTCTGCGTTGCATCANCNGGCCATGCGTGNN |
| | | CATTACG |
| 11 | C3-r | GTTCTAAAAGGCCGACGGCTCGTTGGTCCCGAAGAGT |
| | | GTTTTTTTCCAGCTTCGCAGCCCACCAGTCAGTTCTC |
| | | GTAGAAGGCAACTTAGCTTTGCCGCACCCCGCATGTT |
| | | GATGCCAGAAACAACCGTGCACGAAGATGGCAAGAC |
| | | GAAATCGTGGCAGGACGATATCGGGACACCCCGGAA |
| | | GGTCCTTTCTGTGCAGTCGGAAGCGAAAGCCCATTTT |
| | | GTGAAGAGCTCGTCTAACTGCCATTTCCGGTTGCGTA |
| | | TCGCGCTGGCGAACCCGCGCCATCAACCGAGAACGA |
| | | TTTTCGACCGTGAGGCGGTCTACCATATCTTCGCTCT |
| | | CCTCACCCCTTGGGCGAGTCGCTTGGCGCACCCGAC |
| | | ACACTCGGCGTGACAACCTCAAGCGGGAGTACTTCTT |
| | | GGTTTGGAAAATGCTCGCTGTCGAGGTAGTCTCGAAT |
| | | CAGTCGGGCAATCAGCGTACTTTTCTTGAAGCCGCGT |
| | | TCGTCGCAGTACGAGTCGAGCCGCGCGAACTCATGC |
| | | TGCGGCAGCAACACAGTGACTTTCGTCATTCGGACCT |
| | | TTTGCATGGGAGCTCCATGCGCAACAGTGCGCACTTG |
| | | TACGGAGTAAACCGGAGTTTACGTCGGCCAACTGCGA |
| | | GCCGCAAGGCACAAGTGGGTAAGCCGCACCAATGCT |
| | | GTATGAATATACAGGTTTTCGGGCTCAGCGGCTGCAA |
| | | AGTGCACGCCCCAACGAACGACCGCCACGGCAAGGG |
| | | AGCGTGCACTGAAACCGTCACAATCAGACCCTTTGAA |
| | | ACCGTACGAANNCCGGCCGTATAGTGATTTACGTGCG |
| | | GTCGGCAACCGGCAAGTACATCAATAGAATCAGTGTG |
| | | TTACGGCGAAGTTGGGGCATCAGTGAACNGCCCCTT |
| 12 | B12-r | CGCCGGGTGCTCGGGCGTGCGCGCGGCGATGCGGC |
| | | GCGGCAGCTCGGCGATACGCGCGGGCAGGGCGGCG |
| | | AGCAGCGCCTCGGTGTCGAGCGGCGCGGTGGGCGG |
| | | CGAGGACGGGGACGACTGGGAAGCTGACGGAGAAG |
| | | CGGACTGGGAAGCGGGCATCGTGGCTCCGGAAACAG |
| | | GCCGGGTCGCAGGGCCTTGCTGAAGATGTTCAATAA |
| | | GGTGTCGATCGTGCCACGCGCACCGCGGCGGGGCA |
| | | ATCTGCCGAACGGACAATAGTGCTTCGCGGCGCGCG |
| | | CAATTAAAATGCGCCCATGAGCAAATCCCGACATGTC |
| | | TCCGAAACCCCCGCCACGCAATGGCTGCGCCGCCAG |
| | | GGCGTGGCCTTCGGCGAGCACACCTACGACTACGTC |
| | | GAGCACGGCGGCACGGGCGAATCGGCGCGCCAGCT |
| | | AGGCGTGGACGAGCACGCGGTGGTCAAGACCCTGGT |
| | | GATGGAGGACGAGCAGGCCAGGCCGCTGGTGATCCT |
| | | GATGCATGGCGATCGTACCGTCTCCACCAAGAACCTG |
| | | GCGCGGCAGATCGGCGCCAAGCGCGTCGAGCCCTG |
| | | CAAGCCCGAGGTCGCGAACCGTCATTCGGGCTACCT |
| | | GGTAGGCGGCACCTCGCCGTTCGGCACCAAGAAAGC |
| | | GATGCCCGTCTACGTCGAGTCGAGCGTGCTCGAGCT |
| | | GCCCTCGATCCTCATCAACGGCGGCAAGCGCGGCTA |
| | | CCTGCTGAGCCTCGCGCCGGCGGTGCTGACCGACGT |
| | | GCTCGGCGCGAAACCGGTGCAGTGCGCCAGCGTCGA |
| | | TTGAGGGTTTCACCCGGAACCGGGGCCGGCCCGCTT |
| | | CGGTAGAATGGGCGCCGCGCGGCGCNNNNTGGCCC |
| | | GGCGGCGGCGCCCCNTTCACTT |
| 13 | B12-f | GGCGCGCCGGATCGCCNCCACCGCGTCGAACACGTC |
| | | GCGCGGCGTCGCCTCGGCCGGCGCGATGCCGCGCG |
| | | CGGCGAATTCGCGCGAGACATCGGCGTAGTTGCAAC |
| | | GCGGCGTCCATCGCTTGGGCAGCCTGAACG |
| | | TGACCGAGACGATCGCGAAGCGGTCCCGCGCGGCCT |
| | | GCTTGAAAACGCTGTCGCGATAGCCGAACGCGCAGG |
| | | CCGCGGCATCGAATTCGACGATCTCGCCGGTGGCCA |
| | | GCTCGACCGCCTTCAGCGATGCGAAGCGTTCGCGCA |
| | | TCTCGATGCCGTAGGCGCCGATGTTCTGGATCGGCG |
| | | CGGCGCCCACCGTGCCCGGGATCAGCGCGAGATTCT |
| | | CGAGCCCCGGCATGCCGGCATCCAGGGTCCAGGCCA |
| | | CGAACTCGTGCCAGTTCTCGCCGCCGCCGGCTTCCA |
| | | CGTACCAGGCCTCGTCGTCCTCGCGCAGCAGCGCGC |
| | | GGCCGCGCACGCCGTTGATCAGCACCAGCGCGTCGA |
| | | CGTCGCCCGTGAACACCACGTTGCTGCCGCCGCCGA |
| | | GCACCAGCACTGGCAGGCCGGCTGCGCGCGGGTCG |
| | | CGCGCCGCGGCGGCGAAGCCGGCCTGCGTGTCGAC |
| | | GCGCGCCGCCCAGCGCGCGCGCACCGCGAAACCGA |
| | | AGCTGTTGTGCTCGCGCAGCGGGTAATCGGGCAGCA |
| | | GCACCGGCACGCCGGCAGCCTCCGAGGCGGGAGCG |
| | | GACGAAGGCGGANGAGCAGCGGCGGAAGGGGAAGG |
| | | GGAAGGGGAANGGGAAGCGAANTCGGAATCTGACAT |
| | | CGGCGGCAGGGGGCGCGGCGTTCGCGGGTCACGCC |
| | | GACGTGAGCGGCGGCCTTGGGCAAAACGCGGGGGC |
| | | ATCGGTAAAATGGCGGTCGGTCCGCAATTATAGCGAG |
| | | TGGNNGCGCACGCATCGNGCGGCCCGCATGTTTTAC |
| | | AGGGAGAACAGCATGNCNTCGTTCGACGTCNTTTCCG |
| | | AAGCG |
| 14 | 2 B10-f | GGCGGANAGCCNCCGGCAATGTACGCAACGGCGCAC |
| | | AACGGCTGCCCAGGCGAACGGCAAAAACGACGCCCT |
| | | GCGCTTCACGGTGGGGTGCTCCACCTTGAACCCGAG |
| | | GGTTCTATCGCCAGTCACGCAGGGGCTGA |
| | | TGAGCGCCGTAGTTTATTGGATGGCCGATGAATAGGC |
| | | AACCGGCCGGCCGGCCCTGTGGAGCAATAAGGGCGC |
| | | GATCGAAATCACCGCGAACGCCACGCCGGGCCTGCC |
| | | TCCGTCGCCGCATCCGGGCCTGGAAAGCAGGCCGCC |
| | | GCCGTGCCCGACCACCACCCGTGTCGCCTTGCCGCA |
| | | ACGCGGCATTGTCAGTAGGCTAACGATCCCCCCTATC |
| | | GTTTCACCCCACCGACCAGGAGCAGCAGCAATGATC |
| | | GTGTTCGTCACCGGCGCATCCGCGGGATTCGGCGCC |
| | | GCCATCGCCCGGACCTTCGTCAAGGGCGGCCATCGC |
| | | GTGATCGCCAGCGCGCGCCGCAAGGACCGGCTCGAC |
| | | GCCCTCGCCGCCGAACTCGGCGAGGCCCTGCTGCCC |
| | | GTCGAGCTCGACGTGCGCGAGCGCGGCGCCATCGA |
| | | GGCCGCGCTCGCGGGCCTGCCGGCGGACTTCGCCG |
| | | GGATCGACGTGCTGGTCAACAACGCCGGCCTCGCGC |
| | | TGGGTACCGAGCCGGCCCAGCGGGCCAGCCTCGAC |
| | | GAGTGGCAGACCATGATCGACACCNATTGCTCGGGC |
| | | CTGGTCACCGTCACGCACACGCTGCTGCCCGGCATG |
| | | ATCGCGCGCGGCCGCGGCCACATCTTCAACCTGGGC |
| | | TCGGTCGCCGGCACCTACCCGTACGCGGGCGGCAAC |
| | | GTCTACGGCGCGACCAAGGCATTTGTCCGACAATTCA |
| | | GCCTGAACCTGCGCACCGACCTGCTGGGCACGCCGC |
| | | TGCGCGTGACCGACATCGAGCCGGGCCTCTGCNNCG |
| | | GCACCGAA |
| 15 | 2 B10-r | CACCAGCCCTTCGGTGGCGCCGTTCCAGACGATGAA |
| | | CGGCTTGACCCGGCGCTTGACCTTGTCGGCATAACC |
| | | GGGCGAGGTGGCATTGCCGCCCGAGCCCGAACCCGT |
| | | GCCGCTCTTGGCCAGGCCGTCGCTGCCGCCCTGGCC |
| | | GCCTGCCGCGCCCTGCAACTGCGCGAGGCGCGCCT |
| | | GGCGCTCCTTGTCGAGCTTGGCATTGGCCGCGGCGG |
| | | TGGCCTTGGCCTTCGCGGCCGCGTCGGCCTTCGCCT |
| | | TGGCCGCGGCTTCCGCCTTGGCGGCCGCCGCCTTCT |
| | | CGGCCTCGGCCTTCTTCTGCGCTTCAGCCTGTGCCTG |
| | | CTCCTGCTTGCGTTGCTGCTCGAGCTTCTGCTGTTGC |
| | | TCGAGTTTCTTCTGTTCGGCGAGTTGTTGCTGGCGCA |
| | | ACTTGTCGGCCTGCTTCTGCTTTTCCGCTGCCTGCTG |
| | | CTGGGCAAGCTGCTGCGCCGCCAGCTGGGCGGCGC |
| | | GCCTGGCTTCGGCTTCCTGCTGCTGGGCCTTCAGCG |
| | | CCTGCTCGCGGCGCTGCTCGGCGAGCTGCGCCTCGC |
| | | GCGCGGCCGCTTCCTGCTGCTGGCGGCGCTTCTGCT |
| | | GCAGGGCGATCTCGGCATCGTCGTCCCGCGCCGGAN |
| | | GCGGCGCGGGGGCGACGCGCACCGGCGGGGCGGG |
| | | CGGCGGCACCGGGCGCGGCGCCGGCGAATCCGGCA |
| | | CTTCGGTCCACAGCTCGGCTTCCGCGCCGGCCGGCG |
| | | TGCTGTTCTGCCAATTGATGCCGTGGTAGAGCANGGC |
| | | CACCAGCAGCACGTGCATCAGCGCCGCGAGCAGGAA |
| | | CGCGCGTCCCGTGCCGCGTTCTCGAGGCGGCTGCAG |
| | | CGGTGAGGCGGTGCGGGTCTTGCGCTGGTTCATTGC |
| | | GATTTGACGAGGAGGC |
| 16 | 2 C4-f | GCGGANAGCCACCGGCAATGTACGCAACGGCGCACA |
| | | ACGGCTGCCCAGGCGAACGGCAAAAACGACGCCCTG |
| | | CGCTTCACGGTGGGGTGCTCCACCTTGAACCCGAGG |
| | | GTTCTATCGCCAGTCACGCAGGGGCTGATGAGCGCC |
| | | GTAGTTTATTGGATGGCCGATGAATAGGCAACCGGCC |
| | | GGCCGGCCCTGTGGAGCAATAAGGGCGCGATCGAAA |
| | | TCACCGCGAACGCCACGCCGGGCCTGCCTCCGTCGC |
| | | CGCATCCGGGCCTGGAAAGCAGGCCGCCGCCGTGC |
| | | CCGACCACCACCCGTGTCGCCTTGCCGCAACGCGGC |
| | | ATTGTCAGTAGGCTAACGATCCCCCCTATCGTTTCAC |
| | | CCCACCGACCAGGAGCAGCAGCAATGATCGTGTTCG |
| | | TCACCGGCGCATCCGCGGGATTCGGCGCCGCCATCG |
| | | CCCGGACCTTCGTCAAGGGCGGCCATCGCGTGATCG |
| | | CCAGCGCGCGCCGCAAGGACCGGCTCGACGCCCTC |
| | | GCCGCCGAACTCGGCGAGGCCCTGCTGCCCGTCGAG |
| | | CTCGACGTGCGCGAGCGCGGCGCCATCGAGGCCGC |
| | | GCTCGCGGGCCTGCCGGCGGACTTCGCCGGGATCG |
| | | ACGTGCTGGTCAACAACGCCGGCCTCGCGCTGGGTA |
| | | CCGAGCCGGCCCAGCGGGCCAGCCTCGACGAGTGG |
| | | CAGACCATGATCGACACCAATTGCTCGGGCCTGGTCA |
| | | CCGTCACGCACACGCTGCTGCCCGGCATGATCGCGC |
| | | GCGGCCGCGGCCACATCTTCAACCTGGGCTCGGTCG |
| | | CCGGCACCTACCCGTACGCGGGCGGCAACGTCTACG |
| | | GCGCGACCAAGGCATTTGTCCGACAATTCAGCCTGAA |
| | | CCTGCGCACCGACCTGCTGGGCACGCCGCTGCGCGT |
| | | GACCGACATCNAGCCGGGCCTCTGCGGCGGCACCGA |
| 17 | 2 C4-r | GGTTGAGANGTGTATAAGAGACAGGATGAGCACATTG |
| | | ACCTGCGCGTTGGCGGTGCTGCCCGCCGCGATCAGG |
| | | CACGAGGCCACCAGTGCCCTGAAACCCAGCTTCGTC |
| | | ATCAAACTCATGCGTCCTGTTTCCCGTATGTAACTGTG |
| | | CAACCGCAAAGACCTAACAATAGCCGATTCGTTCCTT |
| | | GTGGCGACGGCGCGAGTGTATGCCGATTCCGTGTCA |
| | | CTCCGCCGCCCGGAAGGTAATTGCAATATTCGCCGG |
| | | GGTACTCCCGTTAGTATCGGGCGGCAGGGGCGAGGC |
| | | CGCCCGCACCGCGCCGACCACGGTTTCGTCCCAGGC |
| | | CGGATTGCCGCTCGGCTTCACCACCGAGACGCCGAG |
| | | CACGTCGCCCGACGGCGAGCAGCGCACCTGCACACG |
| | | CGTCACCAGCCCTTCGGTGGCGCCGTTCCAGACGAT |
| | | GAACGGCTTGACCCGGCGCTTGACCTTGTCGGCATAA |
| | | CCGGGCGAGGTGGCATTGCCGCCCGAGCCCGAACC |
| | | CGTGCCGCTCTTGGCCAGGCCGTCGCTGCCGCCCTG |
| | | GCCGCCTGCCGCGCCCTGCAACTGCGCGAGGCGCG |
| | | CCTGGCGCTCCTTGTCGAGCTTGGCATTGGCCGCGG |
| | | CGGTGGCCTTGGCCTTCGCGGCCGCGTCGGCCTTCG |
| | | CCTTGGCCGCGGCTTCCGCCTTGGCGGCCGCCGCCT |
| | | TCTCGGCCTCGGCCTTCTTCTGCGCTTCAGCCTGTGC |
| | | CTGCTCCTGCTTGCGTTGCTGCTCGAGCTTCTGCTGT |
| | | TGCTCGAGTTTCTTCTGTTCGGCGAGTTGTTGCTGGC |
| | | GCAACTTGTCGGCCTGCTTCTGCTTTTCCGCTGCCTG |
| | | CTGCTGGGCAAGCTGCTGCGCCGCCAGCTGGGCGG |
| | | CGCGCCTGGCTTCNGCTTCCTGCTGCTGGGCCTTCA |
| | | GCGCCTGCTCGCGGCGCTGCTCGGCNANCTG |
| 18 | 2 C11-f | AGCCNCCGGCAATGTACGCAACGGCGCACAACGGCT |
| | | GCCCAGGCGAACGGCAAAAACGACGCCCTGCGCTTC |
| | | ACGGTGGGGTGCTCCACCTTGAACCCGAGGGTTCTAT |
| | | CGCCAGTCACGCAGGGGCTGATGAGCGCCGTAGTTT |
| | | ATTGGATGGCCGATGAATAGGCAACCGGCCGGCCGG |
| | | CCCTGTGGAGCAATAAGGGCGCGATCGAAATCACCG |
| | | CGAACGCCACGCCGGGCCTGCCTCCGTCGCCGCATC |
| | | CGGGCCTGGAAAGCAGGCCGCCGCCGTGCCCGACC |
| | | ACCACCCGTGTCGCCTTGCCGCAACGCGGCATTGTC |
| | | AGTAGGCTAACGATCCCCCCTATCGTTTCACCCCACC |
| | | GACCAGGAGCAGCAGCAATGATCGTGTTCGTCACCG |
| | | GCGCATCCGCGGGATTCGGCGCCGCCATCGCCCGGA |
| | | CCTTCGTCAAGGGCGGCCATCGCGTGATCGCCAGCG |
| | | CGCGCCGCAAGGACCGGCTCGACGCCCTCGCCGCC |
| | | GAACTCGGCGAGGCCCTGCTGCCCGTCGAGCTCGAC |
| | | GTGCGCGAGCGCGGCGCCATCGAGGCCGCGCTCGC |
| | | GGGCCTGCCGGCGGACTTCGCCGGGATCGACGTGCT |
| | | GGTCAACAACGCCGGCCTCGCGCTGGGTACCGAGCC |
| | | GGCCCAGCGGGCCAGCCTCGACGAGTGGCAGACCAT |
| | | GATCGAC |
| | | ACCAATTGCTCGGGCCTGGTCACCGTCACGCACACG |
| | | CTGCTGCCCGGCATGATCGCGCGCGGCCGCGGCCA |
| | | CATCTTCAACCTGGGCTCGGTCGCCGGCACCTACCC |
| | | GTACGCGGGCGGCAACGTCTACNGCGCGANCAAGGC |
| | | ATTTGTCCGACAATTCAGCCTGAACCTGCGCACCGAC |
| | | CTGCTGGGCACGCCGCTGCGCGTGACCGACATCGAG |
| | | CCGGGNCTCTGCGGNGGCACCGAA |
| 19 | 2 C11-r | GGTTGAGANGTGTATAAGAGACAGACGGCGAGCAGC |
| | | GCACCTGCACACGCGTCACCAGCCCTTCGGTGGCGC |
| | | CGTTCCAGACGATGAACGGCTTGACCCGGCGCTTGA |
| | | CCTTGTCGGCATAACCGGGCGAGGTGGCATTGCCGC |
| | | CCGAGCCCGAACCCGTGCCGCTCTTGGCCAGGCCGT |
| | | CGCTGCCGCCCTGGCCGCCTGCCGCGCCCTGCAACT |
| | | GCGCGAGGCGCGCCTGGCGCTCCTTGTCGAGCTTGG |
| | | CATTGGCCGCGGCGGTGGCCTTGGCCTTCGCGGCCG |
| | | CGTCGGCCTTCGCCTTGGCCGCGGCTTCCGCCTTGG |
| | | CGGCCGCCGCCTTCTCGGCCTCGGCCTTCTTCTGCG |
| | | CTTCAGCCTGTGCCTGCTCCTGCTTGCGTTGCTGCTC |
| | | GAGCTTCTGCTGTTGCTCGAGTTTCTTCTGTTCGGCG |
| | | AGTTGTTGCTGGCGCAACTTGTCGGCCTGCTTCTGCT |
| | | TTTCCGCTGCCTGCTGCTGGGCAAGCTGCTGCGCCG |
| | | CCAGCTGGGCGGCGCGCCTGGCTTCGGCTTCCTGCT |
| | | GCTGGGCCTTCAGCGCCTGCTCGCGGCGCTGCTCGG |
| | | CGAGCTGCGCCTCGCGCGCGGCCGCTTCCTGCTGCT |
| | | GGCGGCGCTTCTGCTGCAGGGCGATCTCGGCATCGT |
| | | CGTCCCGCGCCGGANGCGGCGCGGGGGCGACGCGC |
| | | ACCGGCGGGGCGGGCGGCGGCACCGGGCGCGGCG |
| | | CCGGCGAATCCGGCACTTCGGTCCACAGCTCGGCTT |
| | | CCGCGCCGGCCGGCGTGCTGTTCTGCCNATTGATGC |
| | | CGTGGTAGANCAGGGCCACCAGCAGCACGTGCATCA |
| | | GCGCCGCGAGCAGGAACGCGCGTCCCGTGCCGCGT |
| | | TCTCGAGGCGGCTGCAGCGGTGANGCGGTGCGGGT |
| | | CTTGNGCTGGTTCATTGCNATTTGACGAGGANGCCCA |
| 20 | 2 C12-f | CAGACGCGCGGCATCTGGNAGGNGCTGCTCGAAGGC |
| | | GCCGAGCTCTATCGCGCCGAAGCCAAGAACGAGGAA |
| | | ACGCTGCGCAAGTTCAGCCACGGCACGCCGAACGAC |
| | | TGGATCGAGCGCAACCTGTCTCTTATACACATCTCAA |
| | | CCATCATCGATGAATTGCTTCGTTAATACAGATGTAGG |
| | | TGTTCCACAGGGTAGCCAGCAGCATCCTGCGATGCA |
| | | GATCCGGATGCCATTTCATTACCTCTTTCTCCGCACCC |
| | | GACATAGATCCGAAGATCAGCAGTTCAACCTGTTGAT |
| | | AGTACGTACTAAGCTCTCATGTTTCACGTACTAAGCTC |
| | | TCATGTTTAACGTACTAAGCTCTCATGTTTAACGAACT |
| | | AAACCCTCATGGCTAACGTACTAAGCTCTCATGGCTA |
| | | ACGTACTAAGCTCTCATGTTTCACGTACTAAGCTCTCA |
| | | TGTTTGAACAATAAAATTAATATAAATCAGCAACTTAAA |
| | | TAGCCTCTAAGGTTTTAAGTTTTATAAGAAAAAAAAGA |
| | | ATATATAAGGCTTTTAAAGCTTTTAAGGTTTAACGGTT |
| | | GTGGACAACAAGCCAGGGATCTGCCATTTCATTACCT |
| | | CTTTCTCCGCACCCGACATAGATCCGGAACATAATGG |
| | | TGCAGGGCGCTGACTTCCGCGTTTCCAGACTTTACGA |
| | | AACACGGAAACCGAAGACCATTCATGTTGTTGCTCAN |
| | | GTCGCAGACGTTTTGCAGCAGCAGTCGCTTCACGTTC |
| | | GCTCGCGTATCGGTGATTCATTCTGCTAACCAGTAAG |
| | | GCAACCCCGCCAGCCTAGCCNGGTCCTCAACGACAG |
| | | GAGCACGATCATGCGCACCCGTGGCCAGGACCCAAC |
| | | GCTGCCCGAGATGCGCCGCGTGCGGCTGCTGGANAT |
| | | GGCGGACGCGATGGATATGNTCTGCCANGGGTNGGT |
| | | TTGCNCATTC |
| 21 | 2 C12-r | GGTTGAGANGTGTATAAGAGACAGGTTGCGCTCGATC |
| | | CAGTCGTTCGGCGTGCCGTGGCTGAACTTGCGCAGC |
| | | GTTTCCTCGTTCTTGGCTTCGGCGCGATAGAGCTCGG |
| | | CGCCTTCGAGCAGCACCTTCCAGATGCC |
| | | GCGCGTCTGCGGGCTGTGCGGATCCCCGCCACGGTT |
| | | GATGAGAGCTTTGTTGTAGGTGGACCAGTTGGTGATT |
| | | TTGAACTTTTGCTTTGCCACGGAACGGTCTGCGTTGT |
| | | CGGGAAGATGCGTGATCTGATCCTTCAACTCAGCAAA |
| | | AGTTCGATTTATTCAACAAAGCCGCCGTCCCGTCAAG |
| | | TCAGCGTAATGCTCTGCCAGTGTTACAACCAATTAACC |
| | | AATTCTGATTAGAAAAACTCATCGAGCATCAAATGAAA |
| | | CTGCAATTTATTCATATCAGGATTATCAATACCATATTT |
| | | TTGAAAAAGCCGTTTCTGTAATGAAGGAGAAAACTCAC |
| | | CGAGGCAGTTCCATAGGATGGCAAGATCCTGGTATCG |
| | | GTCTGCGATTCCGACTCGTCCAACATCAATACAACCT |
| | | ATTAATTTCCCCTCGTCAAAAATAAGGTTATCAAGTGA |
| | | GAAATCACCATGAGTGACGACTGAATCCGGTGAGAAT |
| | | GGCAAAAGTTTATGCATTTCTTTCCAGACTTGTTCAAC |
| | | AGGCCAGCCATTACGCTCGTCATCAAAATCACTCGCA |
| | | TCAACCAAACCGTTATTCATTCGTGATTGCGCCTGANC |
| | | GAGACGAAATACGCGATCGCTGTTAAAAGGACAATTA |
| | | CNAACAGGAATCGAATGCAACCGGCGCNNNACACTG |
| | | CCAGCGCATCAACAATATTTTCACCTGAATCNNATATT |
| | | CTTCTAATACCTGGAATGCTGTTTTTNCNGGGGATCG |
| | | CAGTGGTGAGTAACCATGCATCATCNGNAGTACGNAT |
| | | AAAATGCTTGATGGTC |
| 22 | 2 D2-f | GACCGCTGGCACGGCTTCGGCCCGCTCGCGGAAGG |
| | | CTTCAACATGCTGGACCCGATCAAGGCCACCATCATC |
| | | ACCCCCTGTCTCTTATACACATCTCAACCATCATCGAT |
| | | GAATTGCTTCGTTAATACAGATGTAGGT |
| | | GTTCCACAGGGTAGCCAGCAGCATCCTGCGATGCAG |
| | | ATCCGGATGCCATTTCATTACCTCTTTCTCCGCACCCG |
| | | ACATAGATCCGAAGATCAGCAGTTCAACCTGTTGATA |
| | | GTACGTACTAAGCTCTCATGTTTCACGTACTAAGCTCT |
| | | CATGTTTAACGTACTAAGCTCTCATGTTTAACGAACTA |
| | | AACCCTCATGGCTAACGTACTAAGCTCTCATGGCTAA |
| | | CGTACTAAGCTCTCATGTTTCACGTACTAAGCTCTCAT |
| | | GTTTGAACAATAAAATTAATATAAATCAGCAACTTAAAT |
| | | AGCCTCTAAGGTTTTAAGTTTTATAAGAAAAAAAAGAA |
| | | TATATAAGGCTTTTAAAGCTTTTAAGGTTTAACGGTTG |
| | | TGGACAACAAGCCAGGGATCTGCCATTTCATTACCTC |
| | | TTTCTCCGCACCCGACATAGATCCGGAACATAATGGT |
| | | GCAGGGCGCTGACTTCCGCGTTTCCAGACTTTACGAA |
| | | ACACGGAAACCGAAGACCATTCATGTTGTTGCTCAGG |
| | | TCGCAGACGTTTTGCAGCAGCAGTCGCTTCACGTTCG |
| | | CTCGCGTATCGGTGATTCATTCTGCTAACCAGTAAGG |
| | | CAACCCCGCCAGCCTAGCCGGGTCCTCAACGACAGG |
| | | AGCACGATCATGCGCACCCGTGGCCAGGACCCAACG |
| | | CTGCCCGAGATGCGCCGCGTGCGGCTGCTGGANATG |
| | | GCGGACGCNATGGATATGTTCTGCCANGGGTTGGTTT |
| | | GCGCATTCNCAGGGTGTCCCAAAATCTCTGATGTTAC |
| | | ATTGCACANATAAAATATA |
| 23 | 2 D2-r | GGTTGAGANGTGTATAAGAGACAGGGGGTGATGATG |
| | | GTGGCCTTGATCGGGTCCAGCATGTTGAAGCCTTCCG |
| | | CGAGCGGGCCGAAGCCGTGCCAGCGGTCGTTCGGG |
| | | CGCAGGATCCCCGCCACGGTTGATGAGAGCTTTGTTG |
| | | TAGGTGGACCAGTTGGTGATTTTGAACTTTTGCTTTGC |
| | | CACGGAACGGTCTGCGTTGTCGGGAAGATGCGTGAT |
| | | CTGATCCTTCAACTCAGCAAAAGTTCGATTTATTCAAC |
| | | AAAGCCGCCGTCCCGTCAAGTCAGCGTAATGCTCTGC |
| | | CAGTGTTACAACCAATTAACCAATTCTGATTAGAAAAA |
| | | CTCATCGAGCATCAAATGAAACTGCAATTTATTCATAT |
| | | CAGGATTATCAATACCATATTTTTGAAAAAGCCGTTTC |
| | | TGTAATGAAGGAGAAAACTCACCGAGGCAGTTCCATA |
| | | GGATGGCAAGATCCTGGTATCGGTCTGCGATTCCGAC |
| | | TCGTCCAACATCAATACAACCTATTAATTTCCCCTCGT |
| | | CAAAAATAAGGTTATCAAGTGAGAAATCACCATGAGTG |
| | | ACGACTGAATCCGGTGAGAATGGCAAAAGTTTATGCA |
| | | TTTCTTTCCAGACTTGTTCAACAGGCCAGCCATTACGC |
| | | TCGTCATCAAAATCACTCGCATCAACCAAACCGTTATT |
| | | CATTCGTGATTGCGCCTGAGCGAGACGAAATACGCGA |
| | | TCGCTGTTAAAAGGACAATTACAAACAGGAATCGAAT |
| | | GCAACCGGCGCANGAACACTGCCAGCGCATCAACAA |
| | | TATTTTCACCTGAATCNNATATTCTTCTAATACCTGGAA |
| | | TGCTGTTTTTCCGGGGATCGCAGTGGTGAGTAACCAT |
| | | GCATCATCAGGAGTACNGATAAAATGCTTGATGGTCG |
| | | GAAGANGCATAAATTCCGTCAGCCAGTTTAGTCTGAC |
| | | CATC |
| 24 | B6-f | CGTGCCCGCCAATTGCCCGCTCTGGCACAATAGCTAC |
| | | GGCTTCGTGCGTGGCATCGTCGACCACGGTCAGATT |
| | | CTTGATCACGCGGCCTTCAGCCGTGCGGTCGAACAC |
| | | AAAATCCATTGACCACACCTGATTGGCTGCCGACGGT |
| | | CGGCCCAATGGCTGGCGTTGCGCAGCCGGAACCTTC |
| | | TTGCGCTTGCGGCGGCGCACCTGCAGATTCTCTTGC |
| | | GCGTACAGCCGCTCCACGCGCTTGTGGTTCACGACC |
| | | ATGCCCGATTGCCGCAATTTCAGTAAATCATGCCCGA |
| | | GCCATAGCGACGGTGCCGCTGCGCTAACGCGACGAT |
| | | CTGCGCACGCAAGGCGAGATTGCGGTCCGGCGCGG |
| | | GCTGATAGCGATAAGCGCTGGCGCTCATGCCGATCA |
| | | CTCGCAACGCATGTCGCTCGCTCAAGCCGCCGTGGA |
| | | TCATATGGCGCACCAAGTCGCGGCGTGACGGTGCGC |
| | | TCACCACTTTTTTCGCAGCGCCTCCGGAGTGACTTCG |
| | | TTCTCCAGCATCGATTCCGCGAGCAACTTCTTCAGCC |
| | | GGTTGTTTTCGGCCTCCAATTCTTTCAGGCGCTTCGC |
| | | GTCGGACACGCTCATGCCGCCGAACTTGCTGCGCCA |
| | | CAAGTAGTAGCTTGCCTCGGAAAAGCCATGCTGTCGG |
| | | CAGAGCTCCTTGATCGGCAAGCCGGCCTCCGCCTCG |
| | | CGCAGGAAACCAATGATCTGCTCTTCGGTGAATCGTT |
| | | TCTTCATGCCCAATCTCCTGACTGCGTGATTGGACTCT |
| | | AAAGCGTCATGCTACTCAAGANCGGGGGGACGTCGC |
| | | CCTGTCTGAACTGCTCGTTGTACTTCGTCATGTAAAAC |
| | | ACCCCAAANGTTG |
| 25 | B6-r | GGTTGAGANGTGTATAAGAGACAGGCCCACCAGTCA |
| | | GTTCTCGTAGAAGGCAACTTAGCTTTGCCGCACCCCG |
| | | CATGTTGATGCCAGAAACAACCGTGCACGAAGATGGC |
| | | AAGACGAAATCGTGGCAGGACGATATCGGGACACCC |
| | | CGGAAGGTCCTTTCTGTGCAGTCGGAAGCGAAAGCC |
| | | CATTTTGTGAAGAGCTCGTCTAACTGCCATTTCCGGTT |
| | | GCGTATCGCGCTGGCGAACCCGCGCCATCAACCGAG |
| | | AACGATTTTCGACCGTGAGGCGGTCTACCATATCTTC |
| | | GCTCTCCTCACCCCTTGGGCGAGTCGCTTGGCGCAC |
| | | CCGACACACTCGGCGTGACAACCTCAAGCGGGAGTA |
| | | CTTCTTGGTTTGGAAAATGCTCGCTGTCGAGGTAGTC |
| | | TCGAATCAGTCGGGCAATCAGCGTACTTTTCTTGAAG |
| | | CCGCGTTCGTCGCAGTACGAGTCGAGCCGCGCGAAC |
| | | TCATGCTGCGGCAGCAACACAGTGACTTTCGTCATTC |
| | | GGACCTTTTGCATGGGAGCTCCATGCGCAACAGTGC |
| | | GCACTTGTACGGAGTAAACCGGAGTTTACGTCGGCCA |
| | | ACTGCGAGCCGCAAGGCACAAGTGGGTAAGCCGCAC |
| | | CAATGCTGTATGAATATACAGGTTTTCGGGCTCAGCG |
| | | GCTGCAAAGTGCACGCCCCAACGAACGACCGCCACG |
| | | GCAAGGGAGCGTGCACTGAAACCGTCACAATCAGAC |
| | | CCTTTGAAACCGTACGAATCCGGCCGTATAGTGATTT |
| | | ACGTGCGGTCGGCAACCGGCAAGTACATCAATAGAAT |
| | | CAGTGTGTTACGGCGAAGTTGGGGCATCAGTGAACC |
| | | GCCCCTTTTTCGAGTCCCTGATTCGCTACCAAATGCA |
| | | GAAAGGGCTCAGCGCATGAACTGCACCCCAAAAGTTG |
| | | GACCCCCCGTCCNACCTTTGGGG |

TABLE 9
Sequences of proteins from candidate mutants

| SEQ | | |
|---|---|---|
| ID | | |
| NO: | Gene name | Protein sequence |
| 29 | YajQ | MPSFDVVSEANMIEVKNAVEQSNKEISTRFDFKGSDAR |
| | | VEHKEQELTLFADDDFKLGQVKDVLIGKMAKRNVDVRF |
| | | LDYGKVDKIGGDKLKQVVTIKKGVTGDLAKRVVRTVKD |
| | | SKIKVQASIQGDAVRVSGTKRDDLQSVIALLRKEVADTP |
| | | LDFNNFRD |
| 30 | Long-chain-fatty- | MPASQSASPSASQSSPSSPPTAPLDTEALLAALPARIAE |
| | acid-CoA ligase | LPRRIAARTPEHPALIEDARRLSYAELVTAIDASAAQLRA |
| | (EC 6.2.1.3) | LGVRGGDRVMIVAENSIAQIVLLFAAATLDAWALLANAR |
| | | LSAAELDAIAAHARPRAITFVTATSPDAAAHAARHRAVP |
| | | AAAGEPDIGTWAVALDPGTHAEAVETEGARQCAALIYT |
| | | TGTTGTPKGVMLSHRNLLFVAAVSSTLRRVSASDVVYT |
| | | VLPVSHVYGLASVCLGSLCAGASLRLAPRFVPEAVRRA |
| | | LADERVTIFQGVPAMHAKLLDHLQAHGHAWQAPQLRF |
| | | VYSGGSPLDADLKARVERVYGLPLHNGYGMTESSPTV |
| | | AQTLLEAPRGDCSVGVPIPGIEVRLVDPELKPVPPGEV |
| | | GEIMVRGPNVMLGYYRNPEATRAAITAEGWLRTGDLA |
| | | RAAADGALSIAGRSKELIIRSGFNVYPAEVEHVLNAHPA |
| | | VVQSAVIGRAVPGNEEVLAFVELTPGAALAADELDAWC |
| | | AARLAPYKRPARIVAVEALPAASTGKVLKHRLREHAAYK |
| | | D |
| 31 | Fatty acid | MLDFLAHGLLHFSVVWQIVLATLVATHVTIVSVTIYLHRC |
| | desaturase | QAHRALDLHPAVSHFFRLWLWMSTGMLTGQWAAIHRK |
| | (EC 1.14.19.1); | HHAKCETEEDPHSPQTRGIWKVLLEGAELYRAEAKNEE |
| | Delta-9 fatty | TLRKFSHGTPNDWIERNVYSKYTILGVSLMMVIDVALFG |
| | acid desaturase | IVGLSVWAVQMIWIPFWAAGWNGLAHFWGYRNFNSA |
| | (EC 1.14.19.1) | DASTNLIPWGIVIGGEEMHNNHHTFATSAKFSNKWYEF |
| | | DIGWMYIRILSAFKLAKVKKIAPTPRLVARKAVVDQETLQ |
| | | AVLSNRYEVMANYGKALKRAYRQELAHLKELGSSEKY |
| | | QLLRGARSWFHKDEEGLNEPQKRLLPEIFANSQKMHT |
| | | YFQLRQDLASMWDRSNASREQLLAQLQDWCHRAEQS |
| | | GIKALQEFATRLRRYA |
| 32 | lysine-tRNA | MLLPQHEFARLDSYCDERGFKKSTLIARLIRDYLDSEHF |
| | synthetase | PNQEVLPLEVVTPSVSGAPSDSPKG |
| 33 | ToIR protein | MAGTPLRSSMRGGRSRRSMADINVVPYIDVMLVLLVIF |
| | | MVTAPLVAPSIVNLPTVGNAAPQDQTPPVVVNIQADGR |
| | | MSVRYKSDAGASQEDTMSKAELDDFIASRQADHPDQP |
| | | VVIAADKTVQYDKVMTVMSDLKARGVKRVGLLVKSQ |
| 34 | Arginine/ | MKFRFPVVIIDEDFRSENISGSGIRALAEAIEKEGVEVLG |
| | Ornithine/Lysine | LTSYGDLTSFAQQSSRASCFILSIDDDELMLGETGPDGE |
| | decarboxylase | LPELATAILELRAFVTEVRRRNADIPIFLYGETRTSRHIPN |
| | | DVLRELHGFIHMFEDTPEFVARHIIRETKVYLDSLAPPFF |
| | | KELVKYADEGSYSWHCPGHSGGVAFLKNPLGQMFHQ |
| | | FFGENMLRADVCNAVDELGQLLDHTGPVAASERNAARI |
| | | FSADHLFFVTNGTSTSNKIVWHANVAPGDIVLVDRNCH |
| | | KSILHAITMTHAIPVFLTPTRNHFGIIGPIPRDEFKPENIRK |
| | | KIEANPFAREALQKNPNAKPRILTITQSTYDGVIYNVEHI |
| | | KDLLGDLLDTLHFDEAWLPHAEFHEFYRDMHAIGAGRP |
| | | RTGSLVFATHSTHKLLAGISQASQIVVQDSENRTFDKHR |
| | | FNEAYLMHTSTSPQYAIIASCDVAAAMMEPPGGTALVE |
| | | ESIAEAIEFRRAMRKVDAEYGDDWFFSVWGPDTLPEE |
| | | GIGSREDWILRPNDRWHGFGPLAEGFNMLDPIKATIITP |
| | | GLDVDGEFGETGIPAAIVTKYLAEHGIIVEKTGLYSFFIM |
| | | FTIGITKGRWNSMVTELQQFKDDYDNNQPLWRVLPEFV |
| | | AQFPIYERVGLRDLCTQIHDVYRANDIARLTTEMYLSDM |
| | | EPAMKASDAFAKLAHREIDRVPLDELEGRVTSILLTPYP |
| | | PGIPLLIPGERFNATIVNYLRFARDFNERFPGFHTDVHG |
| | | LVAEEVNGRVEYYVDCVRD |
| 35 | Succinate | MAAINTSLPRRKFDVVIVGAGGSGMRASLQLARAGLSV |
| | dehydrogenase | CVLSKVFPTRSHTVAAQGGIGASLGNMSEDNWHYHFY |
| | | DTIKGSDWLGDQDAIEFMCREAPNAVYELEHFGMPFD |
| | | RNADGTIYQRPFGGHTANYGEKPVQRACAAADRTGHA |
| | | LLHTLYQQNVAAKTQFFVEWMALDLIRDADGDVLGVTA |
| | | LEMETGDVYILEGKTTLFATGGAGRIFAASTNAFINTGD |
| | | GLGMAARSGIALQDMEFWQFHPTGVAGAGVLITEGVR |
| | | GEGGILRNSDGERFMERYAPTLKDLAPRDFVSRSMDQ |
| | | EIKEGRGVGPNKDHVLLDLSHIGAETIMKRLPSIREIALK |
| | | FANVDCIKEPIPVVPTIHYQMGGIPTNIHGQVVGTSKGH |
| | | EDPINGFYAVGECSCVSVHGANRLGTNSLLDLVVFGRA |
| | | AGNHIVEHVKKQREHKPLPKDAADFALSRLAKLDSSSS |
| | | GEYAQSVANEIRGSMQKHAGVFRTSALLAEGVEDIKKV |
| | | AERAQHIHLKDKSKVFNTARVEALEVANLVEVARATMV |
| | | SAEARKESRGAHAQDDFPHRDDENWMRHTLWFSEGD |
| | | RLDYKPVHMQPLTVESVPPKARTF |

1. A method of preventing or inhibiting dollar spot disease, brown patch disease, ear rot disease, kernel rot disease, or head blight disease in a grass, comprising inoculating a grass with
a) a bacterial endophyte, wherein the bacterial endophyte is a Burkholderia gladioli; or
b) a composition comprising the bacterial endophyte and optionally, a carrier.

2. The method of claim 1, wherein the bacterial endophyte comprises a 16S rRNA gene comprising a nucleotide sequence that has at least 96% sequence identity to the sequence set forth in SEQ ID NO: 26 or its progeny, or an isolated culture thereof, or mutants thereof.

3. The method of claim 1, wherein the bacterial endophyte further comprises at least one gene that has at least 80% sequence identity with a nucleic acid sequence selected from any one of SEQ ID NOs: 4-25.

4. The method of claim 3, wherein the bacterial endophyte comprises at least one gene involved in chitinase activity that is induced as a result of contact with a fungal pathogen.

5. The method claim 4, wherein the at least one gene involved in chitinase activity hydrolyzes 4-nitrophenyl N,N′-diacetyl-β-D-chitobioside or 4-nitrophenyl N-acetyl-β-D-glucosaminide.

6. The method of claim 1, wherein inoculating a grass comprises coating the seeds of the grass and/or exposing the grass to a spray.

7. The method of claim 1, wherein the grass is a cereal or a turfgrass.

8. The method of claim 7, wherein the grass is selected from the group consisting of creeping bentgrass, maize, rice, wheat, barley, sorghum, bentgrass, Bermuda grass, bluegrass, fescue, ryegrass and zoysiagrass.

9. A method of preventing or inhibiting fungal growth on a plant, comprising inoculating a plant with
a) a bacterial endophyte, wherein the bacterial endophyte is a Burkholderia gladioli; or
b) a composition comprising the bacterial endophyte and optionally, a carrier.

10. The method of claim 9, wherein the bacterial endophyte comprises a 16S rRNA gene comprising a nucleotide sequence that has at least 96% sequence identity to the sequence set forth in SEQ ID NO: 26 or its progeny, or an isolated culture thereof, or mutants thereof.

11. The method of claim 9, wherein the bacterial endophyte further comprises at least one gene that has at least 80% sequence identity with a nucleic acid sequence selected from any one of SEQ ID NOs: 4-25.

12. The method of claim 9, wherein the bacterial endophyte comprises at least one gene involved in chitinase activity that is induced as a result of contact with a fungal pathogen.

13. The method claim 12, wherein the at least one gene involved in chitinase activity hydrolyzes 4-nitrophenyl N,N′-diacetyl-β-D-chitobioside or 4-nitrophenyl N-acetyl-β-D-glucosaminide.

14. The method of claim 9, wherein the plant inoculated is a grass.

15. The method of claim 14, wherein the grass is a cereal or a turfgrass.

16. The method of claim 15, wherein the grass is selected from the group consisting of maize, rice, wheat, barley, sorghum, bentgrass, Bermuda grass, bluegrass, fescue, ryegrass and zoysiagrass.

17. The method of claim 9, wherein inoculating a plant comprises coating the seeds of the plant and/or exposing the plant to a spray.

18. The method of claim 9, wherein the endophyte inhibits the growth of at least one fungal pathogen.

19.-35. (canceled)

36. A synthetic combination comprising a purified bacterial population in association with a plurality of seeds or seedlings of a plant, wherein the purified bacterial population comprises an endophyte that is heterologous to the seeds or seedlings and is a Burkholderia gladioli, and wherein the endophyte is present in the synthetic combination in an amount effective to provide a benefit to the seeds or seedlings or plants derived from the seeds or seedlings.

37. The synthetic combination of claim 36, wherein the endophyte comprises a 16S rRNA gene comprising a nucleotide sequence that has at least 96% sequence identity to the sequence set forth in SEQ ID NO:26 or its progeny, or an isolated culture thereof, or mutants thereof.

38. The synthetic combination of claim 36, wherein the bacterial endophyte further comprises at least one gene that has at least 80% sequence identity with a nucleic acid sequence selected from any one of SEQ ID NOs: 4-25.

39. The synthetic combination of claim 36, wherein the bacterial endophyte comprises at least one gene involved in chitinase activity that is induced as a result of contact with a fungal pathogen.

40.-47. (canceled)

48. The synthetic combination of claim 36, wherein the plant is an agricultural plant, optionally a grass.

49.-81. (canceled)
